(19) United States
(12) Patent Application Publication
(10) Pub. No.: US 2015/0169758 A1
(43) Pub. Date: Jun. 18, 2015

(54) MULTI-PARTITE GRAPH DATABASE

(71) Applicants: Luigi ASSOM, VALDOBBIADENE (IT); Alessandro CODELLO, VALDOBBIADENE (IT)

(72) Inventors: Luigi ASSOM, VALDOBBIADENE (IT); Alessandro CODELLO, VALDOBBIADENE (IT)

(21) Appl. No.: 14/109,235

(22) Filed: Dec. 17, 2013

(51) Int. Cl. G06F 17/30

(52) U.S. Cl. CPC G06F 17/30864; G06F 17/30958

(57) ABSTRACT

The present invention relates to techniques to analyze and organize bodies of knowledge into information networks. More particularly, it relates to a method for measuring distance among and organizing similar concepts representing human knowledge, whose information is contained, as example, in databases of documents.

In particular, said method comprises: a) obtaining a plurality of type of entities and their relative properties, wherein at least two of said entities share at least one property; b) creating a multi-partite graph; c) making a projection for each type of entity onto each of their type of properties to obtain a proximity matrix, or a weighted graph, for each pair type of entity-type of property; d) obtaining a family of proximity matrices for each type of entity; e) querying the computed results in a format so that for each type of entity, portions of proximity matrices, or weighted graphs, of said family, are interactively accessed, represented or displayed.

The present invention relates also to a discovery engine based on the above method.

### FIELD OF THE INVENTION

The present invention relates to techniques to analyze and organize bodies of knowledge into information networks. More particularly, it relates to methods for measuring distance among and organizing similar concepts representing human knowledge whose information is contained for example in databases of documents; intellectual properties, ideas, inventions; crafted, manufactured or intellectual products such as movies, recipes, books, games, music, patents, medicines and pharmacological remedies; specific know-how in single arts and disciplines such as biological, biochemical, chemical, biomedical databases and topics characterizing human, scientific and technological studies; industrial knowledge management databases to optimize problems such as clustering products, clustering of problems, and improving retailing product positioning; or any other hypermedia database containing information on product, service, and know-how reflecting human activities, creations, and creators.

### BACKGROUND OF THE INVENTION

### Big Data

Big-data is a challenging new way to capture, organize, and visualize in an accessible way the complexity of collection of data.

The big challenge is to identify a solution making sense of multi-layered information levels, whose data volume is growing exponentially.

### Search and Discovery Techniques

Search Engines aimed to retrieve information in linked databases of documents or documents relative to corpuses of knowledge; as example, methods and systems known in the art provide techniques such as organizing documents by page-rank.

If we depict the history of web intelligence in decades, we roughly can highlight the PC era (1980-1990); the rise of world wide web (web 1.0: 1990-2000); the social web (web 2.0: 2000-2010); the semantic web (web 3.0: 2010-2020); and the expected intelligent web (web 4.0: 2020-2030) [based on source: Josiane Farah, “Predicting the Intelligence of Web 3.0 Search Engines”, International Journal of Computer Theory and Engineering, Vol. 4, No. 3, June 2012]

From the web 1.0, we observed an increasing extension of productivity of search, such as the evolution of searches against directories (e.g. the first Altavista); towards searches of keywords against linked databases organized by absolute ranking (e.g. Google); towards the introduction of meta-tagging systems (e.g. Open Graph) and collaborative filtering systems (platforms structured against users' behavior); towards the introduction of searches based on natural language processing (semantic web).

The increase of data (big-data) led to a differentiation of search engines: they can be classified according to the techniques in information retrieval they specialized, such as: horizontal or generalist search engines (e.g. Google; Bing); meta-search engines (e.g. Metacrawler; Infospace); vertical search engines for specific contents (e.g. Google Scholar; Pubchem; Pubmed; Yummly); search engines for multimedia (e.g. Flickr; Youtube; Lastfm); search engines for user-generated media (e.g. Technorati; Blogscope, which evolved into the commercial Sysomos—business intelligence for social media); search engines automatically classifying content by clustering or classes of results (e.g. WebClust, Yippy, Iseek); search engines based on collaborative filtering and crowd-source tagging (e.g. Opendirectory; Del.icio.us); search engines based on ontologies or natural language processing (e.g. Wolframalpha; MIT Start); search engines based on information extraction, text mining or statistical processing of results (e.g. Google Trends; Google Insight; Twitter Sentiment); search engines based on queries refinement (e.g. Google Suggest; ThinkMap; WordTracker).

Other Search Engines specialized in visualization techniques for representing results in categories by means of not conventional user interfaces, and focused on the user experience for searching related documents (e.g. Yasiv based on Amazon's products; What do you Love (WDYL), own by Google; Liveplasma, based on music, movies and books also based on Amazon API).

### Information Retrieval

Beside search engines and tools aiming to retrieve information in linked databases, several innovations approached the problem of discovery of relevant information in corpuses of knowledge.

Recommendation Engines (also known as Recommender Systems) and Discovery Engines focus on retrieval of related information such as recommendation of content, recommendation of products and applications in knowledge management for cause-problem correlations.

Some techniques to construct relational similitude on documents rely on analyzing document content or part of their content.

Methods and systems known in the art provide means for filtering structured information to classify content or items and recommend items based on similarity; semantic analysis techniques focusing on NLP (natural language processing) algorithms; semantic meta-tagging of documents for classification and relation of ontologies in corpora of knowledge; classification of ontologies from disparate source of data.

Recommendations based on large amount of data may adopt machine-learning techniques for classifying and constructing relational similitude on documents and list of products, for extraction of information, opinion analysis and sentiment analysis.

Approaches in semantic web vastly rely on the above methods.

Some techniques include user modeling techniques, such clustering based on statistical analyses against user behavior and user profiles; clustering of logs and queries performed by users, include content-based filtering against user profiles based on relevance feedback mechanism applied to NPL or linguistic processed documents; and include personalization of content structured on the relationships between users behavior and items as bi-partite graphs.

### Graphs in Information Retrieval

Adopting graphs in information retrieval is currently a fast evolving field for structuring databases and for empowering social platforms, such the Open Graph of Facebook. A graph approach, which matches users' behavior to a plurality of content sources such as products, media content, users' skills, is also adopted in recommendation systems by Amazon, Rovi Corporation and LinkedIn.
Facebook

The Open Graph of Facebook is a protocol, which enables any web page to become a rich object in a social graph [http://ogp.me/]. For instance, it is used on Facebook to allow any web page to have the same functionality as any other object on Facebook.
Amazon

The item-to item recommendation system of Amazon is based on collaborative filtering which matches each of the user's purchased and rated items to similar items, then combines those similar items into a recommendation list (http://www.cs.umd.edu/˜samir/498/Amazon-Recommendations.pdf). Such a recommendation system can be represented as bipartite graph between users and items [M. J. E. Newman, Networks An Introduction, Oxford University Press (2010)].

Yasiv.com is a visual recommendation service, which displays the products recommended by Amazon.com via the Application Program Interface (API) of Amazon Associates Program; it displays relations between products in form of a connected graph.
Rovi Corporation

Rovi Corporation extended its ability to help clients to create more personalized recommendation systems with the acquisition of MediaUnbound, a software company which builds and supports personalization and recommendation software for enterprises that sell, distribute, and display media content. Among the services developed by the company, there are the Static Recommendations systems that make individual item recommendations based on a single input point [http://www.crunchbase.com/company/mediaunbound].
LinkedIn

LinkedIn developed a system based on a referral engine (http://www.quora.com/LinkedIn-Recommendations/How-does-LinkedIns-recommedation-system-work): a system which helps in matching skills with people, and is structured on terabytes of data on members, jobs, groups, news, companies, schools, discussions and events. The recommendation platform computes recommendation on assortment of products, including “Jobs You May be Interested In”, “Groups You May Like”, “News Relevance”, and “Ad Targeting”

[http://www.cloudera.com/content/cloudera/en/resources/library/hadoopworld/hadoop-world-2011-presentation-video-leveraqing-hadoop-to-transform-raw-data-to-richfeatures-at-linkedin.html].

### Collaborative Databases

Wikipedia

Encyclopedias are the oldest types of collaborative databases; Wikipedia is the major example of modern collaborative database where the contribution is crowd-sourced.
Freebase

Freebase is a collaborative database of metadata, a project founded by Metaweb Technologies in 2005 and acquired by Google in 2010; it defined “an entity [as] a single thing or concept that exists in the world” [http://wiki.freebase.com/wiki/Entity].

### Knowledge Graph and Google

Knowledge Graphs are hyperlinked structures resulting from collaborative databases, where people encoded meaningful semantic information in articles, multimedia, hyper-links and descriptions.

Knowledge graphs have introduced the idea of adopting entities to enhance information retrieval of webpages.
Google

The knowledge graph of Google, Inc. is based on Freebase, which also includes Wikipedia database.

The Freebase database accounts in July 2013 of 39 million real world entities; recommendation of knowledge graph are displayed on the Google search engine page for keywords that matches the topic queried by the user [http://www.google.com/insidesearch/features/search/knowledge.html].

The connections are created as in recommendation engines by combining the information that others found useful with the information in the knowledge graph. Indeed, the knowledge graph displays related information only for those topics sufficiently popular among the Google user base [http://www.youtube.com/watch?feature=player embedded&v=mmQI6VGvX-c].

The links of the knowledge graph inform about possible correlations between entities, but they do not carry proximity information to prioritize the most meaningful entities related to a searched entity.

As example, for “Blade Runner” and other movies the knowledge graph displays links to related movies and other related information, such as excerpts extracted from Wikipedia, but for entities such as “supramolecular chemistry” no result is displayed because the topic is not sufficiently popular among the searches of Google to be meaningfully connected to other topics.
Bing

The choice of adopting a knowledge base constructed and peer-reviewed by people has been adopted also by Bing, Inc., which established a partnership with Britannica Encyclopedia to create its own knowledge graph [http://www.binq.com/blogs/site blogs/b/search/archive/2012/06/07/bing-introduces-new-britannica-online-encyclopedia-answers.aspx].

However, the knowledge management in the big-data environment still suffers from unsolved problems, such as combining a plurality of databases and multiple information layers into a single structure, in such a way that complexity of semantic information is organized to allow accessibility to the contextual relationships for any entity, including the least popular.

Moreover, a method to organize the proximity of contextual relationships and to access recommendations of an entity for any possible context characterizing a type of entity is still missing in the art.

### SUMMARY OF THE INVENTION

It has now been found, and it is an object of the present invention, a computer-implemented method to organize and combine multiple databases into a Multi-Partite Graph Database (MPGD), said databases containing information on type of entities and their properties, said method solves the problems of the prior art, such as for example combining a plurality of databases and multiple information layers into a single structure. Advantageously, complexity of semantic information is organized so to allow accessibility to the contextual relationships for any entity, and permitting to discover previously unknown relationships.

Another advantage is that the method of the present invention organizes contextual relationships by proximity for any possible semantic context characterizing a type of entity, and providing to the user easily recommendations of a queried entity for each selected context.

The present invention describes a universal method to obtain proximity or similarity relations for entities of any type and for infinite contexts, where each context is significant of a diverse type of relationship connecting entities.

The method prescribes a way to encode semantic information into the topology of a graph-based database called Multi-partite Graph Database.

Accordingly, it is an object of the present invention a computer-implemented method to organize and combine multiple databases into a Multi-Partite Graph Database (MPGD), said databases containing information on type of entities and their properties, comprising:
a. obtaining a plurality of type of entities and their relative properties, wherein at least two of said entities share at least one property;
b. creating a multi-partite graph;
c. making a projection for each type of entity onto each of their type of properties to obtain a proximity matrix, or a weighted graph, for each pair type of entity-type of property;
d. obtaining a family of proximity matrices for each type of entity;
e. querying the computed results in a format so that for each entity, portions of proximity matrices, or weighted graphs, of said family, are interactively accessed, represented or displayed.

In a preferred embodiment of the present invention, in said method, after step b) and before step c), the step b′) of promoting said properties to entities and type of properties to type of entities is provided.

In another aspect, in the method according to the present invention, said multi-partite graph database contains as many families of proximity matrices as the number of entity types and any of said family contains infinite proximity matrices.

In another aspect, in the method according to the present invention, said multi-partite graph database contains as many families of weighted graphs as the number of entity types and any of said family contains infinite weighted graphs.

In another aspect, in the method according to the present invention, said types of entities are documents and said properties are links between said documents.

In another aspect, in the method according to the present invention, said multi-partite graph of step b) is a collection of as many hyper-graphs (where an entity is an element and a property a set) as the entity-types are.

In another aspect, in the method according to the present invention, semantic relations among entities are transferred to relations among nodes of said multi-partite graph.

In another aspect, in the method according to the present invention, an entity type is projected onto each of the entity types it is connected with in said multi-partite graph.

In another aspect, in the method according to the present invention, said projection generates proximity matrices over a type of entity which are linearly combined to create a continuous family of proximity matrices.

In another aspect, in the method according to the present invention, the family of proximity matrices is queried by specifying any of type of entity, a context and a list of entities.

In another aspect, in the method according to the present invention, said query returns a sub-graph, or equivalently a sub-matrix, containing the specified entities.

In another aspect, in the method according to the present invention, a visual interface is implemented.

Another object of the present invention is a discovery engine using the method disclosed above.

In another aspect, in the discovery engine, a query of a single entity is made.

In another aspect, in the discovery engine, any successive query is made against an entity belonging to the sub-graph union of the sub-graphs returned by the previous queries.

In another aspect, in the discovery engine, a query of two entities is made.

In another aspect, in the discovery engine, a shortest-path algorithm is applied to determine the returned sub-graph.

In another aspect, in the discovery engine, a query of three or more entities is made.

In another aspect, in the discovery engine, clustering or community detection algorithms are applied to determine the returned sub-graph.

In another aspect, in the discovery engine, queries against collections of families of proximity matrices are combined.

Another object of the present invention is a method for performing the discovery engine disclosed above, wherein a visual interface is implemented, comprising:
a. displaying the sub-graph graphically or by equivalent textual-grid layouts;
b. displaying the shortest path which connects the first queried and the currently selected entity belonging to the sub-graph;
c. overviewing and traversing knowledge domains by accessing the sub-graph;
d. summarizing meaningful relationships between entities by highlighting the paths connecting at least two selected entities;
e. aggregating multiple information layers associated to an entity;
f. accessing a minimum number of properties to characterize a set of entities.

For example, a conventional personal computer, a tablet, a smartphone or other portable or wearable device with a suitable processor, sufficient memory is a convenient way to carry out the present invention.

Another object of the present invention is a non-transitory computer program storage device readable by computer, tangibly embodying a program of instructions executable by said computer to perform the method disclosed above.

Another object of the present invention is a non-transitory computer program storage device readable by computer, tangibly embodying a program of instructions executable by said computer to perform the discovery engine disclosed above.

### the Topological Structure Encodes Semantic Information

The topological structure of the graph allows the extraction of proximity values between entities that can be used to contextualize a given entity, or group of entities, by querying the database.

### Many Different Contexts

The method allows obtaining in principle infinite contexts representing different kind of proximities between the same entities, enabling the user to select the one of her/his interest for accessing types of similarity relationships.

### Queries and Discovery Engine

The present invention allows performing queries against multiple set of entities to obtain, for each chosen context, portions of networks (sub-graphs) which include the queried entities and their neighbors organized by proximity; within sub-graphs, entities are represented as nodes and proximity relationships as weighted links.

Sub-graphs allow to identify, within one as well as within multiple contexts, optimal paths for connecting two entities; to identify clusters of entities sharing the minimum set of properties within a context for characterizing those entities; to optimize the number of properties for obtaining similar entities within a given context or multiple given contexts. The present invention allows also finding the shortest path connecting two entities for each context.

Queries can be iterated for entities belonging to a sub-graph, so that is possible to unify the resulting sub-graphs of each query and traverse the multi-partite graph.

### UX/UI and Discovery Engine

The organization of entities by their proximity relationships for each context allows: to obtain a dual type of interface for overviewing the sub-graphs; to organize entities by type and strength of proximity; to access the entities; to synthesize a knowledge area represented by the sub-graphs, being the knowledge area represented by the proximity relationships between entities for any chosen context; to summarize the relationship and obtain logical paths connecting two selected entities within a sub-graph; to quickly access options for a searched entity by multiple information layers representing salient information such as key properties, excerpts, media, info-graphic and indexed URLs; to aggregate and index external sources for each entity, such as web URLs and pointers to other documents, media or digital archives.

Differences with the Other Approaches (Search Engines, Recommendation Engines and Knowledge Graphs)

Such method does not require statistical analysis on user behavior and machine learning applications to identify information patterns and trends against queries of users.

Such method does not rely on natural language processing or meta-tagging techniques adopted in semantic web and semantic applications, although it may adopt such techniques to obtain properties of entities.

Therefore, such method does not depend on the amount of data available to perform statistical analysis and does not depend on linguistic ontologies and on the chosen language for applying NLP algorithms: the present invention allows to obtain proximity and similarity relations also for the least popular entities and for relatively small datasets.

The present invention relates to the organization and aggregation of entities and type entities into a multi-partite graph, to the computation of proximity networks related to each type of entity, and to access to portion of the information networks related to an entity from an infinite number of possible contexts.

The present invention allows extracting the semantic relationship encoded in databases and knowledge graphs. As an example, in the knowledge graphs based on collaborative encyclopedias, databases and open graph protocols mentioned above, semantic relationships between entities are generally not equivalent to hyper-links between webpages and other sources. As another example, information which is incidentally present in a corpus of knowledge to describe a certain type of entities, it can be extracted to obtain a new type of entities and the semantic relationships characterizing them.

Within the meanings of the present invention, we define as “entity” any of the concepts existing in the world, which can be thought and sufficiently described by a human being, such as a person, an idea, a thing, a place. According to the present invention, and differently from the state of the art, properties defining an entity can also be entities themselves. An entity defined by other entities results in at least two sets of types of entities (e.g. a movie is a thing created by people: the movie and people who are involved in it are two types of entities which are related). An entity can be shared between multiple types of entities (e.g. “Anna Karenina” is a movie entity belonging to the type of entities “movies”, as well as it is a book entity belonging to type of entities “books”).

While web pages, documents, data and properties related to one entity are potentially infinite, the entity they refer to is always unique: as example, at the time of the present invention, there are about 12.100.000 documents for the keywords “blade runner movie”, while the entity representing the movie “Blade Runner” is unique.

The structure of human knowledge is given by the relationships between entities known in its multiple domains. Entities and type of entities are webbed among each other according to the properties they share in common. A property can also be an entity, thus an entity can be characterized by other entities, and multiple entities and type of entities result webbed to each other in a multi-partite graph. With this shift of paradigm, the structure of human knowledge is related to the topology of multi-partite graphs. Also, the problem to make sense of large quantity of data is reduced by several orders of magnitude, since it possible to aggregate and associate multiple sources of information to unique entities.

The present invention solves the problem of how to organize multiple corpora of knowledge or databases representing different type of entities; to combine them into a single object; to retrieve portion of meaningful relationships for contextualizing an entity by means of proximity measures; to obtain an infinite number of possible contexts for accessing relationships and recommendations between entities.

The present invention refers also to a discovery engine: while a search engine searches for a list of documents referring to keywords by ranking webpages, a discovery engine searches for relationships contextualizing an entity and allows recommendations for an infinite number of possible contexts.

The discovery engine is an embodiment of the multi-partite graph to organize and combine multiple corpora of knowledge or databases representing different type of entities, into a single object; to access to portion of information meaningful to contextualize an entity or to recommend entities associated to it by means of proximity relationships, for an infinite number of possible contexts.

The discovery engine according to the present invention provides methods and systems to map and display the relations among entities within a chosen context, and describes the implementation of a tool applicable in business intelligence and knowledge management which is independent from a specific industrial domain or from a type of corpus of knowledge.

The present invention allows to organize, combine and compute family of proximity matrixes among millions of nodes; it addresses the need to save time to overview, access and explore a knowledge area, as well as to save time to address knowledge management problems about similarly related problems or products, to access alternatives and to discover not yet known options.

The organization of knowledge relationships is generally achievable only after having mastered a topic, having researched for lists of related options, having accessed the content of the related options, having organized the type of relations and prioritized the importance of the relations in a meaningful way, so that to understand and extend comprehension of a knowledge area.

Various aspects of the present invention provide systems and methods for organizing and combining information about entities of multiple types.

One aspect of the invention is to model the relations among entities of multiple types in a multi-partite graph.

Another aspect of the invention is to obtain families of proximity networks of entities belonging to the same type. Another aspect of the invention is to access to portions of networks in the families of proximity networks.

Each entity is characterized by properties of different type. The method according to the present invention constructs a multi-partite graph by promoting properties to entities, and type of properties to type of entities. In the present method, an entity is represented as a node of a given type, where each type of node corresponds to a type of entity; then each entity is linked to those other entities equivalent to their properties.

The multi-partite graph contains families of proximity matrices for each type of entity, and from each family is possible to obtain an infinite number of proximity matrices by linear combination.

A hyper-graph of a given type can be drawn as a universe of entities belonging to that type; entities sharing the same properties belong to same sets. Looked at another way, a multi-partite graph can be seen as a collection of as many hyper-graphs (where an entity is an element and a property a set) as the entity types are. Intuitively, this is a way to transfer the semantic relations among entities to the relations among nodes of the multi-partite graph. In this way the information of the original databases is stored and organized in the topological structure of the multi-partite graph.

One aspect of the present invention is directed to taking advantage of the linked structure of the multi-partite graph to obtain, in an objective way, proximity matrixes—in the context of the present invention also indicated as proximity networks—of entities of the same type by means of projection. To make a projection, first a bi-partite graph between entities of two types, i.e. an entity-type and one of its property-type, is extracted from the multi-partite graph; then the bi-partite graph is reduced to a weighted graph (network), the weight expressing a similarity measure between entities. A weighted graph obtained in such a way is equivalently represented as a proximity matrix. An entity type can be projected in the direction of each of its property types, thus more generally a type of entity can be projected onto each of the types it is connected to in the multi-partite graph. For each type of entity, they are obtained as many weighted graphs as the type of entities' properties. A projection onto a type of property informs on the similitudes among entities related to that particular property.

Input databases generally define properties as elements characterizing entities; since the method of the present invention promotes properties to entities, projections are here particularly useful because the proximity matrixes can also be extracted about entities which where only incidentally expressed in input source of data.

The simplex of proximity matrixes about a given type of entity is the convex set of proximity matrixes generated by the proximity matrixes obtained by the projections onto all the properties of the given type of entity.

A context about a type of entity is the proximity matrix associated to a point in the simplex of proximity matrices.

The simplex contains an infinite number of contexts and represents the network family associated to a type: thus a network family contains infinite contexts from which the information relative to a given entity can be accessed. Portion of networks related to each entity can be accessed by a chosen context.

In one aspect of the invention, a computer implemented method is provided to construct the multi-partite graph database. The method comprises the steps of:
a. obtaining a plurality of type of entities and their relative properties, wherein at least two of said entities share at least one property;
b. creating a multi-partite graph (defined as a collection of bi-partite graphs represented by adjacency matrices where each entity is linked to its properties);
c. promoting said properties to entities and type of properties to type of entities (and obtaining the property-entity adjacency matrices by transposition);
d. making a projection for each type of entity onto each of their type of properties (to obtain a proximity matrix, or a weighted graph, for each type of entity);
e. obtaining a family of proximity matrices for each type of entity (by linear combination of the proximity matrices relative to the given pair type of entity-type of property);
f. querying the computed results in a format so that portions of the weighted graphs, or of the proximity matrices, are interactively accessed, represented or displayed.

### BRIEF DESCRIPTION OF THE DRAWINGS

Additional aspects, applications and advantages will become apparent in view of the following description and associated figures.

In the Figures:

FIG. 1 shows an example of the invention, wherein three types of entities (squares, triangles and circles) are organized in a multi-partite graph. An entity of a given type is also a property of that given type for entities of the other two types.

FIG. 2 shows the two bi-partite graphs containing squares (squares-triangles and squares-circles) extracted from the multi-partite graph of FIG. 1.

FIG. 3 shows the projection of squares onto circles and of circles onto squares obtained from the bipartite graph squares-circles of FIG. 2. The links are weighted according to the similarity function chosen.

FIG. 4 shows the projection of squares onto triangles and of triangles onto squares obtained from the bi-partite graph squares-triangles of FIG. 2. The links are weighted according to the similarity function chosen. Node square-4 is not connected to the other since all its proximities are zero.

FIG. 5 shows the family of weighted graphs obtained by linear combination of the weighted graphs with square nodes of FIG. 3 and FIG. 4. Here the simplex is the line segment [0,1] parameterized by α.

FIG. 6A shows how direct graph can be represented as a bipartite graph.

FIG. 6B shows a flow chart of the present method with reference to the example developed in the Detailed Description of the Invention.

FIG. 6C shows a flow chart of the iterative query procedure used in an implementation of the Discovery Engine.

FIGS. 7A-13C show some embodiments of the present invention applied in the patent literature domain.

FIGS. 14A-16D show some embodiments of the present invention applied in field of human knowledge.

FIGS. 17A-17J show some embodiments of the present invention applied in field of movie domain.

FIGS. 18-23 show some embodiments of the present invention applied in field of food domain.

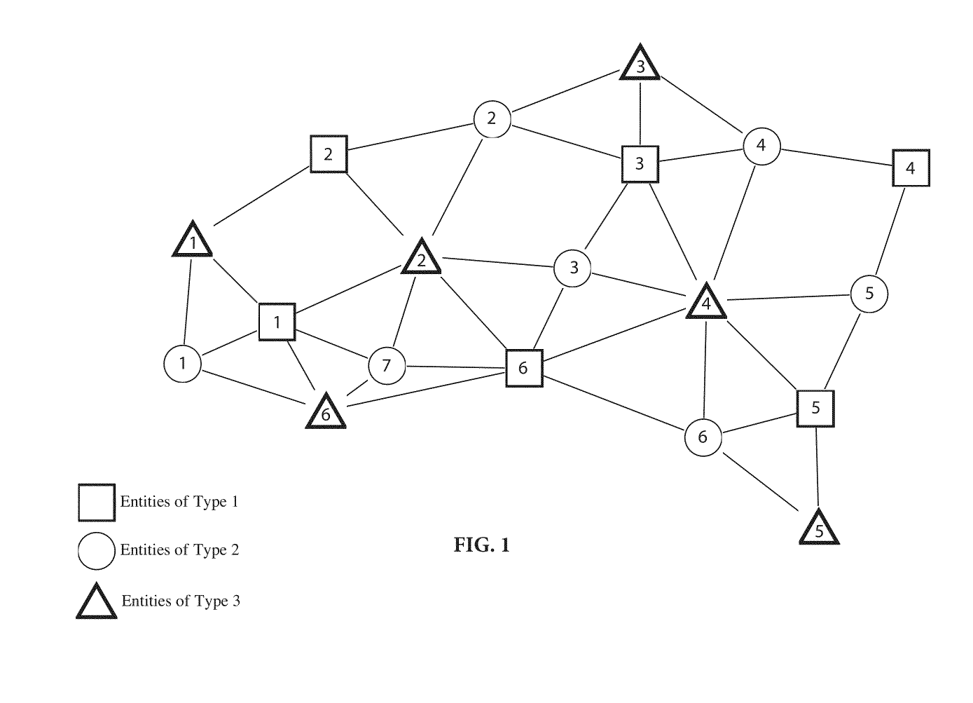

With reference to the FIGS. 1-6A, in the foregoing description of an exemplary embodiment of the present invention, squares are indicated with S, circles with C and triangles with T, this notation is maintained also in the mathematical and computational explanation.

### DETAILED DESCRIPTION OF THE INVENTION

### Definitions

Within the context of the present invention, the following definitions are provided.

Entity: a particular person, idea, place, object, piece of work, fact or generically any instance of abstract or concrete concept which is represented among human knowledge.

Type of entity: the class of entities of the same type, i.e. the set of persons, ideas, places, movies, books, etc.

Property: meaningful attributes which characterizes an entity and enables a person to understand what the entity is and how to distinguish it from others.

Type of property: the class of properties of the same type.

Multi-partite graph: a graph (or network) characterized by nodes of M different types connected by links of one type.

Bi-partite graph: a multi-partite graph with M=2 or a sub-graph of a multi-partite graph obtained by selecting two types of nodes and the links connecting them.

Adjacency matrix: matrix representation of a bi-partite graph. An adjacency matrix can equivalently be represented in the form of an adjacency list.

Proximity (or similarity): real number between 0 (different) and 1 (equal) representing the proximity or similarity between to entities of the same type.

Weighted graph: a graph which has a proximity value associated to each link.

Proximity matrix: matrix representation of a weighted graph. A proximity matrix can equivalently be represented in the form of an adjacency list with proximities.

Projection: procedure by which one obtains a weighted graph from a bi-partite graph, the weight being a proximity value. Since a bi-partite graph has two types of nodes, X and Y, the projection can be type-X onto type-Y or type-Y onto type-X, in this way producing two different proximity matrices.

Families of proximity matrices: the convex set (simplex) of matrices generated by linear combination of all possible projections of a given entity type onto its properties types. The resulting matrices equivalently describe a family of weighted graphs.

Context: a particular proximity matrix in a family of proximity matrices.

### Multi-Partite Graph

A multi-partite graph is a graph constructed by linking nodes of Mdifferent types where each node corresponds to an entity and each type of node corresponds to a type of entity.

The multi-partite graph is constructed starting from a set of input databases from which entities and their properties are extracted. Each entity is characterized by its properties, which can be of different types. The multi-partite graph is constructed by making each type of entity and each type of property a different type of node and by connecting every entity to its properties, where these can be of different type.

At this point, properties can be promoted to be entity themselves and an entity E that has a property P can be interpreted to be a property of P itself. In this way, a multi-partite graph where each node corresponds to an entity and each type of node corresponds to a type of entity is constructed.

FIG. 1 shows an example of three types of entities organized in a multi-partite graph. Each type of entity is also a property of the other. There are three types of entities represented by three types of nodes. Type-S entities are represented by squares, type-T entities by triangles and type-C entities by circles.

The description of each entity can correspond to any record describing that entity within any database of documents, such as web pages, portions of the world wide web or other hypermedia archive, a dictionary or thesaurus, an encyclopedia, a database of academic articles, patents, court cases, chemical compounds, movies, recipes, books, music, art-crafts, products, as well as to a property of the record(s) belonging to a database. Although there are manifold sources of information referring to an entity, and they are found in multiple databases (i.e. a movie is an entity which can have many and multiple description referring to it, stored in digital archives, encyclopedias, blogs and books), the entity is always a unique concept.

If the database is unstructured (i.e. web pages or a collection of texts), it is possible to extract the properties of the considered entities by means of techniques used in the art, for example Natural Language Processing (NPL), parsing, or other equivalent methods.

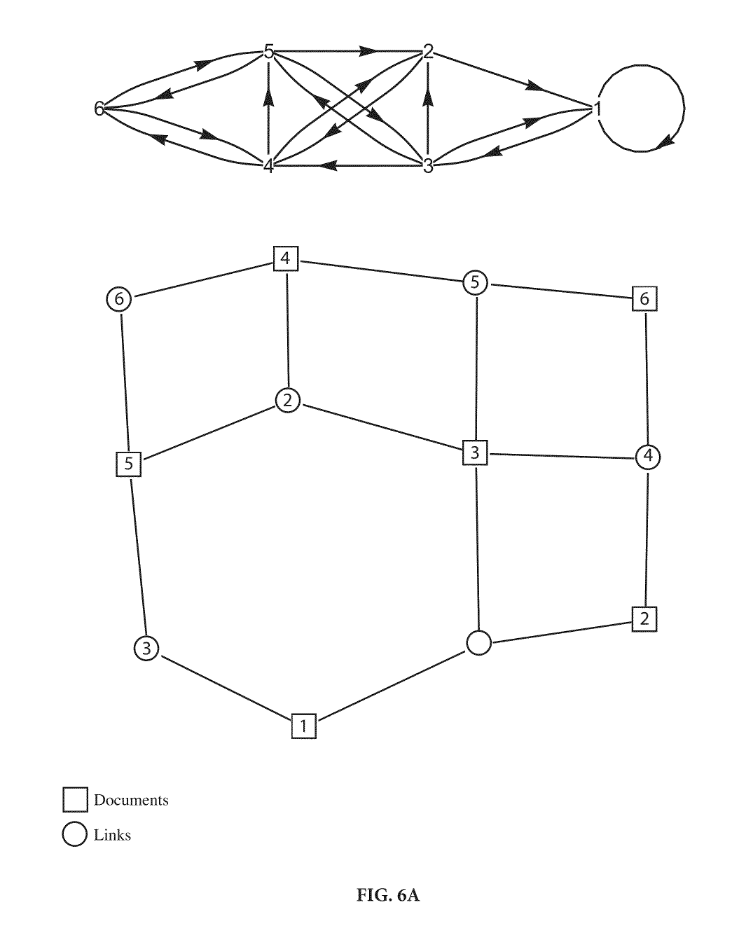

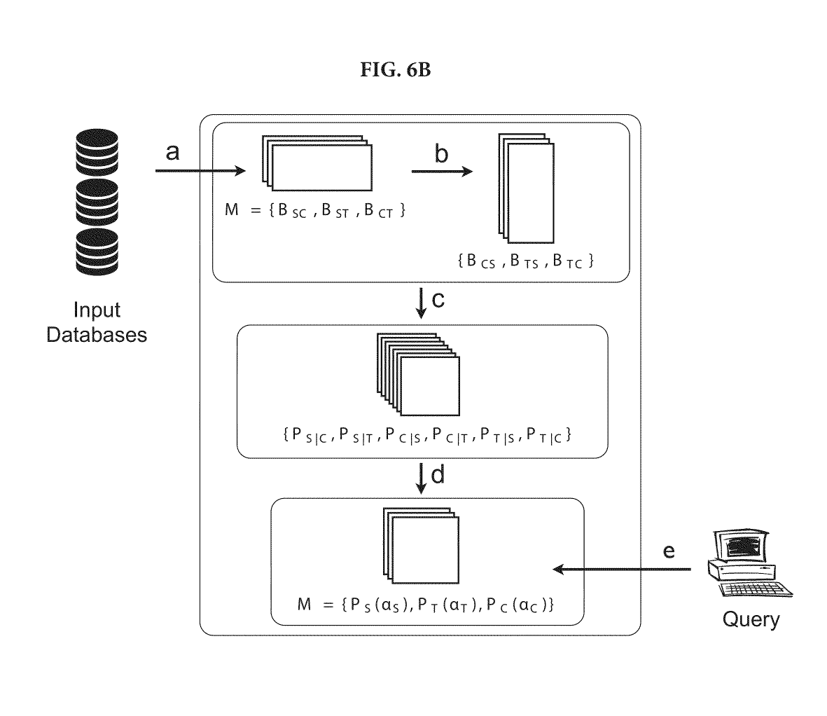

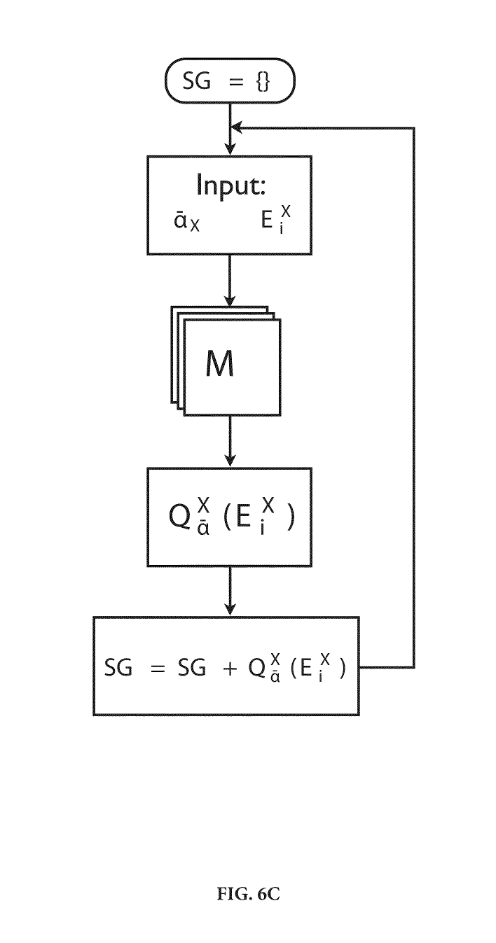

A direct graph can be represented as a bipartite graph as shown in FIG. 6A. Thus, if the input database is a linked database the information contained by the link structure can be encoded in the multipartite graph by first converting the relative directed graph into a bi-partite graph belonging to the multi-partite graph, where the entities are documents and the properties are the links (i.e. this document is linked to this other).

Since each property is promoted to be an entity itself, it is possible to extract new entities from a database treating only a certain type of entities (i.e. from a database of movies it is possible to extract the actors starring in a movie, and therefore obtain a database of actors; from a database of materials and chemical compounds it is possible to extract the firms commercializing them, and obtain a database of firms).

### Projection

The multi-partite graph allows obtaining weighted graphs, or equivalently proximity matrices, of entities of the same type by means of projection. A projection is a procedure to reduce a bi-partite graph, seen as a sub-graph of the multi-partite graph, to a weighted graph, by associating a weighted link between two entities if they share the same property, the weight being a measure of proximity between nodes.

Therefore, each bi-partite graph between entities of a certain type and their properties can be taken in order to make a projection. Each bi-partite graph is obtained from the multi-partite graph, by selecting the entities of a certain type (type-X), the entities of a different type (type-Y) and the edges connecting them. The type-Y entities are the properties of type-X ones (and vice-versa). The projection of type-X onto type-Y entities is obtained by constructing a weighted graph of type-X entities. Two type-X entities are linked if they share a type-Y node. Each edge results weighted by construction, the weight being a function, here called similarity function, of the number of common links and their respective degree. The weighted graph obtained in such a way is equivalently described by a proximity matrix.

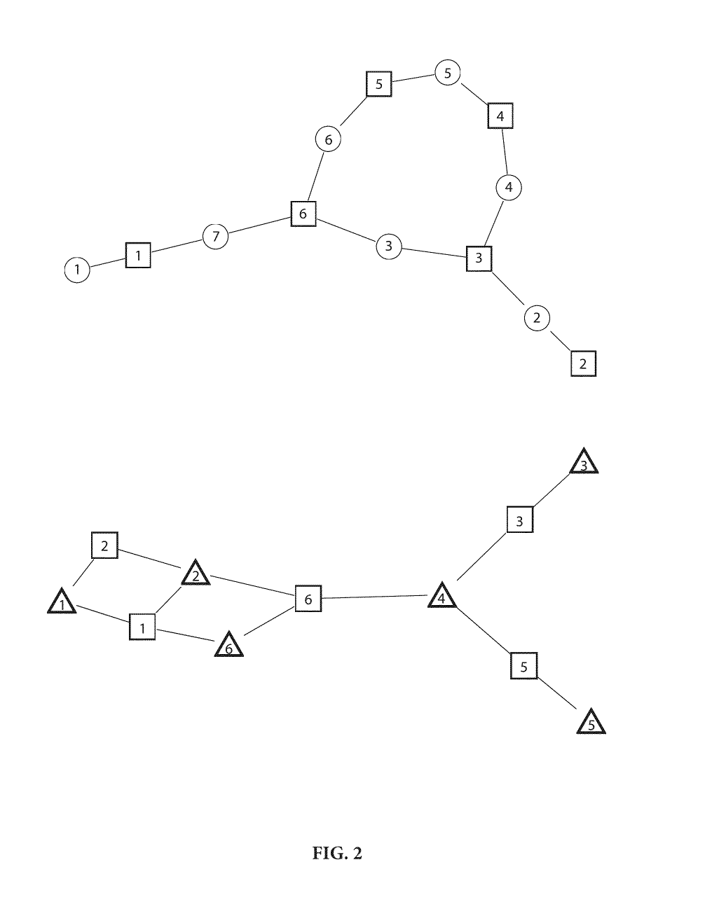

FIG. 2 shows the two bi-partite graphs containing square nodes (i.e. the squares-triangles bi-partite graph and the squares-circles bi-partite graph) extracted from the multi-partite graph of FIG. 1.

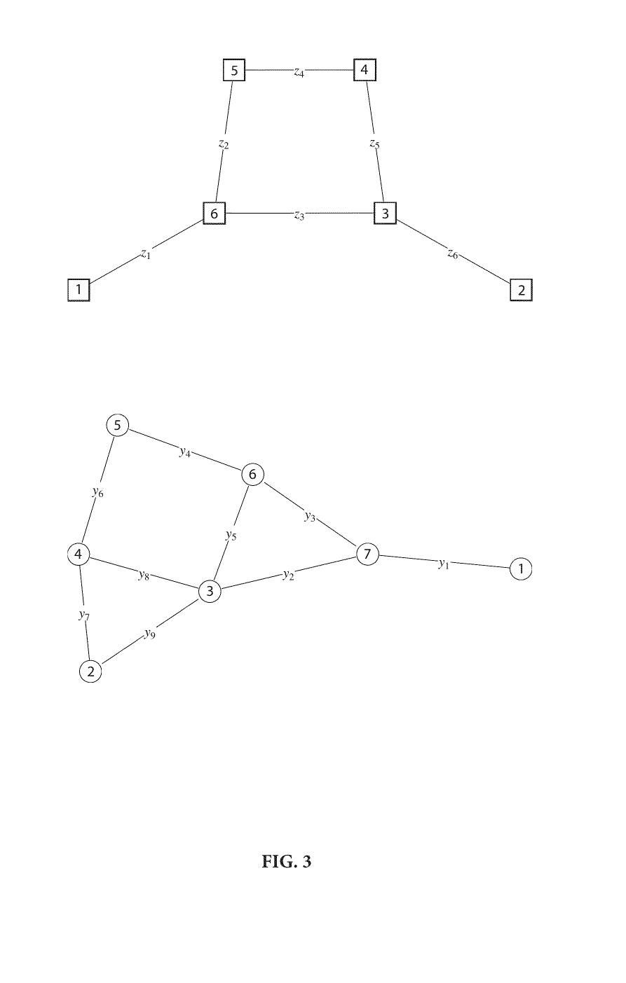

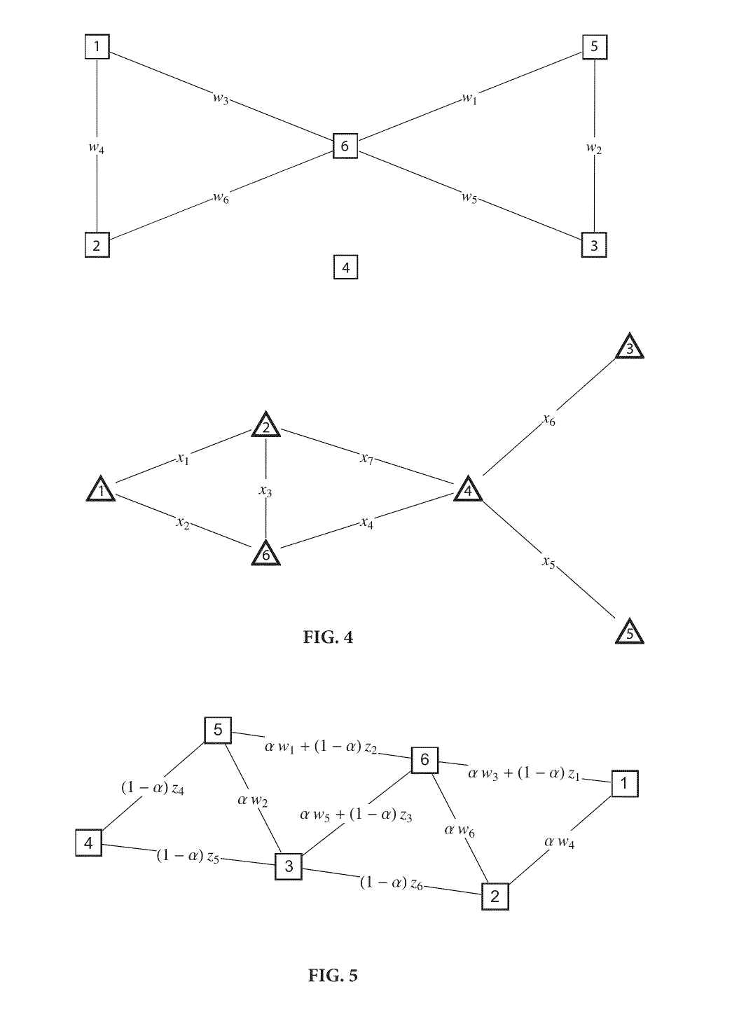

FIG. 3 and FIG. 4 show the two possible projections of the bi-partite graphs of FIG. 2. The links are weighted according to the similarity function chosen.

This method is equivalent to calculate the proximity between each pair of entities by considering these as sets of properties. The proximity between entities is a function of the cardinality of the sets representing entities and of their respective intersections.

Sets of different types can be used to distinguish entities of different types, while elements of different types can be used to distinguish properties of different types. In this way, we can construct an equivalent description of the multi-partite graph based on sets. This kind of representation is called a hyper-graph and is a dual description of a bi-partite graph (see Newman above). Thus, the multi-partite graph, which is a collection of bi-partite graphs, can equivalently be seen as a collection of hyper-graphs.

### Family of Proximity Matrices and Contexts

We can compute the projection of type-X entities onto all of its properties obtaining n proximity matrices, where n is the number of properties a type-X entity has. Then, we can construct the family of proximity matrices over entities of type-X by making the linear combination of the n proximity matrices obtained by projection. The coefficient of the linear combination must belong to the n-dimensional simplex (i.e. the convex set generated by linearly independent points in n-dimensional Euclidean space). Each point on the n-dimensional simplex corresponds to a proximity matrix over the type-X entity and represents a different context. A context of type-X entities is thus a proximity matrix in the family of proximity matrices over entities of type-X.

The multi-partite graph database can thus be equivalently described by the collection of families of proximity matrices, one family for each type of entity.

FIG. 5 shows the linear combinations of the proximity matrices over the type of entity represented by squares.

### Queries on the Multi-Partite Graph Database

The multi-partite graph database in the form of collection of families of proximity matrices can be queried by specifying a type of entity (or type of node), a context and a list of entities (or nodes). A query so formed returns a sub-graph of the weighted graph representing the chosen context containing the specified nodes (or entities).

Successive queries can be made against an entity (to query) belonging to the sub-graph union of the sub-graphs returned by the previous queries and iterated in this way.

When k=2, the query can return a weighted sub-graph containing the shortest path between the two given nodes (or entities). For example, the shortest path can be computed by applying shortest path algorithms such as Dijkstra's algorithm (E. W. Dijkstra, A note on two problems in connection with graphs, Numerische Mathematik 1 (1959) 269-271) or equivalents.

Since nodes represent entities, the multi-partite graph gives a framework to find the shortest path between two entities.

When k is equal or greater than three, the query can return a sub-graph wherein clustering or community detection algorithms (see Newman above) are applied to determine the returned sub-graph.

### Mathematical Details

Mathematical definition of multi-partite graph is herein provided.

### a) Multi-Partite Graph

The multi-partite graph (database) M is represented mathematically as a collection of adjacency matrices:

M={B_{XY}}_{Xεε,YεP}

where X spans the set of type of entities E and Y spans the set of type of properties P.

The adjacency matrices B_{XY} are defined in the following way:

$${( {B}_{XY} )}_{ij} = \{ \begin{matrix}1 & if {E}_{i}^{X} has property {P}_{j}^{Y} \\ 0 & if {E}_{i}^{X} does not have property {P}_{j}^{Y}\end{matrix}$$

Note that some of the adjacency matrices B_{XY} can be the zero-matrix since a type-X entity cannot be described by properties of type-Y; this happens when type-X nodes are not linked to type-Y in the multipartite graph.

The matrix B_{YX} is obtained from the adjacency matrix B_{XY} by transposition:

B_{YX}=B_{XY}^{T}

According to the method of the present invention, properties can be promoted to be entities and the set of type of entities coincides with the set of type of properties:

ε≡P

This implies that the multi-partite graph can also be characterized by the following set of adjacency matrices:

M={B_{XY}}_{X,Yεε}

with only the pair XY or YX comparing for any X, Y, since in each case the other adjacency matrix can be obtained by transposition.

The multi-partite graph of exemplary FIG. 1 is represented by the set of adjacency matrices {B_{SC}, B_{ST}, B_{CT}}. These are of the following form:

$${B}_{SC} = \begin{matrix} & {P}_{1}^{C} & {P}_{2}^{C} & {P}_{3}^{C} & {P}_{4}^{C} & {P}_{5}^{C} & {P}_{6}^{C} & {P}_{7}^{C} \\ {E}_{1}^{S} & 1 & 0 & 0 & 0 & 0 & 0 & 1 \\ {E}_{2}^{S} & 0 & 1 & 0 & 0 & 0 & 0 & 0 \\ {E}_{3}^{S} & 0 & 1 & 1 & 1 & 0 & 0 & 0 \\ {E}_{4}^{S} & 0 & 0 & 0 & 1 & 1 & 0 & 0 \\ {E}_{5}^{S} & 0 & 0 & 0 & 0 & 1 & 1 & 0 \\ {E}_{6}^{S} & 0 & 0 & 1 & 0 & 0 & 1 & 1\end{matrix}$$

$${B}_{ST} = \begin{matrix} & {P}_{1}^{T} & {P}_{2}^{T} & {P}_{3}^{T} & {P}_{4}^{T} & {P}_{5}^{T} & {P}_{6}^{T} \\ {E}_{1}^{S} & 1 & 1 & 0 & 0 & 0 & 1 \\ {E}_{2}^{S} & 1 & 1 & 0 & 0 & 0 & 0 \\ {E}_{3}^{S} & 0 & 0 & 1 & 1 & 0 & 0 \\ {E}_{4}^{S} & 0 & 0 & 0 & 0 & 0 & 0 \\ {E}_{5}^{S} & 0 & 0 & 0 & 1 & 1 & 0 \\ {E}_{6}^{S} & 0 & 1 & 0 & 1 & 0 & 1\end{matrix}$$

$${B}_{CT} = \begin{matrix} & {P}_{1}^{T} & {P}_{2}^{T} & {P}_{3}^{T} & {P}_{4}^{T} & {P}_{5}^{T} & {P}_{6}^{T} \\ {E}_{1}^{C} & 1 & 0 & 0 & 0 & 0 & 1 \\ {E}_{2}^{C} & 0 & 1 & 1 & 0 & 0 & 0 \\ {E}_{3}^{C} & 0 & 1 & 0 & 1 & 0 & 0 \\ {E}_{4}^{C} & 0 & 0 & 1 & 1 & 0 & 0 \\ {E}_{5}^{C} & 0 & 0 & 0 & 1 & 0 & 0 \\ {E}_{6}^{C} & 0 & 0 & 0 & 1 & 1 & 0 \\ {E}_{7}^{C} & 0 & 1 & 0 & 0 & 0 & 1\end{matrix}$$

Even if we identify entities with properties we keep, in the above and in the following examples, entities and properties separated in order to show which entity plays the role of entity and which of property. It is understood that one can always set P=E.

The transposed matrices B_{CS} and B_{TS} (that are needed later in the section Computational details), are obtained, respectively, from B_{SC} and B_{ST} by interchanging rows with columns:

$${B}_{CS} = {B}_{SC}^{T} = \begin{matrix} & {E}_{1}^{S} & {E}_{2}^{S} & {E}_{3}^{S} & {E}_{4}^{S} & {E}_{5}^{S} & {E}_{6}^{S} \\ {P}_{1}^{S} & 1 & 0 & 0 & 0 & 0 & 0 \\ {P}_{2}^{S} & 0 & 1 & 1 & 0 & 0 & 0 \\ {P}_{3}^{S} & 0 & 0 & 1 & 0 & 0 & 1 \\ {P}_{4}^{S} & 0 & 0 & 1 & 1 & 0 & 0 \\ {P}_{5}^{S} & 0 & 0 & 0 & 1 & 1 & 0 \\ {P}_{6}^{S} & 0 & 0 & 0 & 0 & 1 & 1 \\ {P}_{7}^{S} & 1 & 0 & 0 & 0 & 0 & 1\end{matrix}$$

$${B}_{TS} = {B}_{ST}^{T} = \begin{matrix} & {E}_{1}^{S} & {E}_{2}^{S} & {E}_{3}^{S} & {E}_{4}^{S} & {E}_{5}^{S} & {E}_{6}^{S} \\ {P}_{1}^{T} & 1 & 1 & 0 & 0 & 0 & 0 \\ {P}_{2}^{T} & 1 & 1 & 0 & 0 & 0 & 1 \\ {P}_{3}^{T} & 0 & 0 & 1 & 0 & 0 & 0 \\ {P}_{4}^{T} & 0 & 0 & 1 & 0 & 1 & 1 \\ {P}_{5}^{T} & 0 & 0 & 0 & 0 & 1 & 0 \\ {P}_{6}^{T} & 1 & 0 & 0 & 0 & 0 & 1\end{matrix}$$

### b) Projection

To compute the proximity matrix for type-X entities P_{X|Y} obtained by projection onto type-Y entities we extract from the multi-partite graph the bi-partite graph adjacency matrix B_{XY} between entities (of type-X) and their properties (entities of type-Y).

The projection of type-X onto type-Y entities corresponds to computing:

P_{X|Y}=D_{X|Y}B_{XY}B_{YX}D_{X|Y}

The diagonal matrix D_{X|Y} is defined as:

(D_{X|Y})_{i,j}=ƒ(|Eᵢ^{X}|_{Y})δ_{i,j}

where:

|Eᵢ^{X}|_{Y}

is the degree of the i-th node of type-X with respect to links linking nodes of type-Y. In other words, it is the number of properties of type-Y that the entity

Eᵢ^{X}

has. The similarity function ƒ is a monotonically decreasing function that is equal to infinity at zero and zero at infinity. Examples of forms of ƒ are:

$${f}^{Cosine} ( X ) = \frac{1}{\sqrt{x}} {f}^{Newman} ( x ) = \frac{1}{x}$$

but other forms can be used. In particular, these two forms are chosen to reproduce the proximity measures defined later in this description.

The proximity matrix P_{X|Y} can also be written as follows:

$$\begin{matrix}{P}_{X \vert Y} = {D}_{X \vert Y} {{B}_{XY} ( {D}_{X \vert Y} {B}_{XY} )}^{T} \\ = {\tilde{B}}_{XY} {\tilde{B}}_{XY}^{T}\end{matrix}$$

where the adjacency matrix

\tilde{B}_{XY}=D_{X|Y}B_{XY}

is obtained from B_{XY} by multiplying each non-zero entry in each row by the value obtained by applying the similarity function ƒ to the number of non-zero entries of the row.

Our proximity matrices, obtained as the product of adjacency matrices and their transposes, can be seen as a generalization of co-citation and bibliographic coupling matrices (see Newman, above).

The proximities, i.e. the entries of the proximity matrix,

p_{i,j}^{X|Y}=(P_{X|Y})_{i,j}

implied by the previous construction are given by the following general relation:

p_{i,j}^{X|Y}=|Eᵢ^{X}#Eⱼ^{Y}|_{Y}ƒ(|Eᵢ^{X}|_{Y})ƒ(|Eⱼ^{X}|_{Y})

where:

|Eᵢ^{X}∪Eⱼ^{X}|_{Y}

is the number of properties of type-Y that the type-X entities i and j have in common. The proximities so obtained are a measure of structural similarity (for the definition of the concept of structural similarity see Newman above) between nodes of the same type, and thus between entities of the same type. The proximities are real numbers between 0 and 1

0≦p_{i,j}^{X|Y}≦1

and are symmetric in i and j:

p_{i,j}^{X|Y}=p_{j,i}^{X|Y}

The actual value of proximity implied by the method depends on the form of the similarity function ƒ. The two examples given above lead to:

$${p}_{i , j}^{X \vert Y Cosine} = \frac{{\vert {E}_{i}^{X} ⋂ {E}_{j}^{X} \vert}_{Y}}{\sqrt{{E}_{i}^{X} {\vert}_{Y} \vert {E}_{j}^{X} {\vert}_{Y}}}$$

$$and$$

$${p}_{i , j}^{X \vert Y Newman} = \frac{{\vert {E}_{i}^{X} ⋂ {E}_{j}^{X} \vert}_{Y}}{{E}_{i}^{X} {\vert}_{Y} \vert {E}_{j}^{X} {\vert}_{Y}}$$

By referring to the exemplary embodiment of the Figures, the proximity matrix P_{S|C} (obtained by projecting type-square entities onto type-circle entities) is represented by the weighted graph with square nodes of FIG. 3, while the proximity matrix P_{S|T} (obtained by projecting type-square entities onto type-triangle entities) is represented by the weighted graph with square nodes of FIG. 4. Explicitly, these proximity matrices are of the following form:

$${P}_{S \vert C} = \begin{matrix} & {E}_{1}^{S} & {E}_{2}^{S} & {E}_{3}^{S} & {E}_{4}^{S} & {E}_{5}^{S} & {E}_{6}^{S} \\ {E}_{1}^{S} & 1 & 0 & 0 & 0 & 0 & {z}_{1} \\ {E}_{2}^{S} & 0 & 1 & {z}_{6} & 0 & 0 & 0 \\ {E}_{3}^{S} & 0 & {z}_{6} & 1 & {z}_{5} & 0 & {z}_{3} \\ {E}_{4}^{S} & 0 & 0 & {z}_{5} & 1 & {z}_{4} & 0 \\ {E}_{5}^{S} & 0 & 0 & 0 & {z}_{4} & 1 & {z}_{2} \\ {E}_{6}^{S} & {z}_{1} & 0 & {z}_{3} & 0 & {z}_{2} & 1\end{matrix}$$

$${P}_{S \vert T} = \begin{matrix} & {E}_{1}^{S} & {E}_{2}^{S} & {E}_{3}^{S} & {E}_{4}^{S} & {E}_{5}^{S} & {E}_{6}^{S} \\ {E}_{1}^{S} & 1 & {w}_{4} & 0 & 0 & 0 & {w}_{3} \\ {E}_{2}^{S} & {w}_{4} & 1 & 0 & 0 & 0 & {w}_{6} \\ {E}_{3}^{S} & 0 & 0 & 1 & 0 & {w}_{2} & {w}_{5} \\ {E}_{4}^{S} & 0 & 0 & 0 & 1 & 0 & 0 \\ {E}_{5}^{S} & 0 & 0 & {w}_{2} & 0 & 1 & {w}_{1} \\ {E}_{6}^{S} & {w}_{3} & {w}_{6} & {w}_{5} & 0 & {w}_{1} & 1\end{matrix}$$

where the values zᵢ and wᵢ are the non-zero computed proximities that depend on the form of the similarity function ƒ chosen. Vice-versa, one can obtain P_{C|S} by projecting type-circle entities onto type-square entities (represented by the weighted graph with circle nodes of FIG. 3), or P_{T|S} by projecting type-triangle entities onto type-square entities (represented by the weighted graph with triangle nodes of FIG. 4). Explicitly, these proximity matrices are of the following form:

$${P}_{C \vert S} = \begin{matrix} & {E}_{1}^{C} & {E}_{2}^{C} & {E}_{3}^{C} & {E}_{4}^{C} & {E}_{5}^{C} & {E}_{6}^{C} & {E}_{7}^{C} \\ {E}_{1}^{C} & 1 & 0 & 0 & 0 & 0 & 0 & {y}_{1} \\ {E}_{2}^{C} & 0 & 1 & {y}_{9} & {y}_{7} & 0 & 0 & 0 \\ {E}_{3}^{C} & 0 & {y}_{9} & 1 & {y}_{8} & 0 & {y}_{5} & {y}_{2} \\ {E}_{4}^{C} & 0 & {y}_{7} & {y}_{8} & 1 & {y}_{6} & 0 & 0 \\ {E}_{5}^{C} & 0 & 0 & 0 & {y}_{6} & 1 & {y}_{4} & 0 \\ {E}_{6}^{C} & 0 & 0 & {y}_{5} & 0 & {y}_{4} & 1 & {y}_{3} \\ {E}_{7}^{C} & {y}_{1} & 0 & {y}_{2} & 0 & 0 & {y}_{3} & 1\end{matrix}$$

$${P}_{T \vert S} = \begin{matrix} & {E}_{1}^{T} & {E}_{2}^{T} & {E}_{3}^{T} & {E}_{4}^{T} & {E}_{5}^{T} & {E}_{6}^{T} \\ {E}_{1}^{T} & 1 & {x}_{1} & 0 & 0 & 0 & {x}_{2} \\ {E}_{2}^{T} & {x}_{1} & 1 & 0 & {x}_{7} & 0 & {x}_{3} \\ {E}_{3}^{T} & 0 & 0 & 1 & {x}_{6} & 0 & 0 \\ {E}_{4}^{T} & 0 & {x}_{7} & {x}_{6} & 1 & {x}_{5} & {x}_{4} \\ {E}_{5}^{T} & 0 & 0 & 0 & {x}_{5} & 1 & 0 \\ {E}_{6}^{T} & {x}_{2} & {x}_{3} & 0 & {x}_{4} & 0 & 1\end{matrix}$$

where the yᵢ and xᵢ are the non-zero computed proximities that depend on the form of the similarity function ƒ chosen.
c) Family of Proximity Matrices and Contexts For each type of entity it is possible to make a projection onto each of its types of property.

We can obtain a family of proximity matrices, which is a continuous set of proximity matrices, by linear interpolation of the proximity matrices P_{X|Y}, P_{X|Z}, . . . , over all Y, Z, . . . , in P which are properties of X:

P_{X}(α_{Y},α_{z}, . . . )=α_{Y}P_{X|Y}+α_{Z}P_{X|Z}+ . . .

with the following constraint on the parameters:

α_{Y}+α_{Z}+ . . . =1

A simplex is the convex set generated by linearly independent points in a multi-dimensional space and is defined by the above equation. The points corresponding to a vertex of the simplex correspond to one of the proximity matrices P_{X|Y}, P_{X|Z}, . . . , obtained by projection onto a given type of property. Each other point in the simplex corresponds to a proximity matrix which is a linear combination of the P_{X|Y}, P_{X|Z}, . . . , and represents a proximity matrix whose proximities interpolate between the proximities of the proximity matrices of the vertices of the simplex.

The simplex contains infinite points: the simplex represents the family of proximity matrices, or weighted graphs, associated to a type of entity. The family of proximity matrices contains infinite contexts from which the information relative to a given type of entity can be accessed.

One can parameterize the family of proximity matrices, or equivalently the points in the simplex, over type-X entities in the following way:

$${P}_{X} = ( \frac{α}{α + β + …} , \frac{β}{α + β + …} , … )$$

where the parameters α,β . . . are subject to:

α,β, . . . ε[0,1]

but other parameterizations are possible. A context of type-X entities is thus a vector of the form (α*, β* . . . ) representing a point in the simplex in the given parameterization.

FIG. 5 shows the family of weighted graphs obtained by linear combination of the weighted graphs with square nodes of FIG. 3 and FIG. 4, or the representation of the proximity matrix over type-square entities obtained by linear combination of the proximity matrices obtained by projecting type-square entities over type-circle entities and type-square entities over type-triangle entities:

P_{S}(α)=αP_{S|T}+(1−α)P_{S|C}

In this example the simplex is the line segment [0,1] and is parameterized α. The above proximity matrix has the following explicit form:

$$\begin{matrix} & {E}_{1}^{S} & {E}_{2}^{S} & {E}_{3}^{S} & {E}_{4}^{S} & {E}_{5}^{S} & {E}_{6}^{S} \\ {E}_{1}^{S} & 1 & α {w}_{4} & 0 & 0 & 0 & α {w}_{3} + ( 1 - α ) {z}_{1} \\ {E}_{2}^{S} & α {w}_{4} & 1 & ( 1 - α ) {z}_{6} & 0 & 0 & α {w}_{6} \\ {E}_{3}^{S} & 0 & ( 1 - α ) {z}_{6} & 0 & ( 1 - α ) {z}_{5} & α {w}_{2} & α {w}_{5} + ( 1 - α ) {z}_{3} \\ {E}_{4}^{S} & 0 & 0 & ( 1 - α ) {z}_{5} & 1 & ( 1 - α ) {z}_{4} & 0 \\ {E}_{5}^{S} & 0 & 0 & α {w}_{2} & ( 1 - α ) {z}_{4} & 1 & α {w}_{1} + ( 1 - α ) {z}_{2} \\ {E}_{6}^{S} & α {w}_{3} + ( 1 - α ) {z}_{1} & α {w}_{6} & α {w}_{5} + ( 1 - α ) {z}_{3} & 0 & α {w}_{1} + ( 1 - α ) {z}_{2} & 1\end{matrix}$$

The method so far exposed implies that a multi-partite graph (database) M can equivalently be described as the collection of family of proximity matrices, one for each entity X in E:

$$ℳ = {\{ {P}_{X} = ( \frac{{α}_{X}}{{α}_{X} + {β}_{X} + …} , \frac{{β}_{X}}{{α}_{X} + {β}_{X} + …} , … ) \}}_{X ∈ ɛ}$$

Where the parameters (αₓ, βₓ . . . ) are between 0 and 1. The collection of families of proximity matrices contains all possible correlations between entities, including properties promoted to entities, that are present in the multi-partite graph and consequently in the input databases.

### d) Queries on the Multi-Partite Graph Database

The multi-partite graph database in the form of collection of families of proximity matrices can be queried by specifying a type of entity X, a context (αₓ*, βₓ*, . . . ) and a list of k entities. A query so formed returns a sub-matrix Q_{(αx*,βx*, . . . )}(E) of P_{X}(αₓ*/(αₓ*+βₓ*+ . . . ),βₓ*/(αₓ*+βₓ*+ . . . ), . . . ) containing the specified k entities, or equivalently a weighted sub-graph, containing the relative k nodes.

Successive queries can be made against an entity (to query) belonging to the sub-graph SG union of the sub-graphs returned by the previous queries. The query procedure is iterated in this way. FIG. 6C shows the flow chart relative to this procedure: 0) the sub-graph SG={ } is set equal to the empty graph; 1) a query to the multi-partite database M is formed specifying a context (αₓ*, βₓ*, . . . ) and an entity E; 2) the sub-matrix Q_{(αx*,βx*, . . . )}(E) is returned; 3) the sub-graph is updated SG=SG∪Q_{(αx*,βx*, . . . )}(E); iterate the procedure returning to point 1).

In another embodiment of the present invention queries against collections of families of proximity matrices are combined and the above procedure is generalized.

When k=2, the query returns a sub-matrix, or equivalently a weighted sub-graph, which can contain the shortest path between the two given nodes. For example, the shortest path can be computed by applying to the matrix P_{X}(αₓ*/(αₓ*+βₓ*+ . . . ),βₓ*/(αₓ*+βₓ*+ . . . ), . . . ) shortest path algorithms such as Dijkstra's algorithm (see reference above) or equivalents.

When k is equal or greater than three the query can return a sub-graph wherein clustering or community detection algorithms (see Newman above) are applied to determine the returned sub-graph.

### Computational Details

We describe here the algorithms involved in the method.

### a) Multi-Partite Graph

The matrices B_{XY} representing the bi-partite graphs are represented in form of adjacency list, which is a list of arrays where each header of the array correspond to the entity, and the properties which are linked to it are reported alongside. The adjacency list is suggested, being a more efficient way to handle the adjacency matrices obtained in applications of the present method, which generally are sparse matrices.

Referring to FIG. 2 the bi-partite graphs are represented by the following adjacency lists:

$${B}_{SC} = \begin{matrix}{E}_{1}^{S} & {P}_{1}^{C} & {P}_{7}^{C} & \\ {E}_{2}^{S} & {P}_{2}^{C} & & \\ {E}_{3}^{S} & {P}_{2}^{C} & {P}_{3}^{C} & {P}_{4}^{C} \\ {E}_{4}^{S} & {P}_{4}^{C} & {P}_{5}^{C} & \\ {E}_{5}^{S} & {P}_{5}^{C} & {P}_{6}^{C} & \\ {E}_{6}^{S} & {P}_{3}^{C} & {P}_{6}^{C} & {P}_{7}^{C}\end{matrix}$$

$${B}_{ST} = \begin{matrix}{E}_{1}^{S} & {P}_{1}^{T} & {P}_{2}^{T} & {P}_{6}^{T} \\ {E}_{2}^{S} & {P}_{1}^{T} & {P}_{2}^{T} & \\ {E}_{3}^{S} & {P}_{3}^{T} & {P}_{4}^{T} & \\ {E}_{4}^{S} & & & \\ {E}_{5}^{S} & {P}_{4}^{T} & {P}_{5}^{T} & \\ {E}_{6}^{S} & {P}_{2}^{T} & {P}_{4}^{T} & {P}_{6}^{T}\end{matrix}$$

### b) Transposition

The transposed matrix B_{YX} of the matrix B_{XY} is obtained by exchanging rows and columns. In terms of adjacency lists the transposed list B_{YX}, relating type-Y entities to their properties, i.e. the type-X entities, is obtained by the transposition algorithm.

This is described by the following pseudo-code:

for every entity:

for every property:

if the property has already been encountered:

add the entity to the array

else:

create a new array with the property as header
add the entity to the array

The computational complexity of transposition is estimable in NM where N is the number of entities and M is the average number of properties an entity has.

In terms of the previous example, the adjacency list:

$${B}_{CS} = {B}_{SC}^{T} = \begin{matrix}{P}_{1}^{C} & {E}_{1}^{S} & \\ {P}_{7}^{C} & {E}_{1}^{S} & {E}_{6}^{S} \\ {P}_{2}^{C} & {E}_{2}^{S} & {E}_{3}^{S} \\ {P}_{3}^{C} & {E}_{3}^{S} & {E}_{6}^{S} \\ {P}_{4}^{C} & {E}_{3}^{S} & {E}_{4}^{S} \\ {P}_{5}^{C} & {E}_{4}^{S} & {E}_{5}^{S} \\ {P}_{6}^{C} & {E}_{5}^{S} & {E}_{6}^{S}\end{matrix}$$

is obtained from B_{SC} through the following steps:

$$\begin{matrix}\to & {E}_{1}^{S} & {P}_{1}^{C} & {P}_{7}^{C} & \\ & {E}_{2}^{S} & {P}_{2}^{C} & & \\ & {E}_{3}^{S} & {P}_{2}^{C} & {P}_{3}^{C} & {P}_{4}^{C} \\ & {E}_{4}^{S} & {P}_{4}^{C} & {P}_{5}^{C} & \\ & {E}_{5}^{S} & {P}_{5}^{C} & {P}_{6}^{C} & \\ & {E}_{6}^{S} & {P}_{3}^{C} & {P}_{6}^{C} & {P}_{7}^{C}\end{matrix} \qquad \begin{matrix}{P}_{1}^{C} & {E}_{1}^{S} \\ {P}_{7}^{C} & {E}_{1}^{S} \\ & \\ & \\ & \\ & \end{matrix}$$

$$\begin{matrix} & {E}_{1}^{S} & {P}_{1}^{C} & {P}_{7}^{C} & \\ \to & {E}_{2}^{S} & {P}_{2}^{C} & & \\ & {E}_{3}^{S} & {P}_{2}^{C} & {P}_{3}^{C} & {P}_{4}^{C} \\ & {E}_{4}^{S} & {P}_{4}^{C} & {P}_{5}^{C} & \\ & {E}_{5}^{S} & {P}_{5}^{C} & {P}_{6}^{C} & \\ & {E}_{6}^{S} & {P}_{3}^{C} & {P}_{6}^{C} & {P}_{7}^{C}\end{matrix} \qquad \begin{matrix}{P}_{1}^{C} & {E}_{1}^{S} \\ {P}_{7}^{C} & {E}_{1}^{S} \\ {P}_{2}^{C} & {E}_{2}^{S} \\ & \\ & \\ & \end{matrix}$$

$$\begin{matrix} & {E}_{1}^{S} & {P}_{1}^{C} & {P}_{7}^{C} & \\ & {E}_{2}^{S} & {P}_{2}^{C} & & \\ \to & {E}_{3}^{S} & {P}_{2}^{C} & {P}_{3}^{C} & {P}_{4}^{C} \\ & {E}_{4}^{S} & {P}_{4}^{C} & {P}_{5}^{C} & \\ & {E}_{5}^{S} & {P}_{5}^{C} & {P}_{6}^{C} & \\ & {E}_{6}^{S} & {P}_{3}^{C} & {P}_{6}^{C} & {P}_{7}^{C}\end{matrix} \qquad \begin{matrix}{P}_{1}^{C} & {E}_{1}^{S} & \\ {P}_{7}^{C} & {E}_{1}^{S} & \\ {P}_{2}^{C} & {E}_{2}^{S} & {E}_{3}^{S} \\ {P}_{3}^{C} & {E}_{3}^{S} & \\ {P}_{4}^{C} & {E}_{3}^{S} & \\ & & \end{matrix}$$

$$\begin{matrix} & {E}_{1}^{S} & {P}_{1}^{C} & {P}_{7}^{C} & \\ & {E}_{2}^{S} & {P}_{2}^{C} & & \\ & {E}_{3}^{S} & {P}_{2}^{C} & {P}_{3}^{C} & {P}_{4}^{C} \\ \to & {E}_{4}^{S} & {P}_{4}^{C} & {P}_{5}^{C} & \\ & {E}_{5}^{S} & {P}_{5}^{C} & {P}_{6}^{C} & \\ & {E}_{6}^{S} & {P}_{3}^{C} & {P}_{6}^{C} & {P}_{7}^{C}\end{matrix} \qquad \begin{matrix}{P}_{1}^{C} & {E}_{1}^{S} & \\ {P}_{7}^{C} & {E}_{1}^{S} & \\ {P}_{2}^{C} & {E}_{2}^{S} & {E}_{3}^{S} \\ {P}_{3}^{C} & {E}_{3}^{S} & \\ {P}_{4}^{C} & {E}_{3}^{S} & {E}_{4}^{S} \\ {P}_{5}^{C} & {E}_{4}^{S} & \end{matrix}$$

$$\begin{matrix} & {E}_{1}^{S} & {P}_{1}^{C} & {P}_{7}^{C} & \\ & {E}_{2}^{S} & {P}_{2}^{C} & & \\ & {E}_{3}^{S} & {P}_{2}^{C} & {P}_{3}^{C} & {P}_{4}^{C} \\ & {E}_{4}^{S} & {P}_{4}^{C} & {P}_{5}^{C} & \\ \to & {E}_{5}^{S} & {P}_{5}^{C} & {P}_{6}^{C} & \\ & {E}_{6}^{S} & {P}_{3}^{C} & {P}_{6}^{C} & {P}_{7}^{C}\end{matrix} \qquad \begin{matrix}{P}_{1}^{C} & {E}_{1}^{S} & \\ {P}_{7}^{C} & {E}_{1}^{S} & \\ {P}_{2}^{C} & {E}_{2}^{S} & {E}_{3}^{S} \\ {P}_{3}^{C} & {E}_{3}^{S} & \\ {P}_{4}^{C} & {E}_{3}^{S} & {E}_{4}^{S} \\ {P}_{5}^{C} & {E}_{4}^{S} & {E}_{5}^{S} \\ {P}_{6}^{C} & {E}_{5}^{S} & \end{matrix}$$

$$\begin{matrix} & {E}_{1}^{S} & {P}_{1}^{C} & {P}_{7}^{C} & \\ & {E}_{2}^{S} & {P}_{2}^{C} & & \\ & {E}_{3}^{S} & {P}_{2}^{C} & {P}_{3}^{C} & {P}_{4}^{C} \\ & {E}_{4}^{S} & {P}_{4}^{C} & {P}_{5}^{C} & \\ & {E}_{5}^{S} & {P}_{5}^{C} & {P}_{6}^{C} & \\ \to & {E}_{6}^{S} & {P}_{3}^{C} & {P}_{6}^{C} & {P}_{7}^{C}\end{matrix} \qquad \begin{matrix}{P}_{1}^{C} & {E}_{1}^{S} & \\ {P}_{7}^{C} & {E}_{1}^{S} & {E}_{6}^{S} \\ {P}_{2}^{C} & {E}_{2}^{S} & {E}_{3}^{S} \\ {P}_{3}^{C} & {E}_{3}^{S} & {E}_{6}^{S} \\ {P}_{4}^{C} & {E}_{3}^{S} & {E}_{4}^{S} \\ {P}_{5}^{C} & {E}_{4}^{S} & {E}_{5}^{S} \\ {P}_{6}^{C} & {E}_{5}^{S} & {E}_{6}^{S}\end{matrix}$$

Similarly one finds for the matrix B_{TS} the following form:

$${B}_{TS} = {B}_{ST}^{T} = \begin{matrix}{P}_{1}^{T} & {E}_{1}^{S} & {E}_{2}^{S} & \\ {P}_{2}^{T} & {E}_{1}^{S} & {E}_{2}^{S} & {E}_{6}^{S} \\ {P}_{6}^{T} & {E}_{1}^{S} & {E}_{6}^{S} & \\ {P}_{3}^{T} & {E}_{3}^{S} & & \\ {P}_{4}^{T} & {E}_{3}^{S} & {E}_{5}^{S} & {E}_{6}^{S} \\ {P}_{5}^{T} & {E}_{5}^{S} & & \end{matrix}$$

### c) Projection

A proximity matrix can be saved in form of adjacency list with proximities. The adjacency list with proximities is an adjacency list of arrays of couples entity-proximity (the first entity of the list will have proximity one). The entities can be sorted in function of their proximity value.

With respect to FIG. 3 the proximity matrix P_{S|C} with type-square nodes is, in adjacency list form, the following:

$${P}_{S \vert C} = \begin{matrix}{E}_{1}^{S} 1 & {E}_{6}^{S} {z}_{1} & & \\ {E}_{2}^{S} 1 & {E}_{3}^{S} {z}_{6} & & \\ {E}_{3}^{S} 1 & {E}_{2}^{S} {z}_{6} & {E}_{6}^{S} {z}_{3} & {E}_{4}^{S} {z}_{5} \\ {E}_{4}^{S} 1 & {E}_{3}^{S} {z}_{5} & {E}_{5}^{S} {z}_{4} & \\ {E}_{5}^{S} 1 & {E}_{4}^{S} {z}_{4} & {E}_{6}^{S} {z}_{2} & \\ {E}_{6}^{S} 1 & {E}_{1}^{S} {z}_{1} & {E}_{3}^{S} {z}_{3} & {E}_{5}^{S} {z}_{2}\end{matrix}$$

where the values zᵢ are the non-zero computed proximities.

The proximity matrix P_{S|T} with square nodes of FIG. 4 is:

$${P}_{S \vert T} = \begin{matrix}{E}_{1}^{S} 1 & {E}_{2}^{S} {w}_{4} & {E}_{6}^{S} {w}_{3} & & \\ {E}_{2}^{S} 1 & {E}_{1}^{S} {w}_{4} & {E}_{6}^{S} {w}_{6} & & \\ {E}_{3}^{S} 1 & {E}_{5}^{S} {w}_{2} & {E}_{6}^{S} {w}_{5} & & \\ {E}_{4}^{S} 1 & & & & \\ {E}_{5}^{S} 1 & {E}_{3}^{S} {w}_{2} & {E}_{6}^{S} {w}_{1} & & \\ {E}_{6}^{S} 1 & {E}_{1}^{S} {w}_{3} & {E}_{2}^{S} {w}_{6} & {E}_{3}^{S} {w}_{5} & {E}_{5}^{S} {w}_{1}\end{matrix}$$

where the values wᵢ are the non-zero computed proximities.

The projection algorithm is described by the following pseudo-code

for every entity:

for every property:

for every entity:

if the entity has already been encountered:

compute the proximity
add the entity and the proximity to the array

else:

create a new array with the entity as header
compute the proximity
add the entity and the proximity to the array

note that this algorithm computes only the non-zero proximities, for this reason the computational complexity of projection is estimate to be:

NM²

where N is the number of entities and M is the average number of entities it is linked to. The algorithm is efficient when:

M<<N

This happens when the matrices are sparse. Said another way, a proximity is computed for every link, thus the number of computations is equal to the number of links M: this is technically feasible only if the ratio N/M is much smaller than one, i.e. if the graph is sparse.

In our example, the projection algorithm works as follows. We project type-square entities onto type-circle entities to obtain P_{S|C} (B_{SC} on the left and B_{CS} on the right):

$$\begin{matrix}\to & {E}_{1}^{S} & {P}_{1}^{C} & {P}_{7}^{C} & \\ & {E}_{2}^{S} & {P}_{2}^{C} & & \\ & {E}_{3}^{S} & {P}_{2}^{C} & {P}_{3}^{C} & {P}_{4}^{C} \\ & {E}_{4}^{S} & {P}_{4}^{C} & {P}_{5}^{C} & \\ & {E}_{5}^{S} & {P}_{5}^{C} & {P}_{6}^{C} & \\ & {E}_{6}^{S} & {P}_{3}^{C} & {P}_{6}^{C} & {P}_{7}^{C}\end{matrix} \times \begin{matrix}\to & {P}_{1}^{C} & {E}_{1}^{S} & \\ \to & {P}_{7}^{C} & {E}_{1}^{S} & {E}_{6}^{S} \\ & {P}_{2}^{C} & {E}_{2}^{S} & {E}_{3}^{S} \\ & {P}_{3}^{C} & {E}_{3}^{S} & {E}_{6}^{S} \\ & {P}_{4}^{C} & {E}_{3}^{S} & {E}_{4}^{S} \\ & {P}_{5}^{C} & {E}_{4}^{S} & {E}_{5}^{S} \\ & {P}_{6}^{C} & {E}_{5}^{S} & {E}_{6}^{S}\end{matrix} = \begin{matrix}\to & {E}_{1}^{S} 1 & {E}_{6}^{S} {z}_{1} \\ & & \\ & & \\ & & \\ & & \\ & & \end{matrix}$$

$$\begin{matrix} & {E}_{1}^{S} & {P}_{1}^{C} & {P}_{7}^{C} & \\ \to & {E}_{2}^{S} & {P}_{2}^{C} & & \\ & {E}_{3}^{S} & {P}_{2}^{C} & {P}_{3}^{C} & {P}_{4}^{C} \\ & {E}_{4}^{S} & {P}_{4}^{C} & {P}_{5}^{C} & \\ & {E}_{5}^{S} & {P}_{5}^{C} & {P}_{6}^{C} & \\ & {E}_{6}^{S} & {P}_{3}^{C} & {P}_{6}^{C} & {P}_{7}^{C}\end{matrix} \times \begin{matrix} & {P}_{1}^{C} & {E}_{1}^{S} & \\ & {P}_{7}^{C} & {E}_{1}^{S} & {E}_{6}^{S} \\ \to & {P}_{2}^{C} & {E}_{2}^{S} & {E}_{3}^{S} \\ & {P}_{3}^{C} & {E}_{3}^{S} & {E}_{6}^{S} \\ & {P}_{4}^{C} & {E}_{3}^{S} & {E}_{4}^{S} \\ & {P}_{5}^{C} & {E}_{4}^{S} & {E}_{5}^{S} \\ & {P}_{6}^{C} & {E}_{5}^{S} & {E}_{6}^{S}\end{matrix} = \begin{matrix} & {E}_{1}^{S} 1 & {E}_{6}^{S} {z}_{1} \\ \to & {E}_{2}^{S} 1 & {E}_{3}^{S} {z}_{6} \\ & & \\ & & \\ & & \\ & & \end{matrix}$$

$$\begin{matrix} & {E}_{1}^{S} & {P}_{1}^{C} & {P}_{7}^{C} & \\ & {E}_{2}^{S} & {P}_{2}^{C} & & \\ \to & {E}_{3}^{S} & {P}_{2}^{C} & {P}_{3}^{C} & {P}_{4}^{C} \\ & {E}_{4}^{S} & {P}_{4}^{C} & {P}_{5}^{C} & \\ & {E}_{5}^{S} & {P}_{5}^{C} & {P}_{6}^{C} & \\ & {E}_{6}^{S} & {P}_{3}^{C} & {P}_{6}^{C} & {P}_{7}^{C}\end{matrix} \times \begin{matrix} & {P}_{1}^{C} & {E}_{1}^{S} & \\ & {P}_{7}^{C} & {E}_{1}^{S} & {E}_{6}^{S} \\ \to & {P}_{2}^{C} & {E}_{2}^{S} & {E}_{3}^{S} \\ \to & {P}_{3}^{C} & {E}_{3}^{S} & {E}_{6}^{S} \\ \to & {P}_{4}^{C} & {E}_{3}^{S} & {E}_{4}^{S} \\ & {P}_{5}^{C} & {E}_{4}^{S} & {E}_{5}^{S} \\ & {P}_{6}^{C} & {E}_{5}^{S} & {E}_{6}^{S}\end{matrix} = \begin{matrix} & {E}_{1}^{S} 1 & {E}_{6}^{S} {z}_{1} & & \\ & {E}_{2}^{S} 1 & {E}_{3}^{S} {z}_{6} & & \\ \to & {E}_{3}^{S} 1 & {E}_{2}^{S} {z}_{6} & {E}_{6}^{S} {z}_{3} & {E}_{4}^{S} {z}_{5} \\ & & & & \\ & & & & \\ & & & & \end{matrix}$$

$$\begin{matrix} & {E}_{1}^{S} & {P}_{1}^{C} & {P}_{7}^{C} & \\ & {E}_{2}^{S} & {P}_{2}^{C} & & \\ & {E}_{3}^{S} & {P}_{2}^{C} & {P}_{3}^{C} & {P}_{4}^{C} \\ \to & {E}_{4}^{S} & {P}_{4}^{C} & {P}_{5}^{C} & \\ & {E}_{5}^{S} & {P}_{5}^{C} & {P}_{6}^{C} & \\ & {E}_{6}^{S} & {P}_{3}^{C} & {P}_{6}^{C} & {P}_{7}^{C}\end{matrix} \times \begin{matrix} & {P}_{1}^{C} & {E}_{1}^{S} & \\ & {P}_{7}^{C} & {E}_{1}^{S} & {E}_{6}^{S} \\ & {P}_{2}^{C} & {E}_{2}^{S} & {E}_{3}^{S} \\ & {P}_{3}^{C} & {E}_{3}^{S} & {E}_{6}^{S} \\ \to & {P}_{4}^{C} & {E}_{3}^{S} & {E}_{4}^{S} \\ \to & {P}_{5}^{C} & {E}_{4}^{S} & {E}_{5}^{S} \\ & {P}_{6}^{C} & {E}_{5}^{S} & {E}_{6}^{S}\end{matrix} = \begin{matrix} & {E}_{1}^{S} 1 & {E}_{6}^{S} {z}_{1} & & \\ & {E}_{2}^{S} 1 & {E}_{3}^{S} {z}_{6} & & \\ & {E}_{3}^{S} 1 & {E}_{2}^{S} {z}_{6} & {E}_{6}^{S} {z}_{3} & {E}_{4}^{S} {z}_{5} \\ \to & {E}_{4}^{S} 1 & {E}_{3}^{S} {z}_{5} & {E}_{5}^{S} {z}_{4} & \\ & & & & \\ & & & & \end{matrix}$$

$$\begin{matrix} & {E}_{1}^{S} & {P}_{1}^{C} & {P}_{7}^{C} & \\ & {E}_{2}^{S} & {P}_{2}^{C} & & \\ & {E}_{3}^{S} & {P}_{2}^{C} & {P}_{3}^{C} & {P}_{4}^{C} \\ & {E}_{4}^{S} & {P}_{4}^{C} & {P}_{5}^{C} & \\ \to & {E}_{5}^{S} & {P}_{5}^{C} & {P}_{6}^{C} & \\ & {E}_{6}^{S} & {P}_{3}^{C} & {P}_{6}^{C} & {P}_{7}^{C}\end{matrix} \times \begin{matrix} & {P}_{1}^{C} & {E}_{1}^{S} & \\ & {P}_{7}^{C} & {E}_{1}^{S} & {E}_{6}^{S} \\ & {P}_{2}^{C} & {E}_{2}^{S} & {E}_{3}^{S} \\ & {P}_{3}^{C} & {E}_{3}^{S} & {E}_{6}^{S} \\ & {P}_{4}^{C} & {E}_{3}^{S} & {E}_{4}^{S} \\ \to & {P}_{5}^{C} & {E}_{4}^{S} & {E}_{5}^{S} \\ \to & {P}_{6}^{C} & {E}_{5}^{S} & {E}_{6}^{S}\end{matrix} = \begin{matrix} & {E}_{1}^{S} 1 & {E}_{6}^{S} {z}_{1} & & \\ & {E}_{2}^{S} 1 & {E}_{3}^{S} {z}_{6} & & \\ & {E}_{3}^{S} 1 & {E}_{2}^{S} {z}_{6} & {E}_{6}^{S} {z}_{3} & {E}_{4}^{S} {z}_{5} \\ & {E}_{4}^{S} 1 & {E}_{3}^{S} {z}_{5} & {E}_{5}^{S} {z}_{4} & \\ \to & {E}_{5}^{S} 1 & {E}_{4}^{S} {z}_{4} & {E}_{6}^{S} {z}_{2} & \\ & & & & \end{matrix}$$

$$\begin{matrix} & {E}_{1}^{S} & {P}_{1}^{C} & {P}_{7}^{C} & \\ & {E}_{2}^{S} & {P}_{2}^{C} & & \\ & {E}_{3}^{S} & {P}_{2}^{C} & {P}_{3}^{C} & {P}_{4}^{C} \\ & {E}_{4}^{S} & {P}_{4}^{C} & {P}_{5}^{C} & \\ & {E}_{5}^{S} & {P}_{5}^{C} & {P}_{6}^{C} & \\ \to & {E}_{6}^{S} & {P}_{3}^{C} & {P}_{6}^{C} & {P}_{7}^{C}\end{matrix} \times \begin{matrix} & {P}_{1}^{C} & {E}_{1}^{S} & \\ \to & {P}_{7}^{C} & {E}_{1}^{S} & {E}_{6}^{S} \\ & {P}_{2}^{C} & {E}_{2}^{S} & {E}_{3}^{S} \\ \to & {P}_{3}^{C} & {E}_{3}^{S} & {E}_{6}^{S} \\ & {P}_{4}^{C} & {E}_{3}^{S} & {E}_{4}^{S} \\ & {P}_{5}^{C} & {E}_{4}^{S} & {E}_{5}^{S} \\ \to & {P}_{6}^{C} & {E}_{5}^{S} & {E}_{6}^{S}\end{matrix} = \begin{matrix} & {E}_{1}^{S} 1 & {E}_{6}^{S} {z}_{1} & & \\ & {E}_{2}^{S} 1 & {E}_{3}^{S} {z}_{6} & & \\ & {E}_{3}^{S} 1 & {E}_{2}^{S} {z}_{6} & {E}_{6}^{S} {z}_{3} & {E}_{4}^{S} {z}_{5} \\ & {E}_{4}^{S} 1 & {E}_{3}^{S} {z}_{5} & {E}_{5}^{S} {z}_{4} & \\ & {E}_{5}^{S} 1 & {E}_{4}^{S} {z}_{4} & {E}_{6}^{S} {z}_{2} & \\ \to & {E}_{6}^{S} 1 & {E}_{1}^{S} {z}_{1} & {E}_{3}^{S} {z}_{3} & {E}_{5}^{S} {z}_{2}\end{matrix}$$

### d) Family of Proximity Matrices and Contexts

### Linear Combination

The linear combination algorithm is described by the following pseudo-code where we are linearly combining the proximity matrices A and B in their adjacency list with proximities form (note that by construction A and B have the same number of lines (entities)):

for every entity of A:

for every child entity in A:

if the child entity is also a child entity in B:

linearly combine their proximities
add the sum to the linearly combined matrix

else:

add to the linearly combined matrix

The computational complexity of linear combination is estimable as follows:

NM²

To linearly combine more matrices we iterate the procedure.

In our example, the linear combination algorithm works as follows. We linearly combine the matrices P_{S|C} and P_{S|T} to obtain P_{S}(α)=αP_{S|T}+(1−α)P_{S|C}):

$$\begin{matrix} & {E}_{1}^{S} 1 & {E}_{2}^{S} {w}_{4} & {E}_{6}^{S} {w}_{3} & & \\ & {E}_{2}^{S} 1 & {E}_{1}^{S} {w}_{4} & {E}_{6}^{S} {w}_{6} & & \\ α & {E}_{3}^{S} 1 & {E}_{5}^{S} {w}_{2} & {E}_{6}^{S} {w}_{5} & & \\ & {E}_{4}^{S} 1 & & & & \\ & {E}_{5}^{S} 1 & {E}_{3}^{S} {w}_{2} & {E}_{6}^{S} {w}_{1} & & \\ & {E}_{6}^{S} 1 & {E}_{1}^{S} {w}_{3} & {E}_{2}^{S} {w}_{6} & {E}_{3}^{S} {w}_{5} & {E}_{5}^{S} {w}_{1}\end{matrix} + \begin{matrix} & {E}_{1}^{S} 1 & {E}_{6}^{S} {z}_{1} & & \\ & {E}_{2}^{S} 1 & {E}_{3}^{S} {z}_{6} & & \\ ( 1 - α ) & {E}_{3}^{S} 1 & {E}_{2}^{S} {z}_{6} & {E}_{6}^{S} {z}_{3} & {E}_{4}^{S} {z}_{5} \\ & {E}_{4}^{S} 1 & {E}_{3}^{S} {z}_{5} & {E}_{5}^{S} {z}_{4} & \\ & {E}_{5}^{S} 1 & {E}_{4}^{S} {z}_{4} & {E}_{6}^{S} {z}_{2} & \\ & {E}_{6}^{S} 1 & {E}_{1}^{S } {z}_{1} & {E}_{3}^{S} {z}_{3} & {E}_{5}^{S} {z}_{2}\end{matrix} = \begin{matrix}{E}_{1}^{S} 1 & {E}_{2}^{S} α {w}_{4} & {E}_{6}^{S} α {w}_{3} + ( 1 - α ) {z}_{1} & & \\ {E}_{2}^{S} 1 & {E}_{1}^{S} α {w}_{4} & {E}_{6}^{S} α {w}_{6} & {E}_{3}^{S} ( 1 - α ) {z}_{6} & \\ {E}_{3}^{S} 1 & {E}_{5}^{S} α {w}_{2} & {E}_{6}^{S} α {w}_{5} + ( 1 - α ) {z}_{3} & {E}_{2}^{S} ( 1 - α ) {z}_{6} & {E}_{4}^{S} ( 1 - α ) {z}_{5} \\ {E}_{4}^{S} 1 & {E}_{3}^{S} ( 1 - α ) {z}_{5} & {E}_{5}^{S} ( 1 - α ) {z}_{4} & & \\ {E}_{5}^{S} 1 & {E}_{3}^{S} α {w}_{2} & {E}_{6}^{S} α {w}_{1} + ( 1 - α ) {z}_{2} & {E}_{4}^{S} ( 1 - α ) {z}_{4} & \\ {E}_{6}^{S} 1 & {E}_{1}^{S} α {w}_{3} + ( 1 - α ) {z}_{1} & {E}_{2}^{S} α {w}_{6} & {E}_{3}^{S} α {w}_{5} + ( 1 - α ) {z}_{3} & {E}_{5}^{S} α {w}_{1} + ( 1 - α ) {z}_{2}\end{matrix}$$

FIG. 6C shows the implementation of the present method with reference to the example developed in the present section: a) the adjacency lists B_{XY} are created starting from input databases; b) properties are promoted to entities and the adjacency lists B_{YX} are obtained by transposition; c) a proximity matrix P_{X|Y} for every pair type of entity-type of property is obtained by projection; d) a family of proximity matrices P_{X}(αₓ, βₓ . . . ) for every type of entity is obtained by linear combination; e) the multi-partite graph database is queried by specifying a type of entity, a context and a set of nodes; the query returns a sub-graph of the given context for the given type of entities containing the given nodes.

### APPLICATIONS

Some practical implementations of the present invention are herein provided.

### Discovery Engine.

The discovery engine is an implementation of the invention that allows the user to query at least one entity against a family of proximity matrixes.

The simplex associated to a family of proximity matrices contains infinite points corresponding to all contexts of entities of a given type, these have been obtained by linear combination of all the projections over all property types that an entity type has.

Thus, each point of the simplex reflects all the points of view of a user can select to query the discovery engine and obtain a sub-set of entities sorted by proximity which contextualizes the a linear combination of the semantic relationship between a type of entity and the type of properties.

Thus each point of the simplex reflects all the points of view a user can select to query the discovery engine and obtain a sub-set of entities, sorted by proximity, which contextualizes the searched entity.

A query of a single entity addresses the problem of contextualizing that entity with a sub-set of entities.

A query of two entities addresses the problem of finding a path linking the two entities in a sub-set of contextualizing entities.

A query of three or more entities addresses the problem of finding a cluster in sub-set of contextualizing entities.

The meaning of contextualization of entities encompasses possible interpretations such as semantic relevance, recommendation, suggestion of relevant content, depending on the databases sourced to construct the multi-partite graph.

By combining queries against collections of families of proximity matrixes it is possible to obtain a set of sub-graphs belonging to one or more families of proximity matrixes, organized in such a way that contextualization of entities can be interactively accessed, represented or displayed by any chosen point of view.

The method described in the details of invention can be applied to multiple types of entities and to different domains of human knowledge: thus the method allows the discovery engine to contextualize any entity.

Since any point of the simplex for a given family of proximity matrixes associated to a type of entity is a linear combination of the projections entity-property, it is possible to contextualize two entities and obtain relevant results on multiple semantic aspects which may be of interest to a user of the discovery engine.

The advantage of computing any point in the simplex by linear combination allows to access to any array of contextualization in real time.

Consistent with the present invention, there are several ways that this method can be adapted for various purposes, such as information retrieval; for recommendation of contents and products; for synthesizing, organizing and accessing to contextual information.

Complementarity with Search Engines

The discovery engine allows an individual to overview a domain of knowledge by contextualizing an entity, despite being not an expert in that specific field.

In this sense, the discovery engine is complementary to a web search engine: the latter organizes the importance of web pages related to an entity, thus it ranks the sources about the same entity (e.g. a movie). The discovery engine organizes the relationships contextualizing the searched entity with the resulted neighbor entities. Each entity can carry multiple information layers, such as the source of the webpages (or other pages from corpuses of knowledge) about that entity.

In this way, the discovery engine solves the problem to find pertinent entities, synthesize and organize the relationships they hold for a quick access to the information of each entity—such a task would otherwise take into account accessing the document or media about the searched entity (e.g. a topic); enumerate a list the possible most relevant entities (other topics); access each of the documents or media related to such entities; classify and organize all of the found entities consistently for each type of relations and relatedness which a user may consider.

The integration and combination of heterogeneous corpuses of knowledge into a multi-partite graph allows to obtain a discovery engine for general purpose in which any entity can be queried against the family of proximity matrixes obtained for all the possible projections of entity-property.

### UI/UX Discovery Engine

The contextualization of the results can be emphasized by interfaces enhancing the organization provided by the discovery engine, so that visual interfaces can be functional to overview and traverse a knowledge domain; to summarize meaningful relationships between entities; to quickly access multiple information layers associated to entities; to quickly access a minimum number of properties characterizing a set of entities in the sub-graph.

### DEFINITIONS

Iteration of queries: a query of an entity belonging to a sub-graph returned by a previous query;

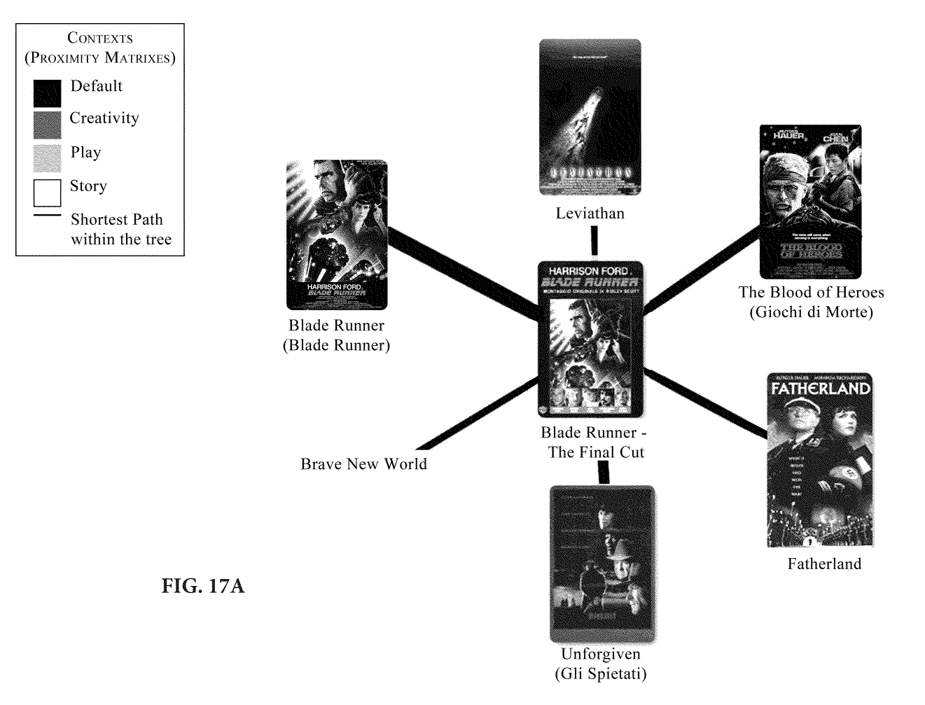

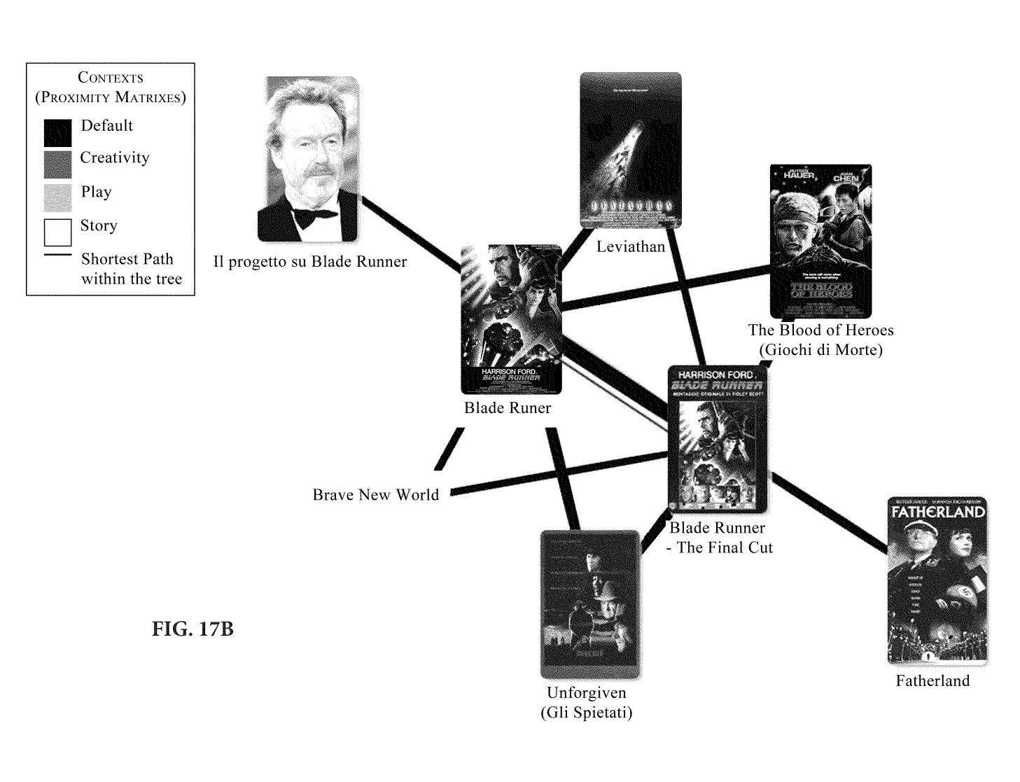

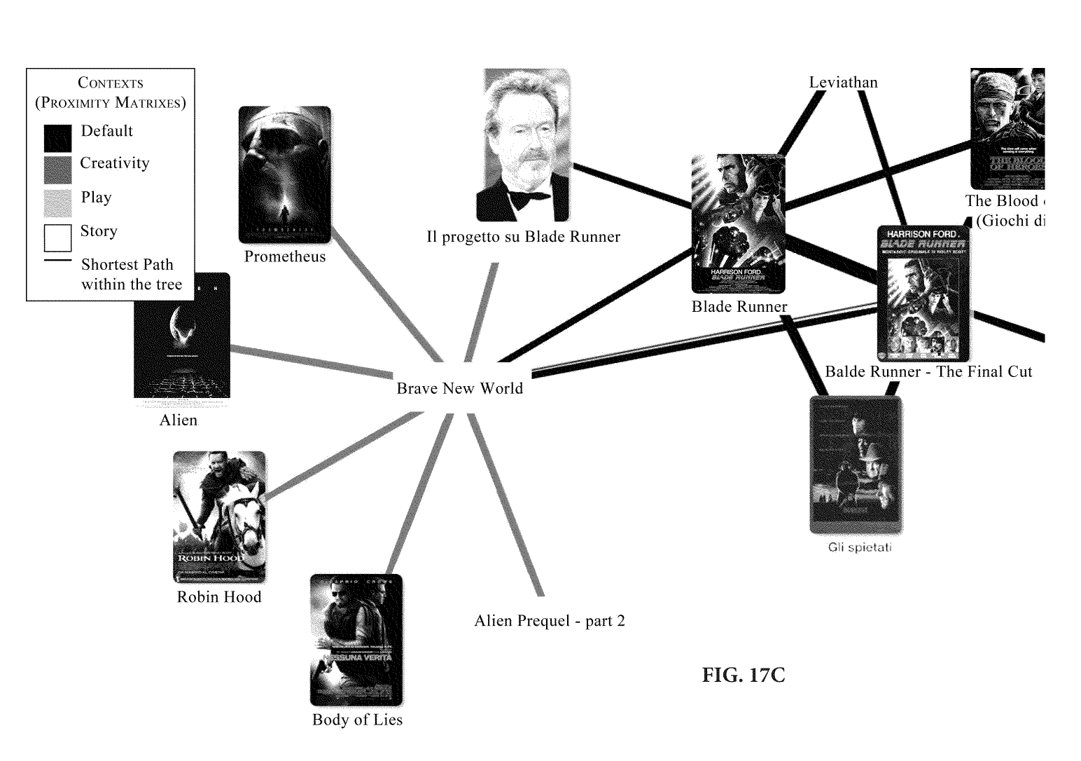

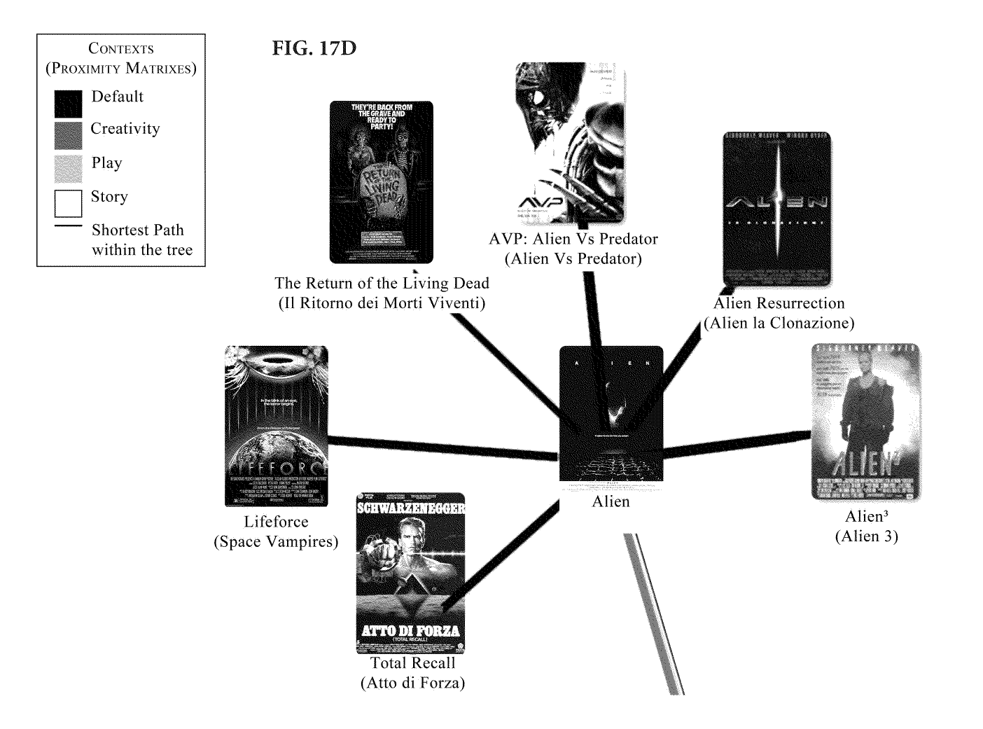

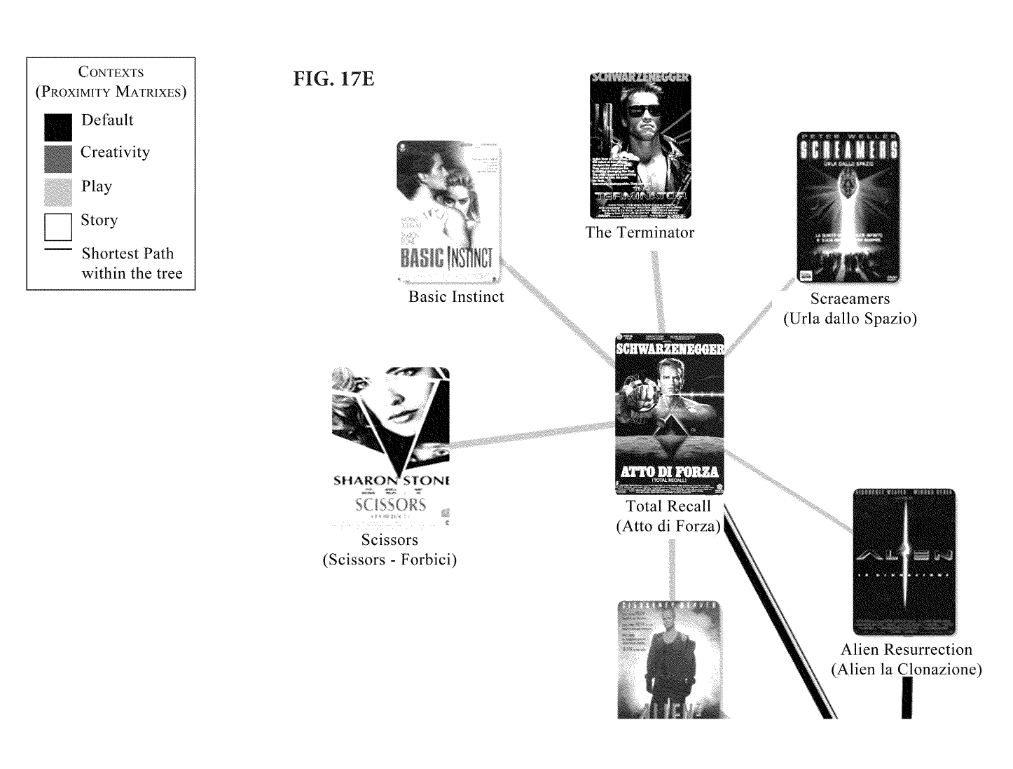

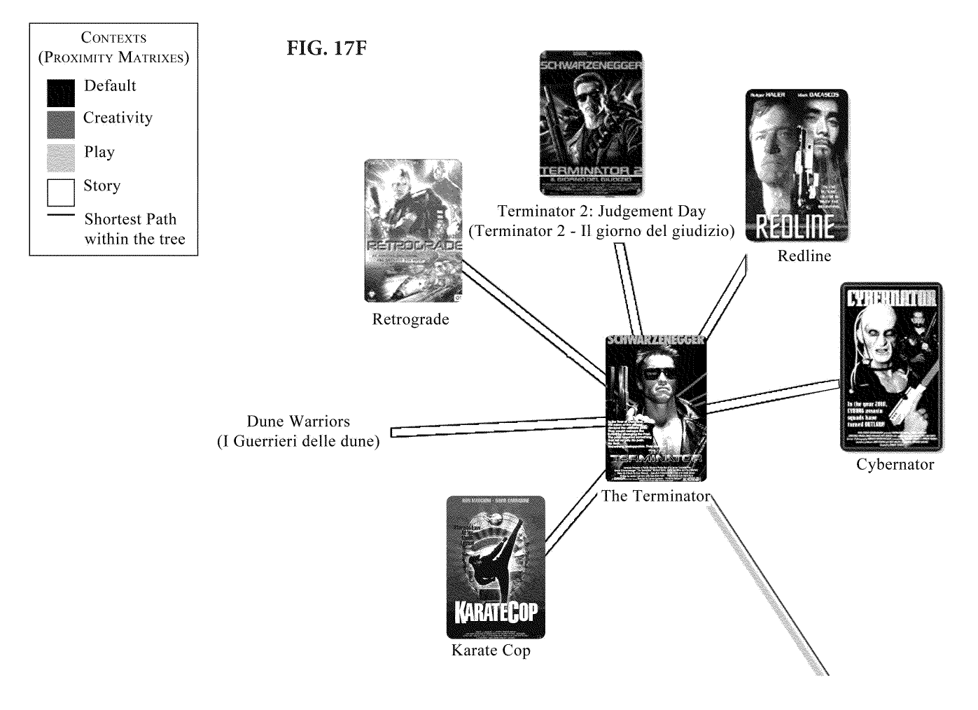

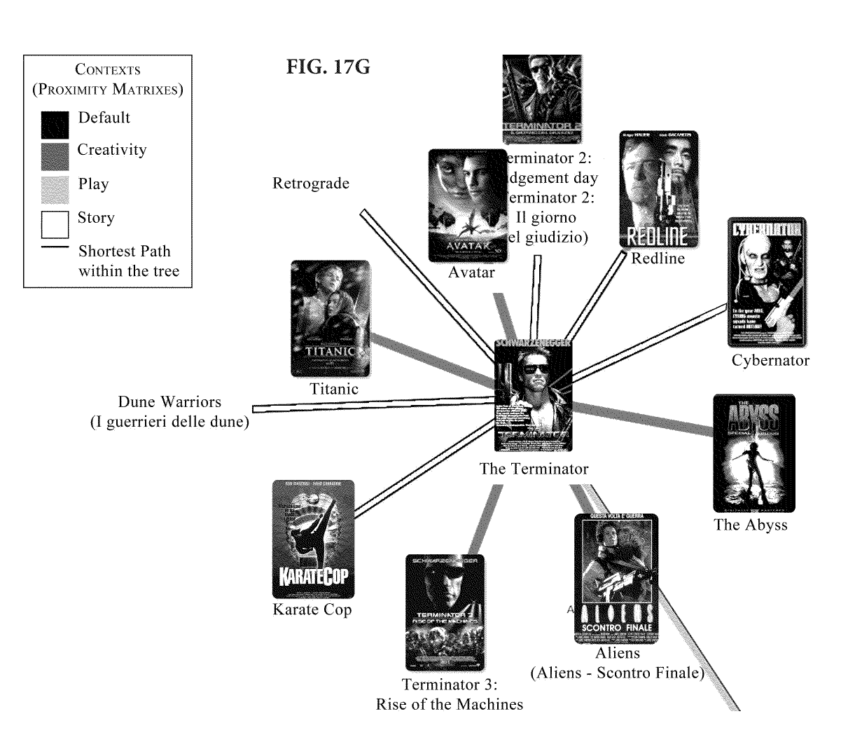

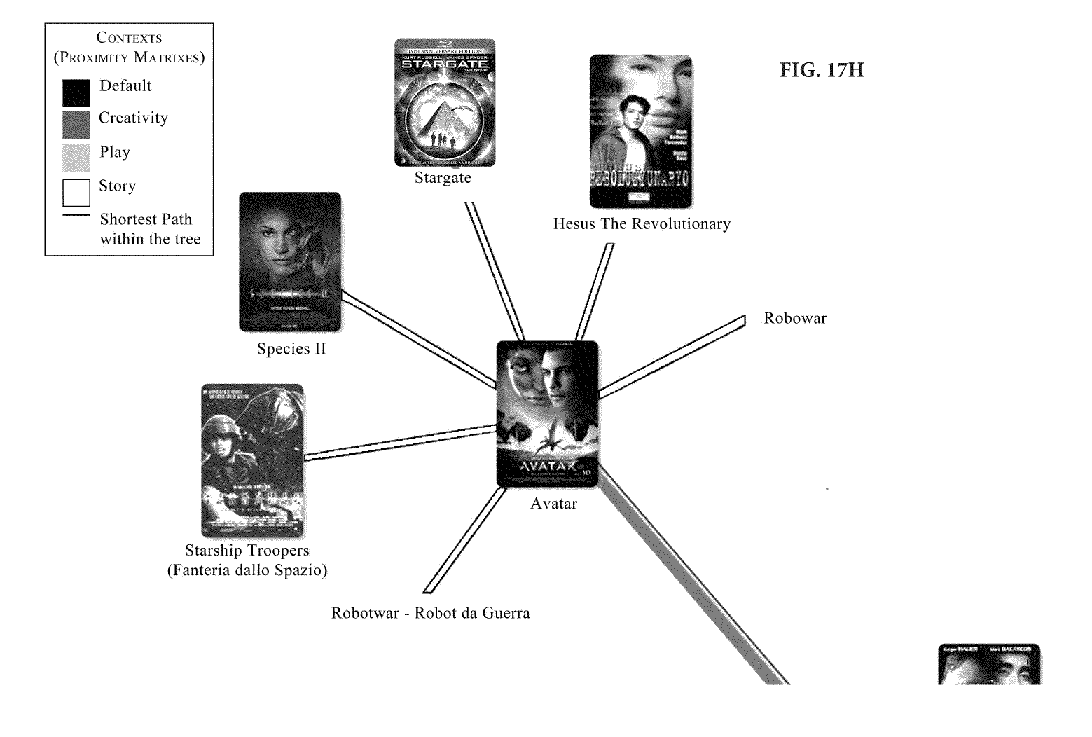

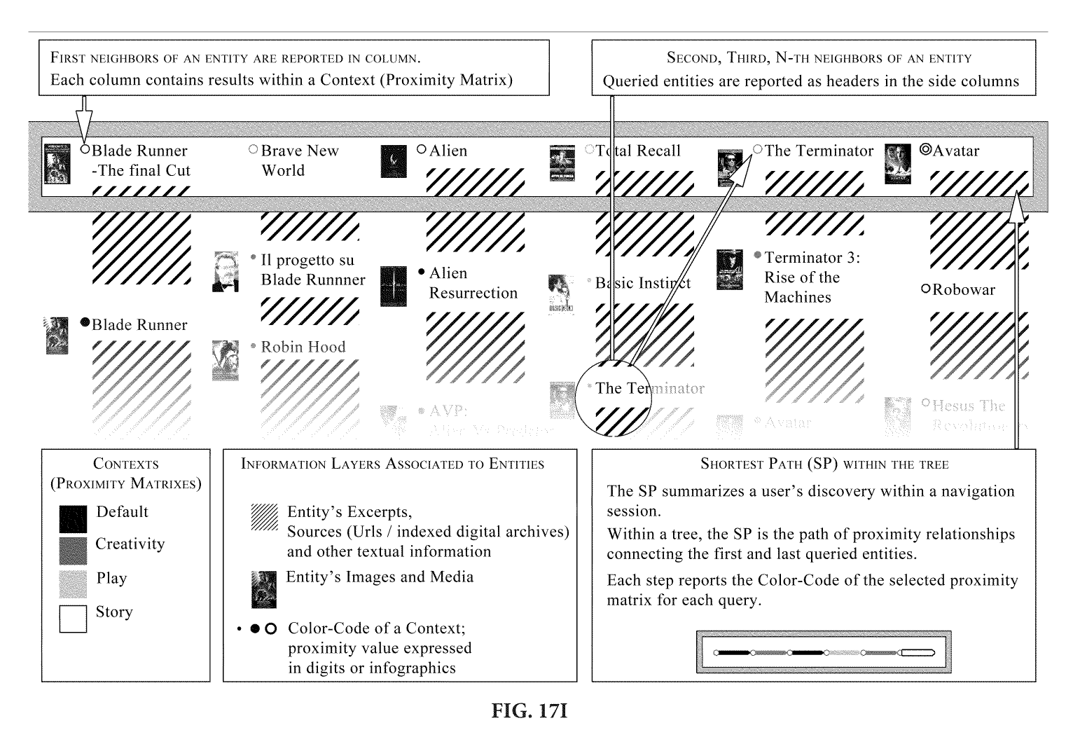

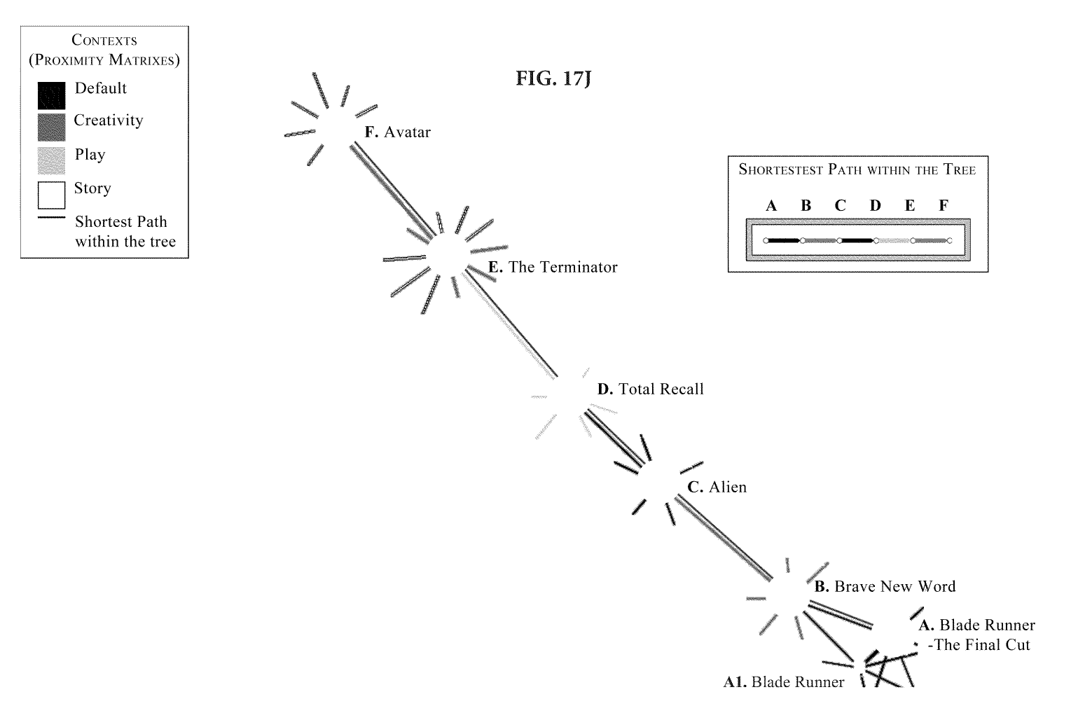

shortest-path within the tree: the path of relationships connecting two entities within a tree of the sub-graph; the shortest path can contain relationships obtained from different contexts, helping the user to summarize different semantic layers connecting two entities; (see: FIG. 17J)

textual-grid layout: an equivalent representation of a tree of the sub-graph by means of columns and rows, where each column displays the neighbors of the heading entity, ordered by proximity; columns' headers result aligned in the top row, so that the top row represents the shortest-path within the tree; (see: FIG. 17I)

### Recommendations for Adopting Visual Interfaces to Display the Discovery Engine Results

A user can choose the context to obtain recommendations for an entity and select a point in the simplex by means of buttons, either by means of a controller to adjust the parameters of the linear combination of the family of proximity matrixes.

Each point of the simplex is associated to a linear combination of the family of proximity matrixes and thus is associated to a context.

Visual codes, such as color codes, can be associated to specific points in the simplex to guide the user.

The iteration of queries on entities belonging to a sub-graph allows the user to overview a knowledge area from different points of view, that is for each context associated to the selected points of the simplex; and allows to traverse the multipartite-graph, thus crossing and finding connections with diverse knowledge areas.

A dual and equivalent method for accessing the multi-partite graph consists in adopting graphically displayed graphs and textual-grid layouts to represent the results of queries.

A graphically displayed graph represent the sub-graph obtained by the discovery engine as a graph where entities are nodes and proximity relationships are weighted links; each link adopts the visual code of the context selected for querying an entity. The shortest-path within a tree of the sub-graph summarizes the steps of relationships connecting two selected entities, each relationship can belong to different contexts.

The textual-grid layout can be designed in such a way that each column represents a sub-graph of entities queried within a specific context. Each entity represented in a cell of the column-row layout can be decorated with excerpts, media or info-graphic. The iteration of queries allows to organize columns aside of each other. The columns' headers results aligned in the top row. Adopting excerpts or other meaningful information for representing the nodes, allows the user to read the sequence of entities connected by the shortest-path. We found this type of interface particularly useful to display and organize the relationships of entities of factual knowledge databases, so that the definitions and excerpts of topics result organized to convey a logical meaning to the steps of relationships connecting topics, and they help in depicting a certain knowledge area.

Both the layouts can be designed in order to inform the user on the strength of contextual relationships between the entities. A graphically displayed graph can carry such information on the thickness of the links; a textual-grid layout can carry such information by reporting the proximity value as digit or percentage for each entity-entity relationship.

Multiple information can be layered on top of nodes to inform about salient features of entities, to help the user in overviewing and quickly accessing meaningful options related to an entity, and to guide further exploration of related knowledge areas by iterating the queries.

Information layers can account of excerpts and descriptions; indexed URLs of webpages referencing an entity; indexed media and images associated to an entity; pie-charts or other info-graphics summarizing key features of an entity.

Exposing entities' properties in the sub-graph or in portions of the sub-graph can help the user to access a minimum number of properties for characterizing a set of entities.

### Example (General)

The embodiment of the discovery engine can be applied to multiple domains such as, but not exclusively, movies, recipes, books; patents and intellectual property rights; chemical compounds, materials, medical, pharmacological; authors, scientific papers and publications, people contributing to specific domain of art; industrial products; crafted products and artworks; factual knowledge on ideas, topics, people, things and places.

### Example Movies

As example in the movie domain, the contextualization of movies embraces the problem of providing a subset of related, similar or recommended movies for at least one movie queried in the discovery engine.

It is possible to name particular chosen points of the family of proximity matrixes over a type of entity.

As example for the simplex relative to the entity “movie”, it is possible to query at least a movie and obtain movies contextualized by the points of view of “creativity” or “story”, being the two points specific linear combinations of the family of proximity matrixes.

By enabling properties to entities, it is possible to exploit incidental information within a movie database so that to also obtain, from multi-partite graph constructed on the entity “movie”, a discovery engine for the entity “actor” providing recommendations on similar actors.

### Example Taste

As example, a discovery engine for contextualizing entities in the domain of food & nutrition can be obtained from a family of proximity matrixes having as vertexes the projections recipe-ingredient; recipe-nutritional values; recipe-main ingredients; recipe-flavors.

### Example Human Knowledge

As example, a discovery engine for contextualizing entities in the domain of factual knowledge can be obtained by a family of proximity matrixes over topics within an encyclopedia or other corpora of knowledge.

### Example Intellectual Property

As example, a discovery engine for contextualizing entities in the domain of intellectual property can be obtained from a simplex having as vertexes the projections patent-creator; patent-field of invention; patent-legal attorney; patent-classification of invention; patent-citations; patent-co-citations.

Reversely, it is possible to obtain a discovery engine for contextualizing the legal attorneys according to the intellectual properties they operated on.

Each contextualization reflects different semantic aspects for assessing the problem of relevance in patents, which can be parameterized for computing the linear combination associated to a point in the simplex: it is the user who chooses the parameters, that is the user chooses the “amount” of projections to be linearly combined.

### Example Chemistry

The discovery engine can be used to discover compounds and molecules related to a given one; to discover related inventions or related fields of inventions associated to a cluster of patents; to discover products with similar properties; to discover other options of compounds, remedies or treatments which are related to at least a given one.

### Example Industrial Application

The same technique can be applied in knowledge management for industrial problems, in order to group entities, which share similar properties, to observe and measure how certain group of entities is matched with other groups of entities, and facilitate the analysis to overcome problems contextualized by other problems whose solution is known.

### Pathsearch

A query of at least two entities addresses the problem of finding paths linking the queried entities, in such a way to identify the minimum and other optimal sets of properties to characterize those entities.

A query of two entities can apply shortest-path algorithms, such as Dijkstra's algorithm, on the family of weighted graphs; the shortest path shows the relations between the minimum number of entities for connecting two given entities belonging to a family of proximity matrixes.

As example, the discovery engine can return the shortest-path for contextualizing two topics within an encyclopedia (e.g. “Leonardo Da Vinci” and “Italian Renaissance”); two patents within a corpus of patents; two movies or two entities of the same type.

In this short example on the movie domain, we applied the Dijkstra algorithm to find the shortest path within a proximity matrix, by querying two entities as starting and ending point:

a) within the Proximity Matrix computed for movies against the writer of the screenplay. We selected ‘Akira’ (a Japanese cartoon 1988 movie written by Katsuhiro Tomo and Izo Hashimoto) as starting point and ‘Star Wars’ (written by George Lucas). We obtain: ‘Akira’, ‘Wonder Boys’; ‘The Amazing Spider-Man’; ‘Gambit’; ‘Unfaithful’; ‘The Twist’; ‘I motorizzati’; ‘Per amore . . . per magia . . . ’; ‘La guerra del ferro—Ironmaster’; ‘Master of the World’; ‘Stir of Echoes’; ‘Jurassic Park’; ‘Indiana Jones and the Kingdom of the Crystal Skull’; ‘American Graffiti’; ‘Star Wars’.
b) within the Proximity Matrix computed for movies against the director. We selected “Blade Runner” as starting point and ‘Alien’ as ending point. We obtain: ‘Blade Runner’, ‘All the Invisible Children’, and ‘Alien’.
c) within the Proximity Matrix computed for movies against the starring actors. We selected ‘Snow White’ as starting point and ‘The Lion King’ as ending point. We obtain: ‘Snow White’; ‘Seven Footprints to Satan’; ‘Should Men Walk Home?’; ‘Le stranezze di Jane Palmer’; ‘Diritto d'amare’; ‘The St. Valentine's Day Massacre’; ‘Max Dugan Returns’; ‘The Lion King’.

### Resilience and Slow Time Evolution of the Multipartite Graph

For each domain of human knowledge, information is constantly ameliorated and enriched; however, consolidated information on entities is hardly to be changed. As example, if a movie or a patent is known to exist, hardly the content identifying that entity will change over time. For topics within corpus of knowledge, information may vary substantially over time or even undergo vandalism, which often happens in the case of corpora of knowledge within created-common license: yet hardly the corpora of knowledge will be corrupted or compromised.

The fact sources of human knowledge are resilient to be abruptly changed reflects also on the multipartite graph.

The integration and combination of multiple databases into a multi-partite graph allows the graph to be resilient and to obtain manifold embodiment of the discovery engine for each type of entity, or type of properties enabled to entities, within a domain.

While content is redundant and popularity of web pages are subjected to fluctuations over time, entities are unique and relatively stable over time.

This allows the discovery engine to provide results independently from the fluctuations in sourced web archives, and to aggregate and organize URLs as references related to entities.

Maintaining a collection of up-to-date indexed URLs referring to an entity can be executed ex-post the creation of the multi-partite graph: popularity or other statistical methods applied to the collected URLs are independent from the results of the multi-partite graph.

This allows allocating a commercial space for promoting an entity, such as on an indexed web page, without interfering with the proximity results obtained from the discovery engine. Results of the discovery engine are user-driven for each selected proximity matrix.

### Refinement of Entities

The multi-partite graph database contains information coming from a multitude of source databases. There is the problem that there might be redundant entities, i.e. copies of the same entity coming from different sources. With the use of proximity matrices, we can identify entities' doubles, having in common a very high proximity respect to the statistical distribution of proximity values, so that we can reduce the redundancy of duplicated entities. The iteration of the above converges to multi-partite graph of, what we can call, “pure” entities.

The utility for the individual is that the discovery engine allows identifying equivalent entities, despite the fact an entity can be named in different ways and also in multiple languages.

Independence from Language

Notably, the properties characterizing an entity are independent by the language used to describe them; for example the actors of a movie are the same independently of the languages used in the database and they will always be properties of a given movie. Therefore an entity is unique and consistent among any language adopted to describe it, and the multi-partite graph can be constructed choosing any preferred language.

The invention allows to measure the proximity between two contextualized entities: thus if, in a range of real number between 0.0 and 1.0, the proximity is sufficiently closed to 1.0, the discovery engine can be also used to understand whether two entities are identical. The utility for the individual is that the discovery engine allows identifying equivalent entities, despite the fact an entity can be named in different ways and also in multiple languages.

The multi-partite graph database contains information coming from a multitude of source databases.

There is the problem that there might be redundant entities, i.e. copies of the same entity coming from different sources. With the use of proximity matrices we can identify entities' doubles having a very high proximity respect to the statistical distribution of proximity values, and reduce redundancy of duplicated entities. The iteration of the above converges to multi-partite graph of, what we can call, “pure” entities.

It will be appreciated that still further embodiments of the present invention will be apparent to those skilled in the art in view of the above disclosure. It is to be understood that the present invention is by no means limited to the particular embodiments herein disclosed, but also comprises any modifications or equivalents within the scope of the invention.

### EXAMPLES

### Example 1

### Discovery Engine on Inventions

The sample data collected for constructing the multi-partite graph database of patents considers the USPTO patents from 1976 to 5 Feb. 2013: the size of our sample is 4.8M patents. Only patents with title formed as “US”+7-digits-id-number have been considered as entities: patent applications such as US20120221559 are not included. Patents registered elsewhere than USPTO are also not included. For each patent we extracted the following properties: Inventors, Assignee, Field of Search, Citations.

As first step, we first consider the “patents” as entities, and calculate the proximity matrices for each projection of the entities (patents) against their properties. As second step, we consider their properties as entities as well, and obtain the proximity matrix for the patents' citations projected onto patents.

With this procedure, we construct a family of proximity matrices.

The meaning of CIT matrix (patents projected onto citations) is that it carries the contextualization, or similarity of patents sharing common citations before their filing date; the meaning of PCIT matrix (citations projected onto patents) is that it carries the contextualization, or similarity of patents which have been cited after their filing date. We combined the “Inventors” and “Assignee” property into a “Creator” property. Thus, we considered four matrices: CRE (entity “patent” projected onto entity “Creator”), FOS (entity “patent” projected onto entity “Field of Search”), CIT (entity “patent” projected onto entity “Citations”), PCIT (entity “citations” projected onto entity “patents”). Each matrix is a vertex of the simplex. It is possible to obtain any matrix carrying a type of contextualization or similarity among patents by linear combination of the vertexes. Such linear combination reflects the amount of a type of contextualization or similarity contained in each matrix.

The operation of manipulating parameters to linearly combine the vertexes corresponds to dynamically select a point of the simplex.

Each parameter can have a value within the range [0,1].

The results obtained with the multi-partite graph is the ability to contextualize a patent with respect to all the other ones present in the source data; for each possible type of contextualization, or similarity, a user may want to consider.

The user can navigate the sorted relative rank of each patent against criteria corresponding to the chosen linear combination; the user has the ability to dynamically discover and access to related patents for any chosen matrix of the family of proximity matrices. We propose some examples of navigations represented through similar patents for each type of context using a connected-graph interface; each of the links carries information on the strength of proximity relatedness: the thicker the link, the higher is the proximity value.

For these examples, we queried the first fifteen neighbors for a searched patent.

A. Contextualizing Patent: U.S. Pat. No. 8,321,425 (Assignee: Thomson Reuters Global Resources).

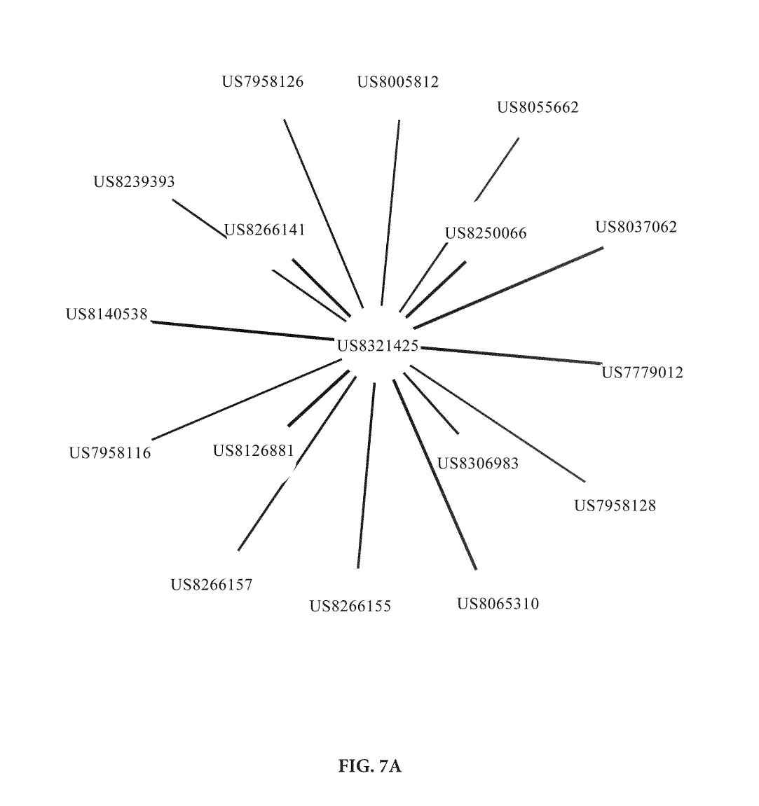

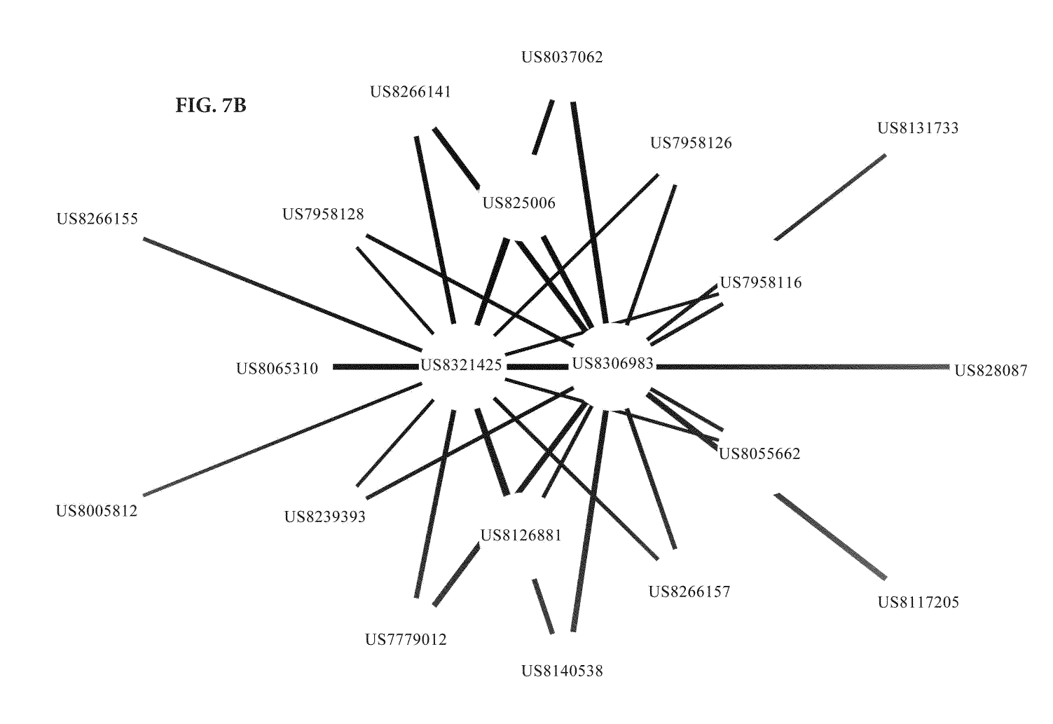

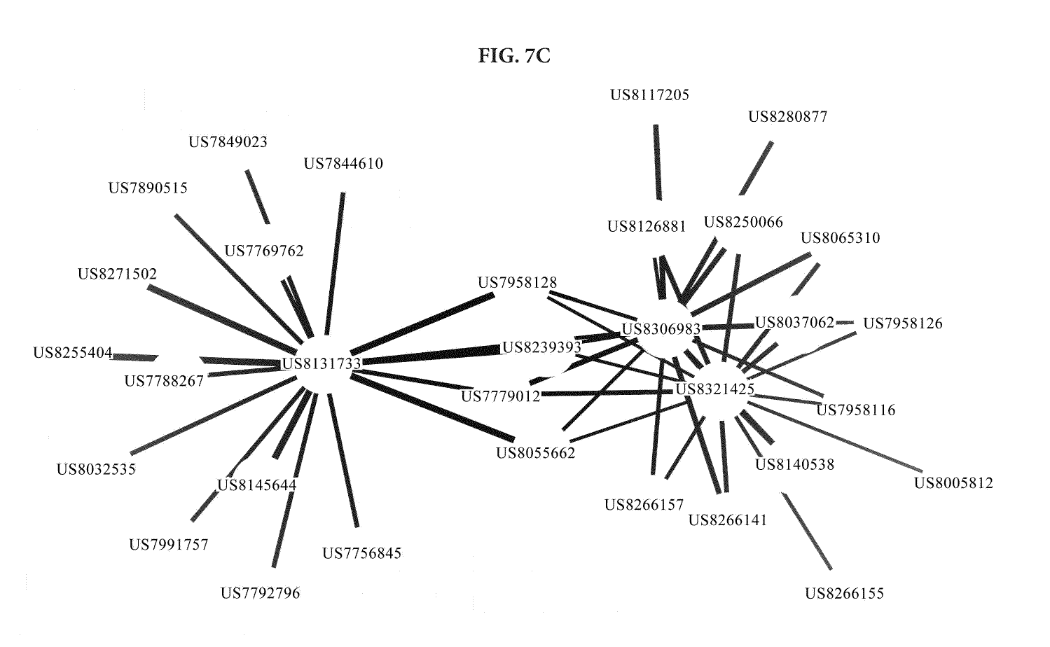

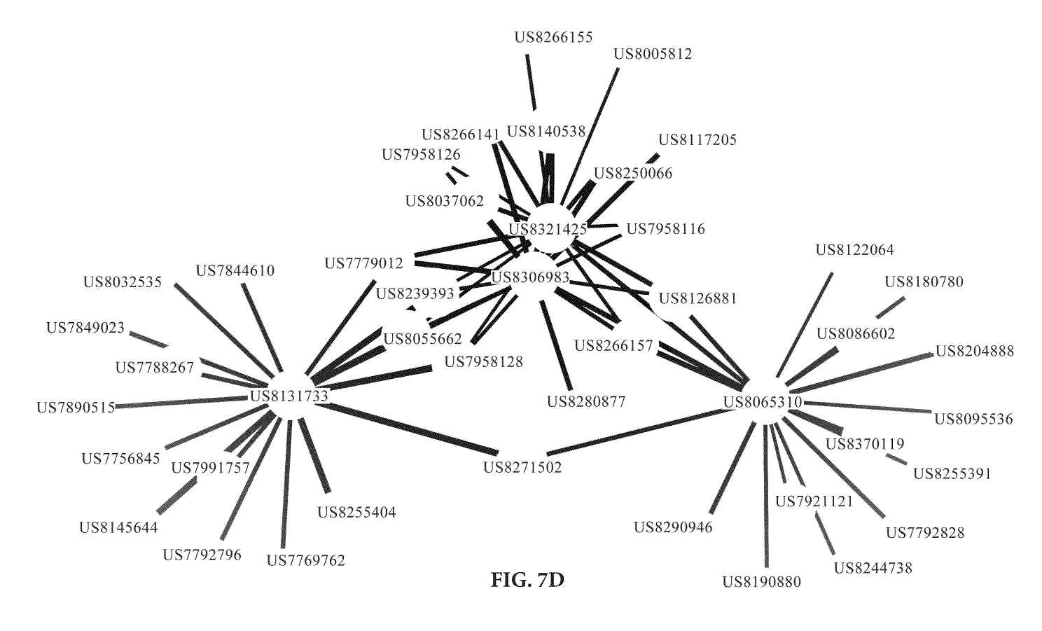

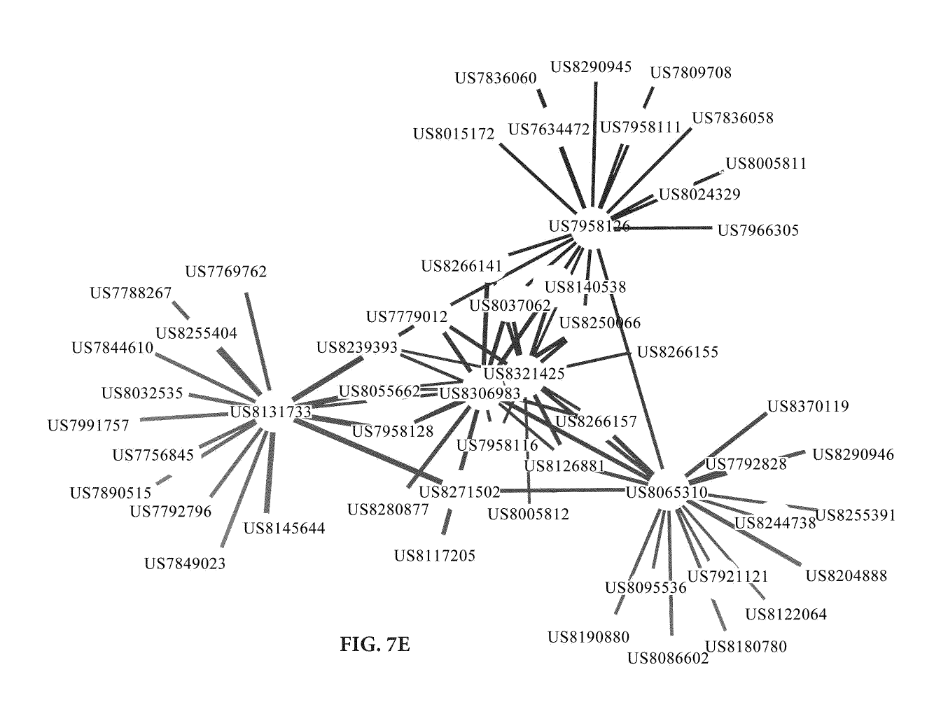

The patent is about “Information-retrieval systems, methods, and software with concept-based searching and ranking”. We looked for the first neighbors with values: FOS=0.4, CRE=0.5, CIT=0.3, PCIT=0.3. We expect to discover some of the neighboring patent related to Information retrieval systems discussed by Thomson Reuter. See FIG. 7A.

In order to better understand the figure, the following list is provided:

First Results of a query within a chosen context. Proximity Values are reported in brackets. Queried patents are formatted in bold font; the current query is marked by the symbol *.

[symbol]

[symbol]

[symbol]

[symbol]

[symbol]

[symbol]

[symbol]

[symbol]

[symbol]

[symbol]

U.S. Pat. No. 8,126,881—Predictive conversion systems and methods [0.288]

U.S. Pat. No. 8,065,310— Topics in relevance ranking model for web search [0.272]

U.S. Pat. No. 7,779,012— Method and apparatus for intranet searching [0.272]

U.S. Pat. No. 8,037,062— System and method for automatically selecting a data source for providing data related to a query [0.272]

U.S. Pat. No. 8,140,538— System and method of data caching for compliance storage systems with keyword query based access [0.272]

U.S. Pat. No. 8,250,066—Search results ranking method and system [0.272]

U.S. Pat. No. 8,266,141—Efficient use of computational resources for interleaving [0.272]

U.S. Pat. No. 8,306,983—Semantic space configuration [0.222]

U.S. Pat. No. 8,266,157—Method and system for using social bookmarks [0.222]

U.S. Pat. No. 8,266,155—Systems and methods of displaying and re-using document chunks in a document development application [0.218]

U.S. Pat. No. 8,239,393—Distribution for online listings [0.192]

U.S. Pat. No. 7,958,126—Techniques for including collection items in search results [0.192]

U.S. Pat. No. 7,958,116—System and method for trans-factor ranking of search results [0.192]

U.S. Pat. No. 7,958,128—Query-independent entity importance in books [0.192]

U.S. Pat. No. 8,005,812—Collaborative modeling environment [0.192]

U.S. Pat. No. 8,055,662—Method and system for matching audio recording [0.192]

Among the results we obtain patents related to concept-based searching and filtering, such as: U.S. Pat. No. 8,140,538—“System and method of data caching for compliance storage systems with keyword query based access” (Assignee: International Business Machine Corporation), which relates to an information-retrieval metric used for measuring a relevancy of a document for a query”; U.S. Pat. No. 8,306,983—“Semantic Space Configuration” (Assignee: Agilex Technologies, Inc.), which relates to “determining a plurality of semantic space representations of the features across a collection” of items; U.S. Pat. No. 7,958,126—“Techniques for including collection items in search results” (Assignee: Yahoo!, Inc.), which relates to “identify a particular set of matching items in response to receiving a search query executed against base items”, with matching items not necessarily belonging to the base item.

As example, note that U.S. Pat. No. 8,306,983 is not referred in the U.S. Pat. No. 8,321,425 and reciprocally U.S. Pat. No. 8,321,425 is not referred by U.S. Pat. No. 8,306,983: the discovery engine returns results of proximity-related patent which also have not been cited in the source dataset.

We may want to increase in FOS value to focus further on similarity of patents characterized by the context patent-“field of search”; we may want to decrease the CRE value to reduce the similarity elated to the fact that patents should relate to the same context patent-assignee/inventor; and we may want to increase in CIT value to focus further on patents which share the same citations as background of invention. We may want to keep PCIT value low being not interested in the “popularity” of this patent after its filing date.

With values: FOS=0.6; CRE=0.3; CIT=0.8; PCIT=0.3 we query the neighboring U.S. Pat. No. 8,306,983—“Semantic Space Configuration” and obtain results about contextualizing the patent with information retrieval domains more related in “matching”, “targeting” and “finding related information”. See FIG. 7B.

In order to better understand the Figure, the following list is provided:

First Results of a query within a chosen context. Proximity Values are reported in brackets. Queried patents are formatted in bold font; the current query is marked by the symbol *.

Results of a 2nd, 3rd, n-th query are listed in paragraphs below; the patents which were already obtained from previous query are omitted, despite proximity value may change their relative rank respect to the current searched node.

[symbol]

[symbol]

[symbol]

[symbol]

[symbol]

[symbol]

[symbol]

[symbol]

[symbol]

[symbol]

U.S. Pat. No. 8,126,881—Predictive conversion systems and methods [0.288]

U.S. Pat. No. 8,065,310—Topics in relevance ranking model for web search [0.272]

U.S. Pat. No. 7,779,012—Method and apparatus for intranet searching [0.272]

U.S. Pat. No. 8,037,062—System and method for automatically selecting a data source for providing data related to a query [0.272]

U.S. Pat. No. 8,140,538—System and method of data caching for compliance storage systems with keyword query based access [0.272]

U.S. Pat. No. 8,250,066—Search results ranking method and system [0.272]

U.S. Pat. No. 8,266,141—Efficient use of computational resources for interleaving [0.272]

[symbol]

[symbol]

[symbol]

[symbol]

[symbol]

U.S. Pat. No. 8,266,157—Method and system for using social bookmarks [0.222]

U.S. Pat. No. 8,266,155—Systems and methods of displaying and re-using document chunks in a document development application [0.218]

U.S. Pat. No. 8,239,393—Distribution for online listings [0.192]

U.S. Pat. No. 7,958,126—Techniques for including collection items in search results [0.192]

U.S. Pat. No. 7,958,116—System and method for trans-factor ranking of search results [0.192]

U.S. Pat. No. 7,958,128—Query-independent entity importance in books [0.192]

U.S. Pat. No. 8,005,812—Collaborative modeling environment [0.192]

U.S. Pat. No. 8,055,662—Method and system for matching audio recording [0.192]

U.S. Pat. No. 8,117,205—Technique for enhancing a set of website bookmarks by finding related bookmarks based on a latent similarity metric [0.244]

U.S. Pat. No. 8,280,877—Diverse topic phrase extraction [0.232]

U.S. Pat. No. 8,131,733—System and method for targeted Ad delivery [0.173]

We find the U.S. Pat. No. 8,131,733-“System and method for targeted Ad delivery”. Note that Assignee is Disney Corporation, as expected with the above values lead to patents which are similar for a context of possible applications (FOS) rather than for context of creators (CRE).

We now iterate the discovery session and query U.S. Pat. No. 8,131,733 within the same context (same values FOS=0.6 CRE=0.3 CIT=0.8 PCIT=0.3). See FIG. 7C.

In order to better understand the Figure, the following list is provided:

First Results of a query within a chosen context. Proximity Values are reported in brackets. Queried patents are formatted in bold font; the current query is marked by the symbol *.

Results of a 2nd, 3rd, n-th query are listed in paragraphs below; the patents which were already obtained from previous query are omitted, despite proximity value may change their relative rank respect to the current searched node.

[symbol]

[symbol]

[symbol]

[symbol]

[symbol]

[symbol]

[symbol]

[symbol]

[symbol]

[symbol]

U.S. Pat. No. 8,126,881—Predictive conversion systems and methods [0.288]

U.S. Pat. No. 8,065,310—Topics in relevance ranking model for web search [0.272]

U.S. Pat. No. 7,779,012—Method and apparatus for intranet searching [0.272]

U.S. Pat. No. 8,037,062—System and method for automatically selecting a data source for providing data related to a query [0.272]

U.S. Pat. No. 8,140,538—System and method of data caching for compliance storage systems with keyword query based access [0.272]

U.S. Pat. No. 8,250,066—Search results ranking method and system [0.272]

U.S. Pat. No. 8,266,141—Efficient use of computational resources for interleaving [0.272]

[symbol]

[symbol]

[symbol]

[symbol]

[symbol]

U.S. Pat. No. 8,266,157—Method and system for using social bookmarks [0.222]

U.S. Pat. No. 8,266,155—Systems and methods of displaying and re-using document chunks in a document development application [0.218]

U.S. Pat. No. 8,239,393—Distribution for online listings [0.192]

U.S. Pat. No. 7,958,126—Techniques for including collection items in search results [0.192]

U.S. Pat. No. 7,958,116—System and method for trans-factor ranking of search results [0.192]

U.S. Pat. No. 7,958,128—Query-independent entity importance in books [0.192]

U.S. Pat. No. 8,005,812—Collaborative modeling environment [0.192]

U.S. Pat. No. 8,055,662—Method and system for matching audio recording [0.192]

U.S. Pat. No. 8,117,205—Technique for enhancing a set of website bookmarks by finding related bookmarks based on a latent similarity metric [0.244]

U.S. Pat. No. 8,280,877—Diverse topic phrase extraction [0.232]

[symbol]

[symbol]

[symbol]

[symbol]

[symbol]

[symbol]

U.S. Pat. No. 8,255,404—Method for classifying web pages and organizing corresponding contents [0.300]

U.S. Pat. No. 8,271,502—Presenting multiple document summarization with search results [0.300]

U.S. Pat. No. 8,145,644—Systems and methods for providing access to medical information [0.300]

U.S. Pat. No. 8,032,535—Personalized web search ranking [0.212]

U.S. Pat. No. 7,890,515—Article distribution system and article distribution method used in this system [0.212]

U.S. Pat. No. 7,849,023—Selecting accommodations on a travel conveyance [0.212]

U.S. Pat. No. 7,756,845—System and method for learning a weighted index to categorize objects

U.S. Pat. No. 7,844,610—Delegated authority evaluation system [0.212]

U.S. Pat. No. 7,792,796—Methods, systems, and computer program products for optimizing resource allocation in a host-based replication environment [0.212]

U.S. Pat. No. 7,769,762—Method and system for consolidating data type repositories [0.212]

U.S. Pat. No. 7,991,757—System for obtaining recommendations from multiple recommenders [0.212]

U.S. Pat. No. 7,788,267—Image metadata action tagging [0.212]

Note that we extended the type of methods we can find for addressing problems in information retrieval, such as methods to “classify web”, “obtaining recommendations”, and “categorize objects” by mean of weighting information; among the results, we find other patents using recommender systems based on assigning a score to results against a human user base or validation, such as:

U.S. Pat. No. 8,271,502—“Presenting multiple document summarization with search results”, Microsoft Corporation, which consists of methods “for summarizing the content of a plurality of documents and presenting the results [ . . . ] to a user in such a way that the user is able to quickly and easily discern what, if any, unique information each document contains”.

### [Abstract]

U.S. Pat. No. 8,255,404—“Method for classifying web pages and organizing corresponding contents”, Mouldtec Ontwerpen B. V., which comprises “executions of [ . . . ] automatic recording processes of the plurality of Internet addresses, and a selection step, for setting a corresponding pertinence value to said plurality of Internet addresses; [ . . . ] and a validation step for validating a subset of the Internet addresses meeting the essentiality criteria; the validation step comprises a human action”. [Abstract]

Within the same context, we query the U.S. Pat. No. 8,065,310—“Topics in relevance ranking model for web search” (Assignee: Microsoft Corporation), related to “a technology by which topics corresponding to web pages are used in relevance ranking of those pages” and obtain neighbors. See FIG. 7D.

In order to better understand the Figure, the following list is provided:

First Results of a query within a chosen context. Proximity Values are reported in brackets. Queried patents are formatted in bold font; the current query is marked by the symbol *.

Results of a 2nd, 3rd, n-th query are listed in paragraphs below; the patents which were already obtained from previous query are omitted, despite proximity value may change their relative rank respect to the current searched node.

[symbol]

[symbol]

[symbol]

[symbol]

[symbol]

[symbol]

[symbol]

[symbol]

[symbol]

[symbol]

U.S. Pat. No. 8,126,881—Predictive conversion systems and methods [0.288]

[symbol]

[symbol]

[symbol]

[symbol]

[symbol]

[symbol]

[symbol]

U.S. Pat. No. 7,779,012—Method and apparatus for intranet searching [0.272]

U.S. Pat. No. 8,037,062—System and method for automatically selecting a data source for providing data related to a query [0.272]

U.S. Pat. No. 8,140,538—System and method of data caching for compliance storage systems with keyword query based access [0.272]

U.S. Pat. No. 8,250,066—Search results ranking method and system [0.272]

U.S. Pat. No. 8,266,141—Efficient use of computational resources for interleaving [0.272]

[symbol]

[symbol]

[symbol]

[symbol]

[symbol]

U.S. Pat. No. 8,266,157—Method and system for using social bookmarks [0.222]

U.S. Pat. No. 8,266,155—Systems and methods of displaying and re-using document chunks in a document development application [0.218]

U.S. Pat. No. 8,239,393—Distribution for online listings [0.192]

U.S. Pat. No. 7,958,126—Techniques for including collection items in search results [0.192]

U.S. Pat. No. 7,958,116—System and method for trans-factor ranking of search results [0.192]

U.S. Pat. No. 7,958,128—Query-independent entity importance in books [0.192]

U.S. Pat. No. 8,005,812—Collaborative modeling environment [0.192]

U.S. Pat. No. 8,055,662—Method and system for matching audio recording [0.192]

U.S. Pat. No. 8,117,205—Technique for enhancing a set of website bookmarks by finding related bookmarks based on a latent similarity metric [0.244]

U.S. Pat. No. 8,280,877—Diverse topic phrase extraction [0.232]

[symbol]

[symbol]

[symbol]

[symbol]

[symbol]

[symbol]

U.S. Pat. No. 8,255,404—Method for classifying web pages and organizing corresponding contents [0.300]

U.S. Pat. No. 8,271,502—Presenting multiple document summarization with search results [0.300]

U.S. Pat. No. 8,145,644—Systems and methods for providing access to medical information [0.300]

U.S. Pat. No. 8,032,535—Personalized web search ranking [0.212]

U.S. Pat. No. 7,890,515—Article distribution system and article distribution method used in this system [0.212]

U.S. Pat. No. 7,849,023—Selecting accommodations on a travel conveyance [0.212]

U.S. Pat. No. 7,756,845—System and method for learning a weighted index to categorize objects

U.S. Pat. No. 7,844,610—Delegated authority evaluation system [0.212]

U.S. Pat. No. 7,792,796—Methods, systems, and computer program products for optimizing resource allocation in a host-based replication environment [0.212]

U.S. Pat. No. 7,769,762—Method and system for consolidating data type repositories [0.212]

U.S. Pat. No. 7,991,757—System for obtaining recommendations from multiple recommenders [0.212]

U.S. Pat. No. 7,788,267—Image metadata action tagging [0.212]

U.S. Pat. No. 8,204,888—Using tags in an enterprise search system [0.244]

U.S. Pat. No. 8,370,119—Website design pattern modeling [0.233]

U.S. Pat. No. 8,290,946—Consistent phrase relevance measures [0.224]

U.S. Pat. No. 7,792,828—Method and system for selecting content items to be presented to a viewer [0.212]

U.S. Pat. No. 8,190,880—Methods and systems for displaying standardized data [0.189]

U.S. Pat. No. 8,180,780—Collaborative program development method and system [0.189]

U.S. Pat. No. 8,086,602—User interface methods and systems for selecting and presenting content based on user navigation and selection actions associated with the content [0.189]

U.S. Pat. No. 8,244,738—Data display apparatus, method, and program [0.173]

U.S. Pat. No. 8,095,536—Profitability based ranking of search results for lodging reservations [0.173]

U.S. Pat. No. 8,255,391—System and method for generating an approximation of a search engine ranking algorithm [0.173]

U.S. Pat. No. 8,122,064—Computer program, method, and apparatus for data sorting [0.160]

U.S. Pat. No. 7,921,121—Apparatus for representing an interest priority of an object to a user based on personal histories or social context [0.160]

We than increase CIT and PCIT values receptively to 0.9 and 0.6 and select U.S. Pat. No. 7,958,126-“Techniques for including collection items in search results”. See FIG. 7E.

In order to better understand the Figure, the following list is provided:

First Results of a query within a chosen context. Proximity Values are reported in brackets. Queried patents are formatted in bold font; the current query is marked by the symbol *

Results of a 2nd, 3rd, n-th query are listed in paragraphs below; the patents which were already obtained from previous query are omitted, despite proximity value may change their relative rank respect to the current searched node.

[symbol]

[symbol]

[symbol]

[symbol]

[symbol]

[symbol]

[symbol]

[symbol]

[symbol]

[symbol]

U.S. Pat. No. 8,126,881—Predictive conversion systems and methods [0.288]

[symbol]

[symbol]

[symbol]

[symbol]

[symbol]

[symbol]

[symbol]

U.S. Pat. No. 7,779,012—Method and apparatus for intranet searching [0.272]

U.S. Pat. No. 8,037,062—System and method for automatically selecting a data source for providing data related to a query [0.272]

U.S. Pat. No. 8,140,538—System and method of data caching for compliance storage systems with keyword query based access [0.272]

U.S. Pat. No. 8,250,066—Search results ranking method and system [0.272]

U.S. Pat. No. 8,266,141—Efficient use of computational resources for interleaving [0.272]

[symbol]

[symbol]

[symbol]

[symbol]

[symbol]

U.S. Pat. No. 8,266,157—Method and system for using social bookmarks [0.222]

U.S. Pat. No. 8,266,155—Systems and methods of displaying and re-using document chunks in a document development application [0.218]

U.S. Pat. No. 8,239,393—Distribution for online listings [0.192]

[symbol]

[symbol]

[symbol]

[symbol]

[symbol]

[symbol]

[symbol]

U.S. Pat. No. 7,958,116—System and method for trans-factor ranking of search results [0.192]

U.S. Pat. No. 7,958,128—Query-independent entity importance in books [0.192]

U.S. Pat. No. 8,005,812—Collaborative modeling environment [0.192]

U.S. Pat. No. 8,055,662—Method and system for matching audio recording [0.192]

U.S. Pat. No. 8,117,205—Technique for enhancing a set of website bookmarks by finding related bookmarks based on a latent similarity metric [0.244]

U.S. Pat. No. 8,280,877—Diverse topic phrase extraction [0.232]

[symbol]

[symbol]

[symbol]

[symbol]

[symbol]

[symbol]

U.S. Pat. No. 8,255,404—Method for classifying web pages and organizing corresponding contents [0.300]

U.S. Pat. No. 8,271,502—Presenting multiple document summarization with search results [0.300]

U.S. Pat. No. 8,145,644—Systems and methods for providing access to medical information [0.300]

U.S. Pat. No. 8,032,535—Personalized web search ranking [0.212]

U.S. Pat. No. 7,890,515—Article distribution system and article distribution method used in this system [0.212]

U.S. Pat. No. 7,849,023—Selecting accommodations on a travel conveyance [0.212]

U.S. Pat. No. 7,756,845—System and method for learning a weighted index to categorize objects

U.S. Pat. No. 7,844,610—Delegated authority evaluation system [0.212]

U.S. Pat. No. 7,792,796—Methods, systems, and computer program products for optimizing resource allocation in a host-based replication environment [0.212]

U.S. Pat. No. 7,769,762—Method and system for consolidating data type repositories [0.212]

U.S. Pat. No. 7,991,757—System for obtaining recommendations from multiple recommenders [0.212]

U.S. Pat. No. 7,788,267—Image metadata action tagging [0.212]

U.S. Pat. No. 8,204,888—Using tags in an enterprise search system [0.244]

U.S. Pat. No. 8,370,119—Website design pattern modeling [0.233]

U.S. Pat. No. 8,290,946—Consistent phrase relevance measures [0.224]

U.S. Pat. No. 7,792,828—Method and system for selecting content items to be presented to a viewer [0.212]

U.S. Pat. No. 8,190,880—Methods and systems for displaying standardized data [0.189]

U.S. Pat. No. 8,180,780—Collaborative program development method and system [0.189]

U.S. Pat. No. 8,086,602—User interface methods and systems for selecting and presenting content based on user navigation and selection actions associated with the content [0.189]

U.S. Pat. No. 8,244,738—Data display apparatus, method, and program [0.173]

U.S. Pat. No. 8,095,536—Profitability based ranking of search results for lodging reservations [0.173]

U.S. Pat. No. 8,255,391—System and method for generating an approximation of a search engine ranking algorithm [0.173]

U.S. Pat. No. 8,122,064—Computer program, method, and apparatus for data sorting [0.160]

U.S. Pat. No. 7,921,121—Apparatus for representing an interest priority of an object to a user based on personal histories or social context [0.160]

U.S. Pat. No. 7,836,060—Multi-way nested searching [0.217]

U.S. Pat. No. 7,634,472—Click-through re-ranking of images and other data [0.217]

U.S. Pat. No. 8,015,172—Method of conducting searches on the internet to obtain selected information on local entities and provide for searching the data in a way that lists local businesses at the top of the results [0.176]

U.S. Pat. No. 8,290,945—Web searching [0.176]

U.S. Pat. No. 7,836,058—Web searching [0.176]

U.S. Pat. No. 8,005,811—Systems and media for utilizing electronic document usage information with search engines [0.176]

U.S. Pat. No. 8,024,329—Using inverted indexes for contextual personalized information retrieval [0.176]

U.S. Pat. No. 7,958,111—Ranking documents [0.173]

U.S. Pat. No. 7,809,708—Information search using knowledge agents [0.172]

U.S. Pat. No. 7,966,305—Relevance-weighted navigation in information access, search and retrieval [0.167]

The results return an overview of neighboring patents majorly further related to “searching”, “ranking” or “weighting” information, such as: U.S. Pat. No. 7,966,305—“Relevance-weighted navigation in information access, search and retrieval” (Assignee: Microsoft International Holding B.V.) which claims a method to compute summary information on documents by identifying “a result set of matching documents and query dependent subsections of the matching documents” (see U.S. Pat. No. 7,966,305's Claims, paragraph 1).

B. Contextualizing Patent: U.S. Pat. No. 7,631,383 (Assignee: Geox S.p.a.)

The patent is about “Waterproofed breathable sole for shoes and method for the manufacture thereof”.

Rather than a similarity mostly focusing on the context of “creators”, that is of patents developed by or belonging to “Geox”, we want to find patents whose similarity is mostly focused on the fields of application of the invention: we want to find results which contextualize the use of the breathable sole, thus extend possible applications of the invention.

Rather than a similarity mostly focusing on the context of “creators”, that is of patents developed by or belonging to “Geox”, we want to find patents whose similarity is mostly focused on the fields of application of the invention: we want to find results which contextualize the use of the breathable sole, thus extend possible applications of the invention.

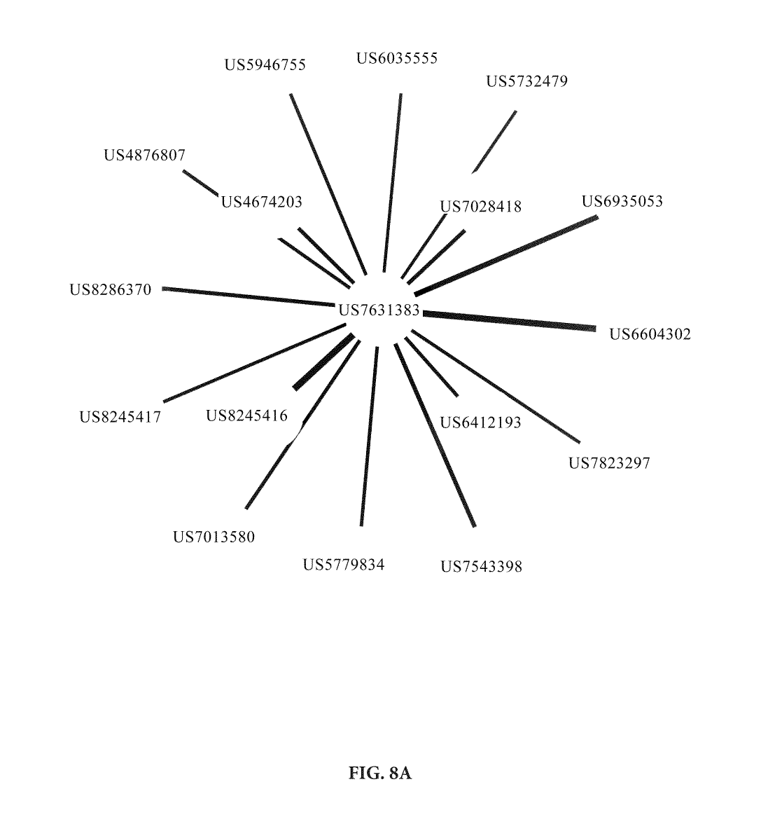

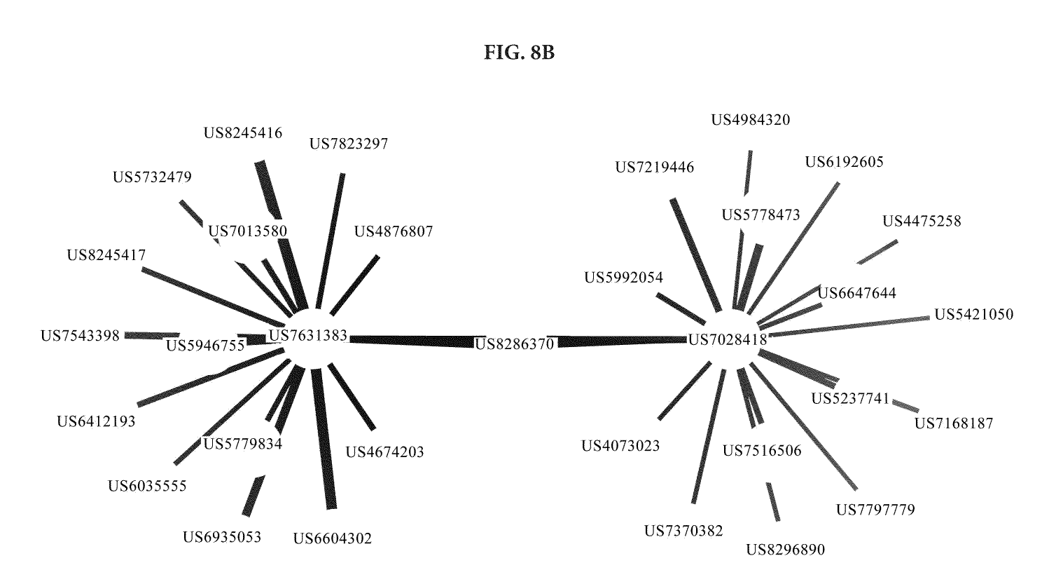

We looked for the first neighbors within the context given by values: FOS=0.7, CRE=0.1, CIT=0.2, PCIT=0.2. As most related results we obtain patents complying with waterproof soles sharing the characteristic to be breathable or vapor-permeable. See FIG. 8A.

To better understand the Figure, the following list is provided:

First Results of a query within a chosen context. Proximity Values are reported in brackets. Queried patents are formatted in bold font; the current query is marked by the symbol *.

[symbol]

[symbol]

[symbol]

[symbol]

[symbol]

[symbol]

[symbol]

[symbol]

U.S. Pat. No. 8,245,416—Waterproof vapor-permeable shoe [0.477]

U.S. Pat. No. 6,604,302—Waterproof shoe with sole or mid-sole molded onto the upper [0.462]

U.S. Pat. No. 6,935,053—Waterproof footwear and methods for making the same [0.381]

U.S. Pat. No. 7,543,398—Waterproof and breathable insole [0.311]

U.S. Pat. No. 8,286,370—Waterproof vapor-permeable shoe [0.295]

U.S. Pat. No. 7,028,418—Integrated and hybrid sole construction for footwear [0.293]

U.S. Pat. No. 4,674,203—Inner part of shoe with a surface massaging the soles of the feet and process for its fabrication [0.278]

U.S. Pat. No. 6,412,193—Waterproof shoe having stitch seam for drainage (I) [0.270]

U.S. Pat. No. 7,013,580—Waterproof footwear and process for its manufacture [0.270]

U.S. Pat. No. 4,876,807—Shoe, method for manufacturing the same, and sole blank therefor [0.252]

U.S. Pat. No. 5,946,755—Shoes and process for producing same [0.250]

U.S. Pat. No. 8,245,417—Vapor-permeable waterproof sole for shoes, shoe which uses said sole, and method for manufacturing said sole and said shoe [0.250]

U.S. Pat. No. 7,823,297—Shoe with breathable and waterproof sole and upper [0.249]

U.S. Pat. No. 5,732,479—Shoe with laminate embedded in spray-moulded compound sole [0.233]

U.S. Pat. No. 5,779,834—Process of making a shoe with a spray-molded sole and shoe manufactured therefrom [0.254]

U.S. Pat. No. 6,035,555—Waterproof shoe [0.233]

We want to overview and extend the contextualization of waterproof sole: we lower CRE value and increase PCIT value, and we query the first neighbors of U.S. Pat. No. 7,028,418-“Integrated and hybrid sole construction for footwear”, Arca Industrial Corp, with values: FOS=0.8, CRE=0.0, CIT=0.2, PCIT=0.5. See FIG. 8B.

First Results of a query within a chosen context. Proximity Values are reported in brackets. Queried patents are formatted in bold font; the current query is marked by the symbol *.

Results of a 2nd, 3rd, n-th query are listed in paragraphs below; the patents which were already obtained from previous query are omitted, despite proximity value may change their relative rank respect to the current searched node.

[symbol]

[symbol]

[symbol]

[symbol]

[symbol]

[symbol]

[symbol]

[symbol]

U.S. Pat. No. 8,245,416—Waterproof vapor-permeable shoe [0.477]

U.S. Pat. No. 6,604,302—Waterproof shoe with sole or mid-sole molded onto the upper [0.462]

U.S. Pat. No. 6,935,053—Waterproof footwear and methods for making the same [0.381]

U.S. Pat. No. 7,543,398—Waterproof and breathable insole [0.311]

U.S. Pat. No. 8,286,370—Waterproof vapor-permeable shoe [0.295]

[symbol]

[symbol]

[symbol]

[symbol]

[symbol]

[symbol]

U.S. Pat. No. 4,674,203—Inner part of shoe with a surface massaging the soles of the feet and process for its fabrication [0.278]

U.S. Pat. No. 6,412,193—Waterproof shoe having stitch seam for drainage (I) [0.270]

U.S. Pat. No. 7,013,580—Waterproof footwear and process for its manufacture [0.270]

U.S. Pat. No. 4,876,807—Shoe, method for manufacturing the same, and sole blank therefor [0.252]

U.S. Pat. No. 5,946,755—Shoes and process for producing same [0.250]

U.S. Pat. No. 8,245,417—Vapor-permeable waterproof sole for shoes, shoe which uses said sole, and method for manufacturing said sole and said shoe [0.250]

U.S. Pat. No. 7,823,297—Shoe with breathable and waterproof sole and upper [0.249]

U.S. Pat. No. 5,732,479—Shoe with laminate embedded in spray-moulded compound sole [0.233]

U.S. Pat. No. 5,779,834—Process of making a shoe with a spray-molded sole and shoe manufactured therefrom [0.254]

U.S. Pat. No. 6,035,555—Waterproof shoe [0.233]

U.S. Pat. No. 5,778,473—Method of forming a boot [0.362]

U.S. Pat. No. 7,219,446—Footwear with sealed sole construction and method for producing same [0.314]

U.S. Pat. No. 5,247,741—Footwear having a molded sole [0.290]

U.S. Pat. No. 5,992,054—Shoe and process for sealing the sole area of a shoe [0.246]

U.S. Pat. No. 7,516,506—Shoe outsole made using composite sheet material [0.266]

U.S. Pat. No. 6,647,644—Welted shoe [0.224]

U.S. Pat. No. 7,370,382—Method for manufacturing breathable shoe [0.217]

U.S. Pat. No. 7,168,187—Footwear construction and related method of manufacture [0.217]

U.S. Pat. No. 8,296,890—Method for providing a weathered shoe and the weathered shoe [0.217]

U.S. Pat. No. 4,073,023—Method of manufacture of footwear [0.214]

U.S. Pat. No. 7,797,779—Semi-bed shoe construction method and products produced by the same [0.205]

U.S. Pat. No. 5,421,050—Shoe construction method [0.197]

U.S. Pat. No. 6,192,605—Welted shoe construction and method [0.197]

U.S. Pat. No. 4,475,258—Process and tooling for production of open top shoes with resin moulded bottom, and shoes manufactured in that manner [0.188]

U.S. Pat. No. 4,984,320—Shoe sole embossed composition and method [0.188]

Here, we gave more importance to the context returned by the proximity matrices FOS and PCIT, that is we gave more importance to the fact patent has been itself cited and to patent's field of search. In the similarity returned within this context, the property creators (CRE) has the least importance, that means we want to observe which other stakeholders are operating in the domain of U.S. Pat. No. 7,028,418 assigned to Arca Industrial Corp; the assignees of resulting neighbors are: C Two Corporation; Franz Haimerl; Suave Shoe Corporation; W.L. Gore & Associates, Inc.; Dynasty Footwear, Ltd.; Kun-Chunq Liu; Geox S.P.A.; Wolverine World Wide, Inc.; Columbia Insurance Company; Ro-Search, Inc.; Aeroqroup International Holdings Llc; Laganas; Arthur; E.S. Originals, Inc.; A.P.I. Applicazioni Poliuretaniche Industriali S.P.A.; Foot-Joy, Inc. The overview of results we obtained shows also a broader extent of applications for shoe and footwear construction methods, which focuses less on the fact inventions are about a particular component of the shoe (the sole).

C. Contextualizing Patent: U.S. Pat. No. 8,239,364 (Assignee: Facebook, Inc.).

The patent is about “Search and retrieval of objects in a social networking system”; it refers to “A social networking system receives a query associated with a user and, in response, provides a combined result set comprising objects stored by a social networking system that match the query”.

We recall that the Open Graph protocol developed by Facebook, Inc. is a protocol based on meta-tagging that allows putting in relationships members of the social network with other web objects: “it is used on Facebook to allow any web page to have the same functionality as any other object on Facebook” [source: http://ogp.me/].

Web objects and members are both nodes of the social network, in order “to richly represent any web page within the social graph” [source: http://ogp.me/]. The outreach of the social network is extended to the web and the Open Graph technology allows to target members of the social network who performed a particular action on Open Graph objects [source: https://developers.facebook.com/docs/reference/ads-api/action-specs/#obects].

Among the claims of U.S. Pat. No. 8,239,364, there are: “accessing a social graph having nodes corresponding to objects, and having edges corresponding to relationships of the objects; receiving a query from a client device[ . . . ] provided by a user [ . . . ]; performing a plurality of search algorithms [for obtaining results] based at least in part on examining connections of the user in the social networking system; obtaining [result sets where each set comprises] a set of objects from an object store of the social networking system that match the query;”.

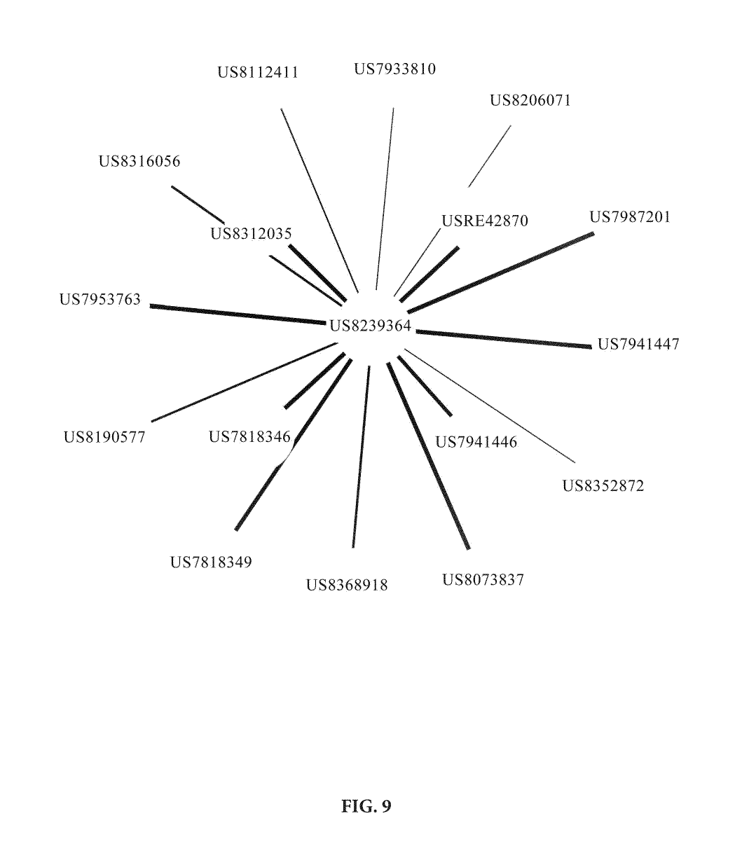

We looked for the first neighbors with values: FOS=0.5 CRE=0.5 CIT=0.3 PCIT=0.3. See FIG. 9.

To better understand the Figure, the following list is provided:

First Results of a query within a chosen context. Proximity Values are reported in brackets. Queried patents are formatted in bold font; the current query is marked by the symbol *.

[symbol]

[symbol]

[symbol]

[symbol]

[symbol]

[symbol]

[symbol]

U.S. Pat. No. 7,941,447—Human relationships registering system and device for registering human relationships, program for registering human relationships, and medium storing human relationships registering program and readable by computer [0.312]

U.S. Pat. No. 7,818,346—Database heap management system with variable page size and fixed instruction set address resolution [0.312]

U.S. Pat. No. 7,987,201—Method and apparatus for communication efficient private information retrieval and oblivious transfer [0.312]

U.S. Pat. No. 8,073,837—Method and apparatus for managing multimedia content [0.312]

U.S. Pat. No. 7,941,446—System with user directed enrichment [0.312]

U.S. RE42870—Text mining system for web-based business intelligence applied to web site server logs [0.309]

U.S. Pat. No. 8,312,035—Search engine enhancement using mined implicit links [0.305]

U.S. Pat. No. 7,953,763—Method for detecting link spam in hyperlinked databases [0.311]

U.S. Pat. No. 7,818,349—Ultra-shared-nothing parallel database [0.290]

U.S. Pat. No. 8,368,918—Methods and apparatus to identify images in print advertisements [0.182]

U.S. Pat. No. 8,316,056—Second-order connection search in a social networking system [0.180]

U.S. Pat. No. 8,190,577—Central database server apparatus and method for maintaining databases on application servers [0.171]

U.S. Pat. No. 8,112,411—Method and system for providing search results [0.120]

U.S. Pat. No. 8,352,872—Geographic location notification based on identity linking [0.09]

U.S. Pat. No. 7,933,810—Collectively giving gifts in a social network environment [0.09]

U.S. Pat. No. 8,206,071—Cabinet anchor bolt assembly [0.09]

We expect results more focused on the contexts returned by application field and creators.

We comment some patents found among the first results:

U.S. Pat. No. 7,941,447—“Human relationships registering system and device for registering human relationships, program for registering human relationships, and medium storing human relationships registering program and readable by computer”, Mekiki Co., Ltd., Mekiki Creates Co., Ltd., which refers to “a human relationships registering system [ . . . ] including sections for receiving personal data of a new member, and a[ . . . ] processing unit including a section for storing the received personal data plus a fourth one which is an average of such proximity matrices [which] stores the personal data of the new member in correlation to an existing member”.

Part of the claims of this patent are about establishing relationships for targeting members in the network: “An apparatus including a server coupled to a communication network configured to establish and update relationships between members registered to a relationship registering system coupled to the communication network”.

U.S. Pat. No. 8,312,035—“Search engine enhancement using mined implicit links”, Microsoft Corporation, is about a system for search engines “that generates implicit links obtained from mining user access logs to facilitate enhanced local searching of web sites and intranets”. One embodiment includes “extracting implicit links from a user access log, generating an implicit links graph from the extracted implicit links, and computing page rankings using the implicit links graph”.

This patent claims a method for “augmenting initial search results [for a user] from a search engine” “and for generating page rankings using a user access log”

U.S. Pat. No. 7,941,446—“System with user directed enrichment”, Xerox Corporation.

This invention is related to management and use of documents, with application to facilitate the relationships between documents [see: “BACKGROUND OF INVENTION Section, 1. Field of the Invention].

In particular, this invention relates to a directed search service and an import-export service based on meta-tagging (meta-document exchanges), where “The import-export service enables meta-document exchanges between systems that provide document enrichment by binding imported meta-documents to identical or similar information providers.” [see: Abstract Section].

A description for using meta-document information to finding related documents is given in the Detail Description section, where a similarity measure is obtained between “the summaries and the context surrounding entities in the document content to which the query is directed”.

The type of “recommendations” of similar documents operated comprises the extension of the annotation applied to a document (markup) by means of a “service”, a “program may identify entities in a document, and annotate each entity with data associated to that entity” (see: Detail Description Section).

U.S. Pat. No. 8,073,837—“Method and apparatus for managing multimedia content”, Alcatel Lucent, consists of a “method for storing media content within a service provider network”.

One embodiment of the invention is about matching directed advertisement and users: “The request for media content is received in response to end-user directed advertisements received at any of the plurality of end-user devices” (see: Abstract) and “supporting content gifting using a server” (See: Claims, par. I)

U.S. RE42870—“Text mining system for web-based business intelligence applied to web site server logs”, Dafineais Protocol Data B. V., LLC, is about another type of innovation for providing information useful to a user based on mining user's information: “A text mining system for collecting business intelligence about a client [ . . . ]. [The components of the system permits] to provide aggregate cluster data representing statistics useful for customer lead generation.”

This patent claims “A text mining system for providing data representing Internet activities of a visitor to a web site of a business enterprise”.

U.S. Pat. No. 8,316,056—“Second-order connection search in a social networking system”, Facebook, Inc.: this patent extends the publication of U.S. Pat. No. 8,239,364: despite the same abstract, there are differences in the claims section which extend the scope of the invention.

U.S. Pat. No. 8,112,411—“Method and system for providing search results”, NHN Corporation, is a method “for providing search results only inclusive of valid web-page(s) to a user”.

This patent is about a relations structure putting in relation web-pages and users, so that searched results of webpages provided to a user are obtained in response of webpages selected by another user.

The first claim is about a method of providing search results comprising: “receiving a first search query from a first user”; “providing the first user with [ . . . ] results obtained in response to the first search query”; “receiving a second search query from a second user, wherein second search results [ . . . ] comprise the webpage selected by the first user”; “providing the second user with the second search results if it is determined that the webpage selected by the first user is valid; and [ . . . ] providing the second user with the corrected second search results if it is determined that the webpage selected by the first user is not valid.”

Among the results about the scope of relationships in networks, we found also patents which broaden the context of applications and focuses on the technological performance of data transmission within networks and relational databases, such as:

U.S. Pat. No. 7,818,349—“Ultra-shared-nothing parallel database”, DATAllegro, Inc., relates to a parallel database system for processing multi-dimensional data by “distributing a database across said plurality of slave nodes, the database comprising a fact table and a plurality of dimension tables” (see: Claims section).

This patent describes a technology for high scalability in querying large databases “consisting of at least one fact table and multiple dimension tables” (see: Abstract section); such technology was acquired by Microsoft and integrated in SQL Server 2008 for managing relational databases.

[See: http://blogs.technet.com/b/dataplatforminsider/archive/2010/04/02/microsoft-shipsthe-final-technology-preview-for-sql-server-2008-r2-parallel-data-warehouse.Aspx].

U.S. Pat. No. 7,987,201—“Method and apparatus for communication efficient private information retrieval and obvious transfer”, NTT DoCoMo, Inc., consists of “A method, article of manufacture and apparatus for performing private retrieval of information from a database”, comprising of “obtaining an index corresponding to information to be retrieved from the database and generating a query that does not reveal the index to the database.” (see: Abstract).

At a lower proximity we find another patent belonging to Facebook, U.S. Pat. No. 8,352,872—“Geographic location notification based on identity linking”, Facebook, Inc., which relates to “A computer implemented method for providing notification information regarding geographical location” (see: Claims section).

The patent's technical field is about exchanging information over telephone and data network, for “controlling distribution of notifications of presence and geographic location of users of systems such as instant messaging and cellular telephone systems” [see: Technical Field Section].

D. Contextualizing Patent: U.S. Pat. No. 6,285,999 (Assignee: Stanford Board of Trustee, Inventor: Larry Page).

The patent is about “Method for node ranking in a link database”. It is the patent disclosing the innovation of the page-rank method that will have been used by Google Inc.

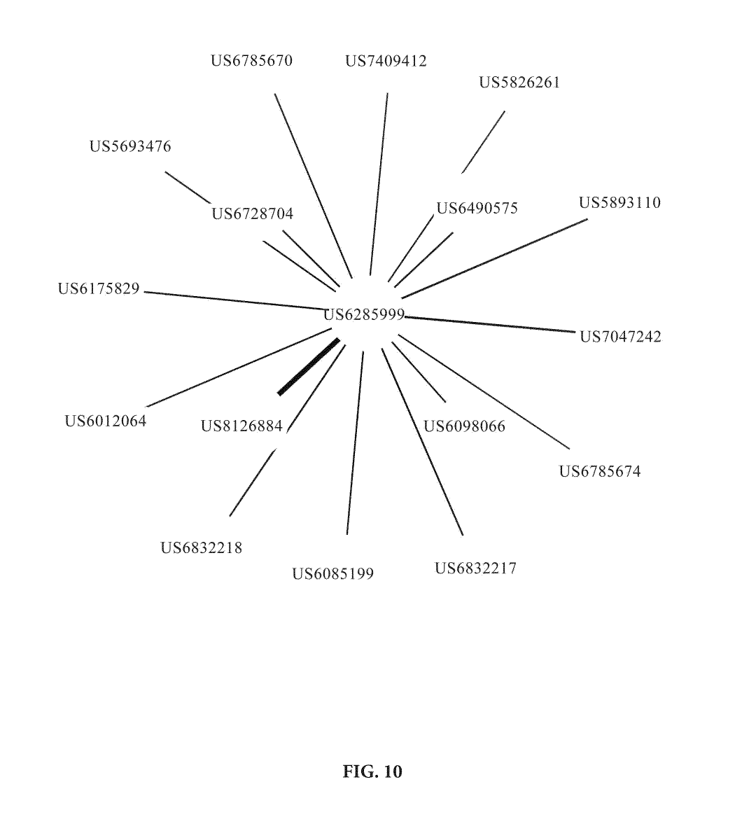

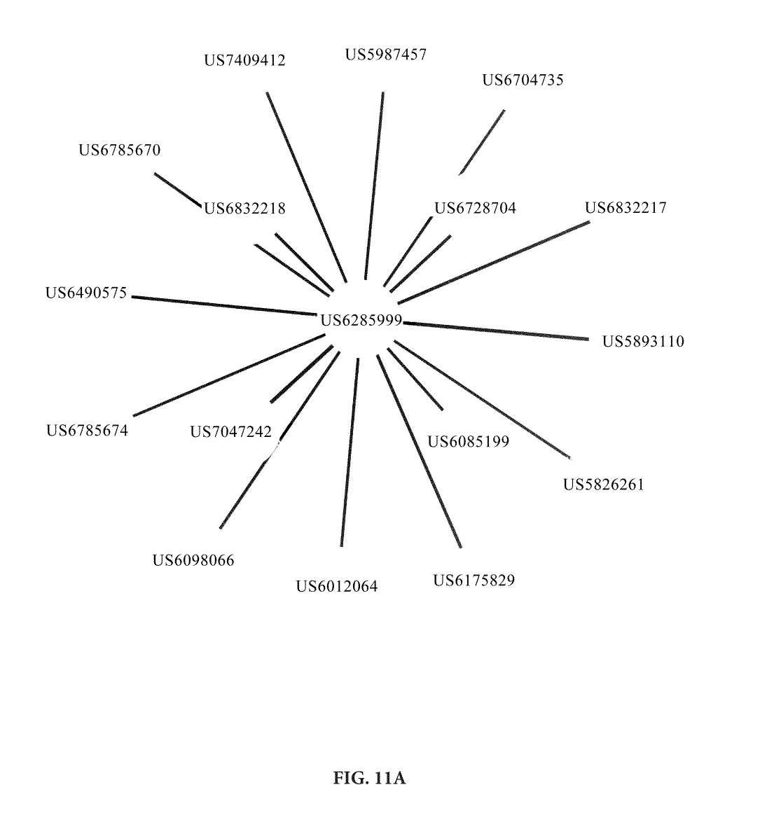

We propose two example of navigation for this patent. See FIG. 10.

With values: FOS=0.3, CRE=0.3, CIT=0.3, PCIT=0.3 we find out that U.S. Pat. No. 8,126,884—“Scoring documents in a linked database” stands out with respect to other neighbors.

This example shows the utility for identifying entities that are potentially identical when the proximity value of their relation tends towards 1 in a range between [0,1].

To better understand the Figure, the following list is provided:

First Results of a query within a chosen context. Proximity Values are reported in brackets. Queried patents are formatted in bold font; the current query is marked by the symbol *.

[symbol]

[symbol]

[symbol]

[symbol]

[symbol]

U.S. Pat. No. 8,126,884—Scoring documents in a linked database [0.366]

U.S. Pat. No. 7,047,242—Weighted term ranking for on-line query tool [0.161]

U.S. Pat. No. 5,893,110—Browser driven user interface to a media asset database [0.149]

U.S. Pat. No. 6,490,575—Distributed network search engine [0.133]

U.S. Pat. No. 6,728,704—Method and apparatus for merging result lists from multiple search engines [0.133]

U.S. Pat. No. 6,175,829—Method and apparatus for facilitating query reformulation [0.133]

U.S. Pat. No. 6,832,217—Information inquiry support apparatus, information inquiry support method, information distribution apparatus, and information distribution method [0.133]

U.S. Pat. No. 6,785,670—Automatically initiating an internet-based search from within a displayed document [0.133]

U.S. Pat. No. 6,832,218—System and method for associating search results [0.133]

U.S. Pat. No. 6,098,066—Method and apparatus for searching for documents stored within a document directory hierarchy [0.126]

U.S. Pat. No. 6,085,199—Method for distributing a file in a plurality of different file formats [0.126]

U.S. Pat. No. 6,012,064—Maintaining a random sample of a relation in a database in the presence of updates to the relation [0.125]

U.S. Pat. No. 5,693,476—Methods of screening for compounds capable of modulating vesicular release [0.125]

U.S. Pat. No. 6,785,674—System and method for structuring data in a computer system [0.120]

U.S. Pat. No. 7,409,412—Data element and structure for data processing [0.120]

U.S. Pat. No. 5,826,261—System and method for querying multiple, distributed databases by selective sharing of local relative significance information for terms related to the query [0.119]

U.S. Pat. No. 8,126,884 extends the publications of U.S. Pat. No. 6,285,999: abstracts are identical; differences in the Classification System and Claims section extend the scope of the innovation.

Other neighbors returned by this proximity matrix contextualize the innovation with other methods concerning “weighting” information, “querying” and “network search engine”.

We may want to search for similar patents concerning further the context of applications in information retrieval and lesser the context of the fact such inventions belongs to a certain creator (a combination of assignee and inventor in our example).

Since the assignee “The Board of Trustees of the Leland Stanford Junior University” holds rights on many thousands of patents and on different industrial domains, we want to lower the parameter of CRE matrix. We also increase the PCIT value, because we want to stress the importance and impact the page-rank method had in innovating information retrieval.

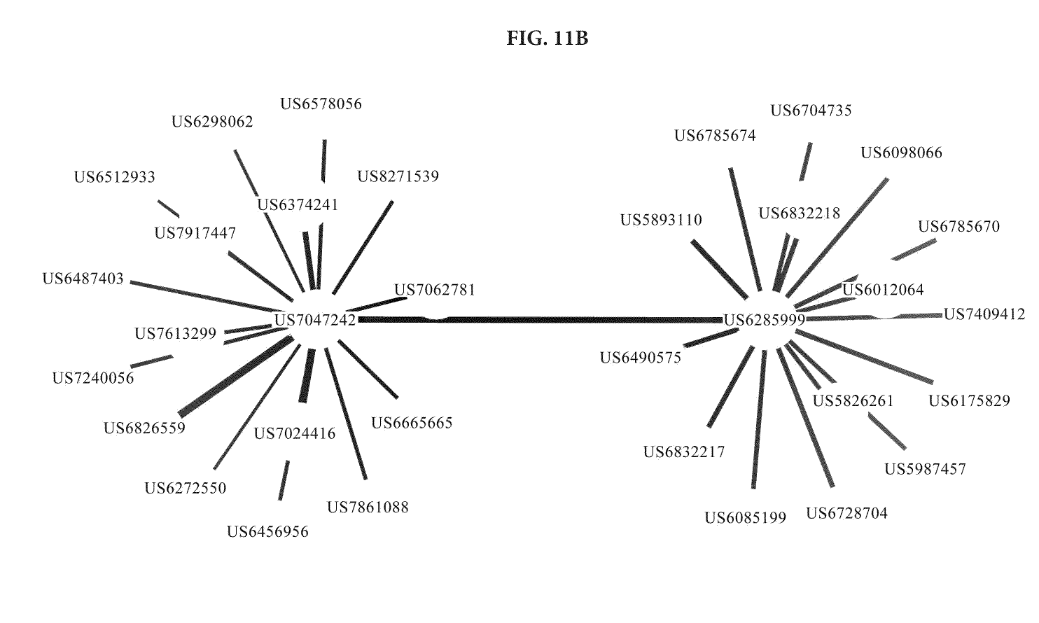

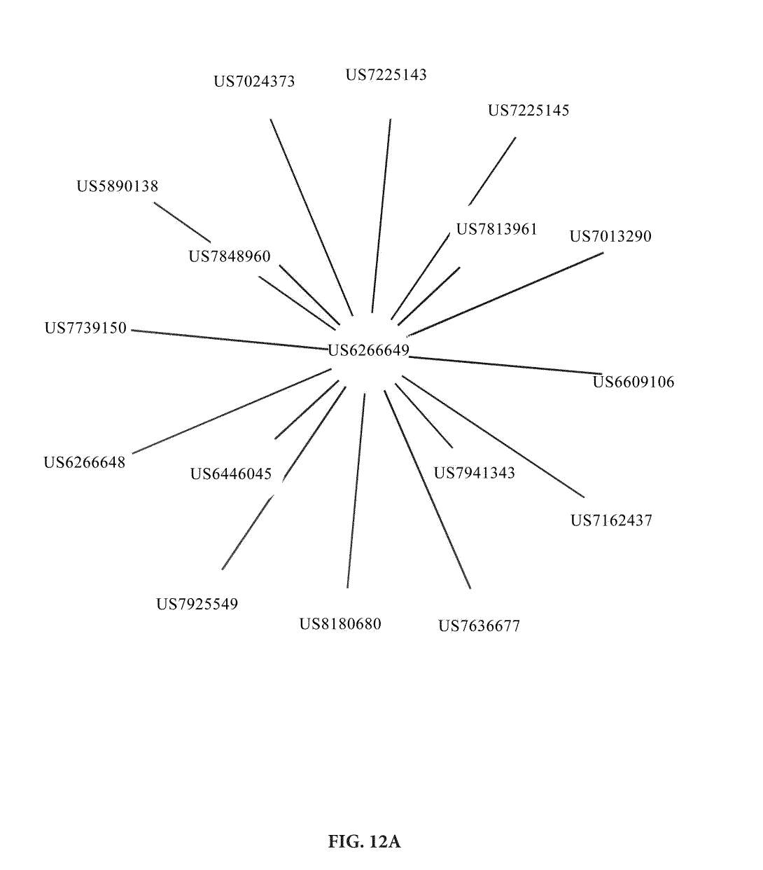

With values FOS=1.0, CRE=0.1, CIT=0.3, PCIT=1.0 we compute a proximity matrix which contextualize the patent about “node ranking in a linked database” with other patents focusing on “facilitating query reformulation” and “query refinement”, “searching for documents”, “associating search results” and “merging results list from multiple search engines”. See FIG. 11A.

To better understand the figure, the following list is provided.

First Results of a query within a chosen context. Proximity Values are reported in brackets. Queried patents are formatted in bold font; the current query is marked by the symbol *

[symbol]

[symbol]

[symbol]

[symbol]

[symbol]

[symbol]

U.S. Pat. No. 7,047,242—Weighted term ranking for on-line query tool [0.268]

U.S. Pat. No. 5,893,110—Browser driven user interface to a media asset database [0.249]

U.S. Pat. No. 6,832,217—Information inquiry support apparatus, information inquiry support method, information distribution apparatus, and information distribution method [0.227]

U.S. Pat. No. 6,490,575—Distributed network search engine [0.222]

U.S. Pat. No. 6,175,829—Method and apparatus for facilitating query reformulation [0.222]

U.S. Pat. No. 6,832,218—System and method for associating search results [0.222]

U.S. Pat. No. 6,085,199—Method for distributing a file in a plurality of different file formats [0.210]

U.S. Pat. No. 6,728,704—Method and apparatus for merging result lists from multiple search engines [0.222]

U.S. Pat. No. 6,098,066—Method and apparatus for searching for documents stored within a document directory hierarchy [0.211]

U.S. Pat. No. 6,785,670—Automatically initiating an internet-based search from within a displayed document [0.208]

U.S. Pat. No. 6,785,674—System and method for structuring data in a computer system [0.201]

U.S. Pat. No. 6,012,064—Maintaining a random sample of a relation in a database in the presence of updates to the relation [0.208]

U.S. Pat. No. 7,409,412—Data element and structure for data processing [0.201]

U.S. Pat. No. 6,704,735—Managing object life cycles using object-level cursor [0.199]

U.S. Pat. No. 5,987,457—Query refinement method for searching documents [0.199]

U.S. Pat. No. 5,826,261—System and method for querying multiple, distributed databases by selective sharing of local relative significance information for terms related to the query [0.199]

We may be more interested in the creator dimension and shared citations now: we set values: FOS=0.3, CRE=0.8, CIT=0.8, PCIT=0.4 and query the neighbor U.S. Pat. No. 7,047,242—“Weighted term ranking for on-line query tool”, a patent whose assignee is Verizon Laboratories Inc.; the innovation is about a system for performing online data queries where “Generic objects are created and used to represent business listings upon which the user may perform queries” [see: abstract, http://www.google.com/patents/US7047242]; the first claim is about “ranking super-categories used in performing data queries”.

We obtain results such as U.S. Pat. No. 6,826,559, U.S. Pat. No. 7,024,416, U.S. Pat. No. 6,374,241, strongly related to U.S. Pat. No. 7,047,242. See FIG. 11B.

To better understand the Figure, the following list is provided.

First Results of a query within a chosen context. Proximity Values are reported in brackets. Queried patents are formatted in bold font; the current query is marked by the symbol *.

Results of a 2nd, 3rd, n-th query are listed in paragraphs below; the patents which were already obtained from previous query are omitted, despite proximity value may change their relative rank respect to the current searched node.

[symbol]

[symbol]

[symbol]

[symbol]

[symbol]

[symbol]

[symbol]

[symbol]

[symbol]

[symbol]

[symbol]

[symbol]

[symbol]

U.S. Pat. No. 5,893,110—Browser driven user interface to a media asset database [0.249]

U.S. Pat. No. 6,832,217—Information inquiry support apparatus, information inquiry support method, information distribution apparatus, and information distribution method [0.227]

U.S. Pat. No. 6,490,575—Distributed network search engine [0.222]

U.S. Pat. No. 6,175,829—Method and apparatus for facilitating query reformulation [0.222]

U.S. Pat. No. 6,832,218—System and method for associating search results [0.222]

U.S. Pat. No. 6,085,199—Method for distributing a file in a plurality of different file formats [0.210]

U.S. Pat. No. 6,728,704—Method and apparatus for merging result lists from multiple search engines [0.222]

U.S. Pat. No. 6,098,066—Method and apparatus for searching for documents stored within a document directory hierarchy [0.211]

U.S. Pat. No. 6,785,670—Automatically initiating an internet-based search from within a displayed document [0.208]

U.S. Pat. No. 6,785,674—System and method for structuring data in a computer system [0.201]

U.S. Pat. No. 6,012,064—Maintaining a random sample of a relation in a database in the presence of updates to the relation [0.208]

U.S. Pat. No. 7,409,412—Data element and structure for data processing [0.201]

U.S. Pat. No. 6,704,735—Managing object life cycles using object-level cursor [0.199]

U.S. Pat. No. 5,987,457—Query refinement method for searching documents [0.199]

U.S. Pat. No. 5,826,261—System and method for querying multiple, distributed databases by selective sharing of local relative significance information for terms related to the query [0.199]

U.S. Pat. No. 6,826,559—Hybrid category mapping for on-line query tool [0.347]

U.S. Pat. No. 7,024,416—Semi-automatic index term augmentation in document retrieval [0.328]

U.S. Pat. No. 6,374,241—Data merging techniques [0.245]

U.S. Pat. No. 6,665,665—Compressed document surrogates [0.173]

U.S. Pat. No. 7,861,088—Method and system for verifiably recording voice communications [0.173]

U.S. Pat. No. 6,487,403—Wireless universal provisioning device [0.173]

U.S. Pat. No. 8,271,539—Hierarchy modification [0.173]

U.S. Pat. No. 6,578,056—Efficient data transfer mechanism for synchronization of multi-media databases [0.173]

U.S. Pat. No. 7,062,781—Method for providing simultaneous parallel secure command execution on multiple remote hosts [0.173]

U.S. Pat. No. 6,456,956—Algorithm for selectively suppressing NLOS signals in location estimation [0.173]

U.S. Pat. No. 7,240,056—Compressed document surrogates [0.173]

U.S. Pat. No. 7,613,299—Cryptographic techniques for a communications network [0.173]

U.S. Pat. No. 7,917,447—Method and system for providing a community of interest service [0.173]

U.S. Pat. No. 6,272,550—Method and apparatus for acknowledging top data packets [0.141]

U.S. Pat. No. 6,298,062—System providing integrated services over a computer network [0.141]

U.S. Pat. No. 6,512,933—Iterative system and method for optimizing CDMA load distribution using reverse interference measurements [0.141]

They are patents also assigned to Verizon Laboratories; “U.S. Pat. No. 6,826,559”—“Hybrid category mapping for on-line query tool”, Verizon Laboratories Inc., and U.S. Pat. No. 6,374,241—“Data merging techniques”, Verizon Laboratories Inc., have identical abstracts of U.S. Pat. No. 7,047,242 and extends the scope of the invention with differences such as in attached Figures, “Claims” and “Summary of the Invention” sections. The invention relates “the field of telecommunications and more particularly to the field of electronic commerce” (see: U.S. Pat. No. 7,047,242—Background of Invention, Par. 1—Fields of Invention) and focus on method to target web advertisement (banner ads) to users (see: U.S. Pat. No. 7,047,242—Background of Invention, Par. 2—Description of Related Art). The three patents contains descriptions which contextualize the invention of the searched U.S. Pat. No. 7,047,242 in three slightly different ways, such as “a technique which efficiently updates an existing database by using various techniques to determine semantic equivalents of various record entries which should be considered as matching” (U.S. Pat. No. 6,374,241-Summary of The invention); “system for establishing super-category lists for use in an on-line query tool [which] may include obtaining categories of documents, such as yellow pages categories, that may be retrieved with the query tool, [ . . . ] may further include establishing super-category terms for the documents, mapping each of the categories to a super-category term and establishing a super-category list. Advertisement may be matched to the super-category terms” (U.S. Pat. No. 6,826,559—Summary of The invention); and “a method of ranking super-category terms for use in an on-line query tool, including establishing a super-category list [ . . . ]. The ranking of categories may be further weighted to reflect information about the terms” (U.S. Pat. No. 7,047,242—Summary of The invention).

U.S. Pat. No. 7,024,416—“Semi-automatic index term augmentation in document retrieval” discloses “methods and systems for indexing or retrieving materials accessible through computer networks”, and also extend the context of “ranking super-category terms for use in an-online query tools” in U.S. Pat. No. 7,047,242 with methods “for assigning categories of items to super categories” (see: Claims section).

E: Contextualizing patent: U.S. Pat. No. 6,266,649 (Assignee: Amazon.com, Inc.).

The patent is about “Collaborative recommendations using item-to-item similarity mappings”. We propose two examples of navigation for this patent.

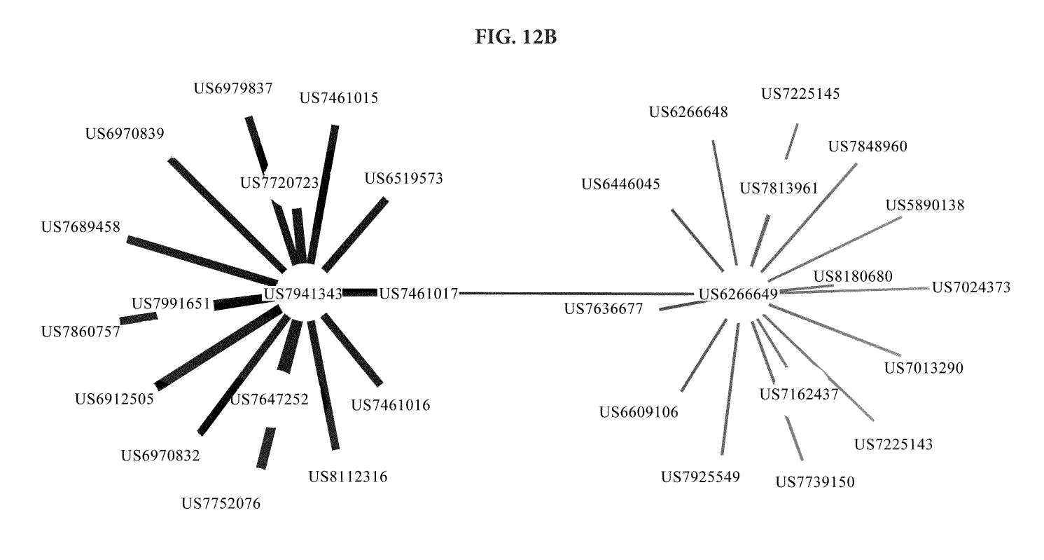

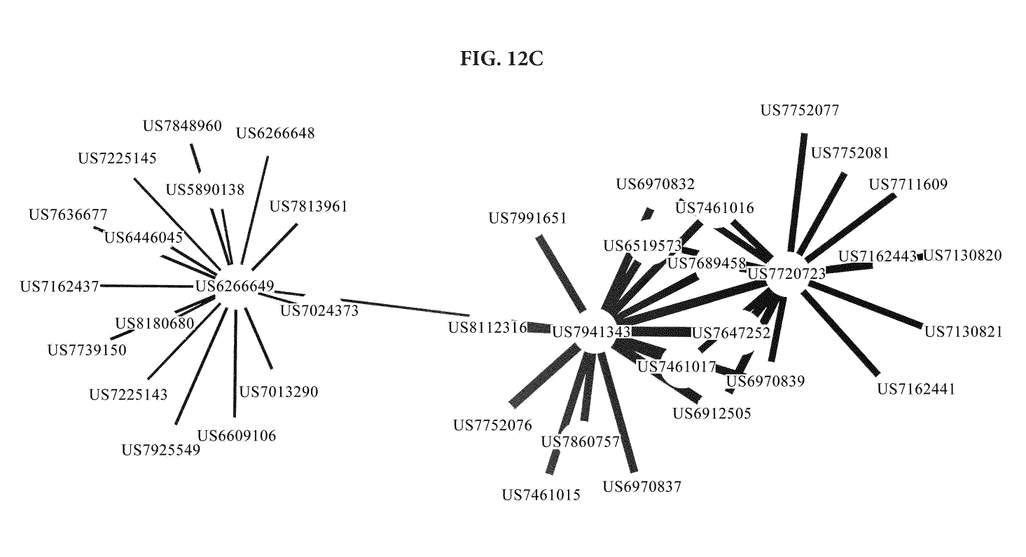

We may want to overview the domain of application of item-to-item based recommendations, such as the one developed by Amazon and applied to Amazon website to increase sales against its users' base. With parameters FOS=0.3 CRE=0.3 CIT=0.3 PCIT=0.3 we obtain results pertaining to “enhancing products sales in network transactions”, systems and methods for “purchasing”, payment platforms, “mass media commerce”, “improving on-line purchasing” and “recommending a product over a computer network”; and “personalized interactive [ . . . ] catalog profiling” against unique users. See FIG. 12A.

To better understand the Figure, the following list is provided.

First Results of a query within a chosen context. Proximity Values are reported in brackets. Queried patents are formatted in bold font; the current query is marked by the symbol *.

[symbol]

[symbol]

[symbol]

[symbol]

[symbol]

[symbol]

[symbol]

U.S. Pat. No. 6,446,045—Method for using computers to facilitate and control the creating of a plurality of functions [0.164]

U.S. Pat. No. 7,739,150—Systems and methods for automated mass media commerce [0.164]

U.S. Pat. No. 6,609,106—System and method for providing electronic multi-merchant gift registry services over a distributed network [0.164]

U.S. Pat. No. 7,013,290—Personalized interactive digital catalog profiling [0.164]

U.S. Pat. No. 7,848,960—Methods for an alternative payment platform [0.164]

U.S. Pat. No. 7,636,677—Method, medium, and system for determining whether a target item is related to a candidate affinity item [0.164]

U.S. Pat. No. 7,925,549—Personalized marketing architecture [0.164]

U.S. Pat. No. 7,813,961—System and method for planning, allocation, and purchasing [0.164]

U.S. Pat. No. 7,941,343—Method and system for enhancing product sales in network transactions [0.142]

U.S. Pat. No. 7,024,373—Auto purchase system and method [0.142]

U.S. Pat. No. 7,225,145—Method and system for providing multi-organization resource management [0.142]

U.S. Pat. No. 7,225,143—System and method for inverted promotions [0.142]

U.S. Pat. No. 7,162,437—Method and apparatus for improving on-line purchasing [0.142]

U.S. Pat. No. 6,266,648—Benefits tracking and correlation system for use with third-party enabling organizations [0.142]

U.S. Pat. No. 5,890,138—Computer auction system [0.142]

U.S. Pat. No. 8,180,680—Method and system for recommending a product over a computer network [0.142]

We may want to give more importance to similar application domains and to the citations referred by the patent, which are two contexts whose information is contained respectively in FOS and CIS proximity matrices.

We may want to give less importance to the creator, which in our example include the assignee who benefit of the patent; we may want to also give less importance to the impact of the invention, reflected in the fact patent has been cited as reference after its application date: thus we shall decrease the parameter for CRE and PCIT proximity matrices.

We set values FOS=O. 7 CRE=0.1 CIT=0.5 PCIT=0.1 and query the neighboring U.S. Pat. No. 7,941,343—“Method and system for enhancing product sales in network transactions”. See FIG. 12B.

To better understand the Figure, the following list is provided.

First Results of a query within a chosen context. Proximity Values are reported in brackets. Queried patents are formatted in bold font; the current query is marked by the symbol *

Results of a 2nd, 3rd, n-th query are listed in paragraphs below; the patents which were already obtained from previous query are omitted, despite proximity value may change their relative rank respect to the current searched node.

[symbol]

[symbol]

[symbol]

[symbol]

[symbol]

[symbol]

[symbol]

U.S. Pat. No. 6,446,045—Method for using computers to facilitate and control the creating of a plurality of functions [0.164]

U.S. Pat. No. 7,739,150—Systems and methods for automated mass media commerce [0.164]

U.S. Pat. No. 6,609,106—System and method for providing electronic multi-merchant gift registry services over a distributed network [0.164]

U.S. Pat. No. 7,013,290—Personalized interactive digital catalog profiling [0.164]

U.S. Pat. No. 7,848,960—Methods for an alternative payment platform [0.164]

U.S. Pat. No. 7,636,677—Method, medium, and system for determining whether a target item is related to a candidate affinity item [0.164]

U.S. Pat. No. 7,925,549—Personalized marketing architecture [0.164]

U.S. Pat. No. 7,813,961—System and method for planning, allocation, and purchasing [0.164]

[symbol]

[symbol]

[symbol]

[symbol]

[symbol]

[symbol]

[symbol]

[symbol]

[symbol]

U.S. Pat. No. 7,024,373—Auto purchase system and method [0.142]

U.S. Pat. No. 7,225,145—Method and system for providing multi-organization resource management [0.142]

U.S. Pat. No. 7,225,143—System and method for inverted promotions [0.142]

U.S. Pat. No. 7,162,437—Method and apparatus for improving on-line purchasing [0.142]

U.S. Pat. No. 6,266,648—Benefits tracking and correlation system for use with third-party enabling organizations [0.142]

U.S. Pat. No. 5,890,138—Computer auction system [0.142]

U.S. Pat. No. 8,180,680—Method and system for recommending a product over a computer network [0.142]

U.S. Pat. No. 6,912,505—Use of product viewing histories of users to identify related products [0.433]

U.S. Pat. No. 7,647,252—Methods and systems for an alternative payment platform [0.433]

U.S. Pat. No. 7,752,076—Inventory management of resources [0.433]

U.S. Pat. No. 7,720,723—User interface and methods for recommending items to users [0.433]

U.S. Pat. No. 7,689,458—Systems and methods for determining bid value for content items to be placed on a rendered page [0.375]

U.S. Pat. No. 6,979,837—Stacked organic memory devices and methods of operating and fabricating [0.353]

U.S. Pat. No. 7,461,015—Computer-usable medium for providing automatic sales support [0.353]

U.S. Pat. No. 7,461,016—Computer-usable medium for providing automatic sales support [0.353]

U.S. Pat. No. 7,461,017—System and method for enabling jewelry certification at local jeweler sites [0.353]

U.S. Pat. No. 7,991,651—Increases in sales rank as a measure of interest [0.353]

U.S. Pat. No. 7,860,757—Enhanced transaction fulfillment [0.353]

U.S. Pat. No. 6,970,839—Method, apparatus, and article of manufacture for generating secure recommendations from market-based financial instrument prices [0.353]

U.S. Pat. No. 6,519,573—System and method for charitable giving [0.353]

U.S. Pat. No. 8,112,316—Digital photograph processing and ordering system and method [0.353]

U.S. Pat. No. 6,970,832—Configuration of computer systems based upon purchaser component needs as determined from purchaser data entries and having a tiered structure of financial incentive levels automatically provided from distributor to system resellers [0.353]

We obtain a star more focusing on the applications of recommendations in network transactions, which may include interfaces, payment methods and methods related to recommending related products. We notice: U.S. Pat. No. 7,720,723—“User interface and methods for recommending items to users”, Amazon Technologies, Inc.; U.S. Pat. No. 7,991,651—“Increases in sales rank as a measure of interest”, Amazon Technologies Inc.; U.S. Pat. No. 6,912,505—“Use of product viewing histories of users to identify related products”, Amazon.com, Inc.; and U.S. Pat. No. 7,647,252-“Methods and systems for an alternative payment platform”, TrialPay, Inc.

We notice that claims of U.S. Pat. No. 7,720,723, Amazon Technologies, Inc., are focused on a method of “recommending items to users [ . . . ] that provides electronic shopping carts for users” (see: Claims, paragraph 1); such claims are highly related with ones of U.S. Pat. No. 7,647,252, TrialPay, Inc., which focus on a “method of electronic commerce wherein a user is engaged with a primary offer of a vendor” (see: Claims, paragraph 1).

In consideration of the invention disclosed in this document, we also notice that the recommendation system developed by Amazon results contextualized as a of bi-partite graph between “users” and “items” viewed by users: abstract of neighboring U.S. Pat. No. 6,912,505 states: “products A and B are related because a significant portion of those who viewed A also viewed B”; we observe U.S. Pat. No. 6,912,505 figures among first proximity neighbors of U.S. Pat. No. 6,266,649.

The concept of bi-partite graph is found also in U.S. Pat. No. 7,461,016—“Computer-usable medium for providing automatic sales support”, AT&T Corp., where “Individual customers are mapped to one or more salespersons” (see: Abstract section and the FIG. 4 of U.S. Pat. No. 7,461,016, depicting the relations between a selling company and a customer company). The patent claims a method comprising “receiving from the salesperson a selection of a target item for the salesperson from an individual customer assigned to the salesperson;” and “receiving from the salesperson a selection of a target item for the salesperson from an individual customer assigned to the salesperson;” (see: Claims section).

We also discover other industrial domain of applications beyond the electronic catalogue and commerce, such as “jewelry certifications” and “ordering methods” applied to digital photograph processing, or more generic “computer-usable medium for providing automatic sales support”.

These examples show the possibility to find and observe options gradually diversifying the scope of an invention by comparing, within a specific context of the proximity matrix, the technical field and commercial domain of a patent, with the technical fields and domains of neighboring patents.

We may want to pivot on assignees and type of application, thus we further contextualize patents against the CRE and FOS parameters. Within the context of values FOS=0.7 CRE=0.7 CIT=0.3 PCIT=0.2 we query the U.S. Pat. No. 7,720,723—“User interface and methods for recommending items to users”, Amazon Technologies, Inc. See FIG. 12C.

To better understand the Figure, the following list is provided.

First Results of a query within a chosen context. Proximity Values are reported in brackets. Queried patents are formatted in bold font; the current query is marked by the symbol *

[symbol]

[symbol]

[symbol]

[symbol]

[symbol]

[symbol]

[symbol]

U.S. Pat. No. 6,266,649—Collaborative recommendations using item-to-item similarity mappings

U.S. Pat. No. 6,446,045—Method for using computers to facilitate and control the creating of a plurality of functions [0.164]

U.S. Pat. No. 7,739,150—Systems and methods for automated mass media commerce [0.164]

U.S. Pat. No. 6,609,106—System and method for providing electronic multi-merchant gift registry services over a distributed network [0.164]

U.S. Pat. No. 7,013,290—Personalized interactive digital catalog profiling [0.164]

U.S. Pat. No. 7,848,960—Methods for an alternative payment platform [0.164]

U.S. Pat. No. 7,636,677—Method, medium, and system for determining whether a target item is related to a candidate affinity item [0.164]

U.S. Pat. No. 7,925,549—Personalized marketing architecture [0.164]

U.S. Pat. No. 7,813,961—System and method for planning, allocation, and purchasing [0.164]

[symbol]

[symbol]

[symbol]

[symbol]

[symbol]

[symbol]

[symbol]

[symbol]

U.S. Pat. No. 7,024,373—Auto purchase system and method [0.142]

U.S. Pat. No. 7,225,145—Method and system for providing multi-organization resource management [0.142]

U.S. Pat. No. 7,225,143—System and method for inverted promotions [0.142]

U.S. Pat. No. 7,162,437—Method and apparatus for improving on-line purchasing [0.142]

U.S. Pat. No. 6,266,648—Benefits tracking and correlation system for use with third-party enabling organizations [0.142]

U.S. Pat. No. 5,890,138—Computer auction system [0.142]

U.S. Pat. No. 8,180,680—Method and system for recommending a product over a computer network [0.142]

U.S. Pat. No. 6,912,505—Use of product viewing histories of users to identify related products [0.433]

U.S. Pat. No. 7,647,252—Methods and systems for an alternative payment platform [0.433]

U.S. Pat. No. 7,752,076—Inventory management of resources [0.433]

[symbol]

[symbol]

[symbol]

[symbol]

[symbol]

[symbol]

[symbol]

U.S. Pat. No. 7,689,458—Systems and methods for determining bid value for content items to be placed on a rendered page [0.375]

U.S. Pat. No. 6,979,837—Stacked organic memory devices and methods of operating and fabricating [0.353]

U.S. Pat. No. 7,461,015—Computer-usable medium for providing automatic sales support [0.353]

U.S. Pat. No. 7,461,016—Computer-usable medium for providing automatic sales support [0.353]

U.S. Pat. No. 7,461,017—System and method for enabling jewelry certification at local jeweler sites [0.353]

U.S. Pat. No. 7,991,651—Increases in sales rank as a measure of interest [0.353]

U.S. Pat. No. 7,860,757—Enhanced transaction fulfillment [0.353]

U.S. Pat. No. 6,970,839—Method, apparatus, and article of manufacture for generating secure recommendations from market-based financial instrument prices [0.353]

U.S. Pat. No. 6,519,573—System and method for charitable giving [0.353]

U.S. Pat. No. 8,112,316—Digital photograph processing and ordering system and method [0.353]

U.S. Pat. No. 6,970,832—Configuration of computer systems based upon purchaser component needs as determined from purchaser data entries and having a tiered structure of financial incentive levels automatically provided from distributor to system resellers [0.353]

U.S. Pat. No. 7,752,077—Method and system for automated comparison of items [0.300]

U.S. Pat. No. 7,752,081—Social-network enabled review system with subject-owner controlled syndication [0.300]

U.S. Pat. No. 7,711,609—System and method for placing products or services and facilitating purchase [0.300]

U.S. Pat. No. 7,162,443—Method and computer readable medium storing executable components for locating items of interest among multiple merchants in connection with electronic shopping [0.300]

U.S. Pat. No. 7,130,820—Methods and systems of assisting users in purchasing items [0.300]

U.S. Pat. No. 7,130,821—Method and apparatus for product comparison [0.300]

U.S. Pat. No. 7,162,441—Method and system for buying and selling bras [0.300]

We obtain neighbors such as U.S. Pat. No. 7,752,077—“Method and system for automated comparison of items”, Amazon Technologies, Inc.; U.S. Pat. No. 7,130,820-“Methods and systems of assisting users in purchasing items”, Amazon.Com, Inc., U.S. Pat. No. 7,752,081-“Social-network enabled review system with subject-owner controlled syndication”, Diamond Review, Inc., whose embodiment “includes a review engine that [ . . . ] receives, stores, and retrieves reviews, based upon the subject and the users' relationship to the authors of the reviews” (see: Abstract).

We notice analogies between the claims of U.S. Pat. No. 7,752,077 and U.S. Pat. No. 7,752,081. The first one claims a method for “automated comparison of items” (see: Claims, par. I) wherein the items can be identified “by a user”, “from a type of item indicated by user activity”, being “a user activity a user interaction with a Web page” or “a user interaction with a catalogue of items offered by a merchant” (see Claims, par. 2-6). The second one claims “A computer controlled method in a review-provider server” (see Claims, par. 1), wherein “one or more [ . . . ] functions includes one or more selected from a group [ . . . ] as an editorial review, [ . . . ] as an expert user-author, [ . . . ], as a subject-owner [ . . . ]”.

We notice there may be other patents claiming systems for buying items based on relationships between items and users, which may be focusing outside the domain of e-commerce contextualizing the industrial domain of Amazon: U.S. Pat. No. 7,162,441-“Method and system for buying and selling bras”, T-Bra Limited, discloses a “method of and system for buying or selling bras” which involves “establishing a database of bras containing bra characteristic data [ . . . ], wearer characteristic data, [ . . . ] and listing for selection by the wearer any bras in the database whose characteristics match the wearer characteristic data” (see: Abstract).

As a second example concerning U.S. Pat. No. 6,266,649, we may now want to overview results on a context which further consider the influence that such invention had on patents filed afterwards its application date.

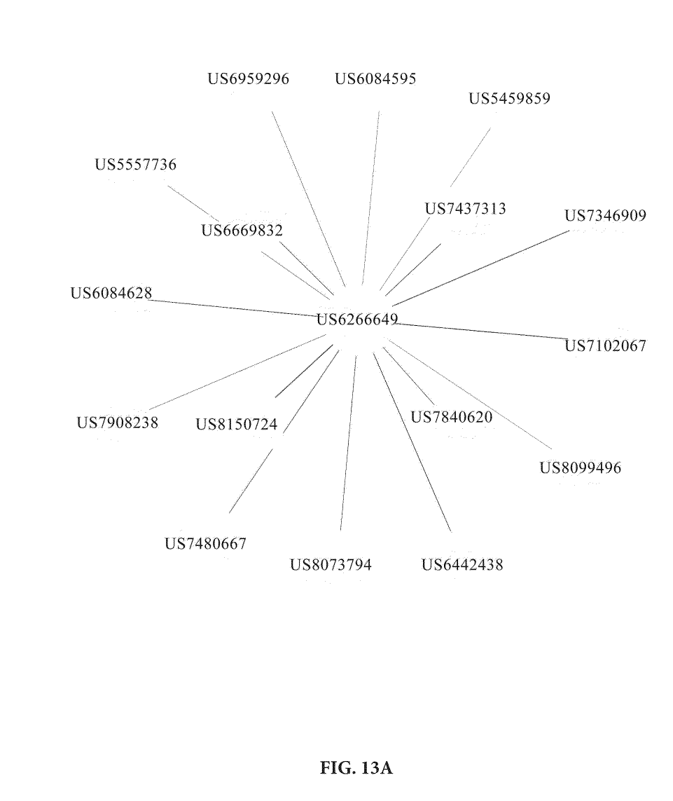

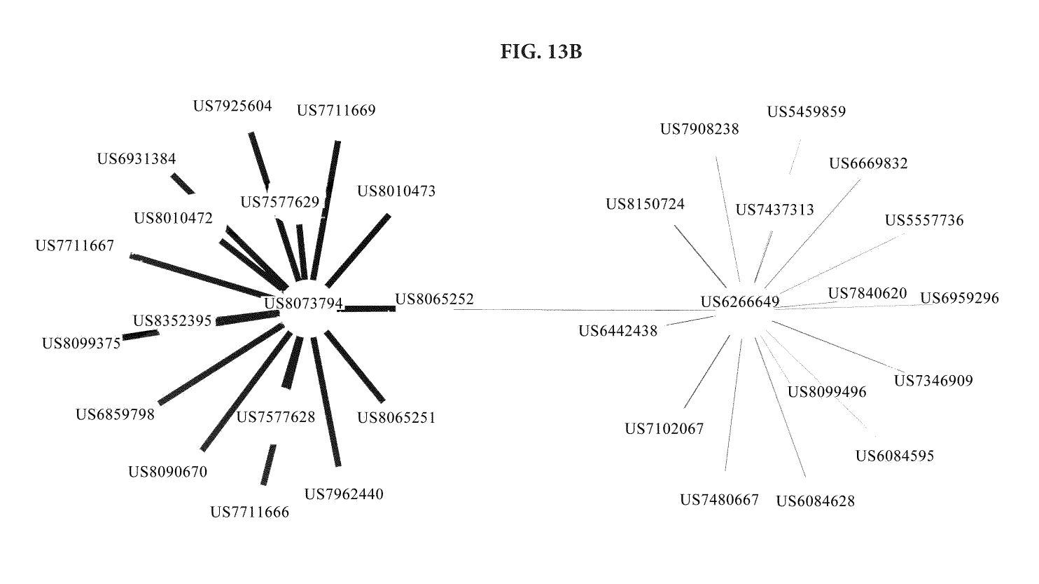

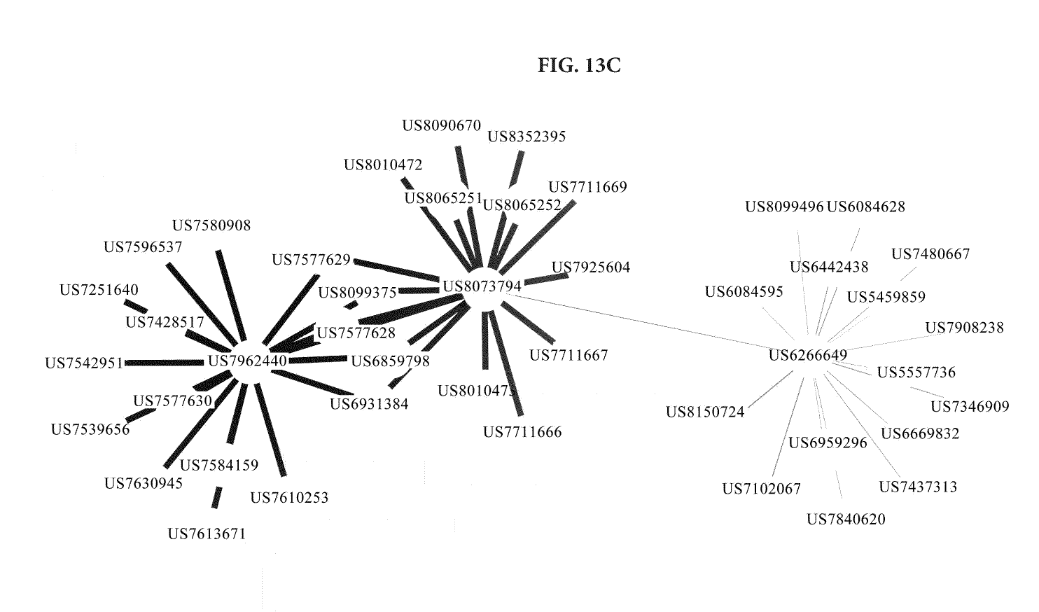

We want to increase PCIT, take into account CIT, also decrease other parameters; specifically we significantly lower FOS and CRE, in order to obtain a proximity matrix which contextualizes patents mostly by the background of knowledge sustaining an invention rather than by the application fields and creators. See FIG. 13A.

With values FOS=0; CRE=0; CIT=0.3 and PCIT=1 we obtain results such as:

U.S. Pat. No. 8,150,724—“System for eliciting accurate judgment of entertainment items”, Emergent Discovery LLC, which “elicits reliable ratings of entertainment items” where “Appropriate users are identified to supply ratings”, and “The identification of appropriate users is based on taste signatures of the items to be rated and of the users” (see: Abstract);

U.S. Pat. No. 8,073,794—“Social behavior analysis and inferring social networks for a recommendation system”, Yahoo!Inc., where “Systems and methods are provided for determining items or people of potential interest to recommend to users in a computer-based network” (see: Abstract);

U.S. Pat. No. 6,084,628 “System and method of providing targeted advertising during video telephone calls”, Telefonaktiebolaget LM Ericsson (pub), which refers to “A system in a telecommunications network for providing targeted advertising to subscribers”, where “The information source stores a plurality of advertisements, and [ . . . ] advertisements [are] based on the advertising preferences for an identified subscriber such as the calling subscriber”.

These results show different possibilities for contextualizing methods matching items, in a broader term, to users' choices.

To better understand the Figure, the following list is provided.

First Results of a query within a chosen context. Proximity Values are reported in brackets. Queried patents are formatted in bold font; the current query is marked by the symbol *.

[symbol]

[symbol]

[symbol]

[symbol]

[symbol]

[symbol]

[symbol]

U.S. Pat. No. 8,150,724—System for eliciting accurate judgement of entertainment items [0.05]

U.S. Pat. No. 7,102,067—Using a system for prediction of musical preferences for the distribution of musical content over cellular networks [0.04]

U.S. Pat. No. 7,346,909—Network-like communication and stack synchronization for different virtual machines on the same physical device [0.04]

U.S. Pat. No. 6,442,438—Method for controlling a decisional process when pursuing an aim in a specific field of application, such as economical, technical, organizational or similar and system for implementing the method [0.04]

U.S. Pat. No. 6,669,832—Electronic transaction system [0.03]

U.S. Pat. No. 6,084,628—System and method of providing targeted advertising during video telephone calls [0.03]

U.S. Pat. No. 7,437,313—Methods, computer-readable media, and apparatus for offering users a plurality of scenarios under which to conduct at least one primary transaction [0.03]

U.S. Pat. No. 7,840,620—Hierarchical playlist generator [0.02]

U.S. Pat. No. 6,959,296—Systems and methods of choosing multi-component packages using an expert system [0.02]

U.S. Pat. No. 7,480,667—System and method for using anchor text as training data for classifier-based search systems [0.03]

U.S. Pat. No. 5,557,736—Computer system and job transfer method using electronic mail system [0.02]

U.S. Pat. No. 7,908,238—Prediction engines using probability tree and computing node probabilities for the probability tree [0.02]

U.S. Pat. No. 8,099,496—Systems and methods for clickstream analysis to modify an off-line business process involving matching a distribution list [0.01]

U.S. Pat. No. 8,073,794—Social behavior analysis and inferring social networks for a recommendation system [0.02]

U.S. Pat. No. 6,084,595—Indexing method for image search engine [0.01]

U.S. Pat. No. 5,459,859—Apparatus and system for providing information required for meeting with desired person while traveling [0.01]

We may want to further query a neighboring patent of our interest, increase also the value for FOS, and explore other neighbors within the context of proximity matrix obtained with values: FOS=0.5 CRE=O. CIT=0.3 PCIT=1.0.

We query U.S. Pat. No. 8,073,794—“Social behavior analysis and inferring social networks for a recommendation system”, Yahoo!Inc. and obtain results such as (See FIG. 13B):

U.S. Pat. No. 7,711,667—“Method and system for measuring interest levels of digital messages”, by Philippe Baumard, which discloses a method where “relevance levels of an incoming or outgoing message for presenting it to an interlocutor is measured without having to actually interact with the interlocutor” (see: Abstract);

U.S. Pat. No. 7,577,629—“Computer-implemented system and method for facilitating and evaluating user thinking about an arbitrary problem”, Zxibix, Inc., where “Preferred embodiments of the invention provide a computer-implemented system and method for facilitating user thinking about an arbitrary problem” (see: Abstract);

U.S. Pat. No. 8,010,472—“System and method for evaluating information”, Kabushiki Kaisha Toshiba, which discloses an “An information estimation system” which includes “a preference model generating unit that generates a preference model [ . . . ] for a user based on a behavior history that indicates history of behavior of the user; [and that] calculates probability of a plurality of recommended candidates based on the preference model” (see: Claims, paragraph I);

U.S. Pat. No. 7,962,440—“Adaptive industrial systems via embedded historian data”, Rockwell Automation Technologies, Inc., which discloses a method which uses historian data “to determine/predict an outcome of a current industrial process.”

To better understand the Figure, the following list is provided.

First Results of a query within a chosen context. Proximity Values are reported in brackets. Queried patents are formatted in bold font; the current query is marked by the symbol *

Results of a 2nd, 3rd, n-th query are listed in paragraphs below; the patents which were already obtained from previous query are omitted, despite proximity value may change their relative rank respect to the current searched node.

[symbol]

[symbol]

[symbol]

[symbol]

[symbol]

[symbol]

[symbol]

U.S. Pat. No. 8,150,724—System for eliciting accurate judgement of entertainment items [0.05]

U.S. Pat. No. 7,102,067—Using a system for prediction of musical preferences for the distribution of musical content over cellular networks [0.04]

U.S. Pat. No. 7,346,909—Network-like communication and stack synchronization for different virtual machines on the same physical device [0.04]

U.S. Pat. No. 6,442,438—Method for controlling a decisional process when pursuing an aim in a specific field of application, such as economical, technical, organizational or similar and system for implementing the method [0.038]

U.S. Pat. No. 6,669,832—Electronic transaction system [0.03]

U.S. Pat. No. 6,084,628—System and method of providing targeted advertising during video telephone calls [0.03]

U.S. Pat. No. 7,437,313—Methods, computer-readable media, and apparatus for offering users a plurality of scenarios under which to conduct at least one primary transaction [0.03]

U.S. Pat. No. 7,840,620—Hierarchical playlist generator [0.02]

U.S. Pat. No. 6,959,296—Systems and methods of choosing multi-component packages using an expert system [0.02]

U.S. Pat. No. 7,480,667—System and method for using anchor text as training data for classifier-based search systems [0.03]

U.S. Pat. No. 5,557,736—Computer system and job transfer method using electronic mail system [0.02]

U.S. Pat. No. 7,908,238—Prediction engines using probability tree and computing node probabilities for the probability tree [0.02]

U.S. Pat. No. 8,099,496—Systems and methods for clickstream analysis to modify an off-line business process involving matching a distribution list [0.018]

[symbol]

[symbol]

[symbol]

[symbol]

[symbol]

[symbol]

[symbol]

[symbol]

[symbol]

U.S. Pat. No. 6,084,595—Indexing method for image search engine [0.018]

U.S. Pat. No. 5,459,859—Apparatus and system for providing information required for meeting with desired person while traveling [0.018]

U.S. Pat. No. 8,065,252—Method and system of knowledge component based engineering design [0.277]

U.S. Pat. No. 8,010,473—Prime indexing and/or other related operations [0.277]

U.S. Pat. No. 7,711,666—Reduction of memory usage for prime number storage by using a table of differences between a closed form numerical function and prime numbers which bounds a prime numeral between two index values [0.277]

U.S. Pat. No. 8,010,472—System and method for evaluating information [0.277]

U.S. Pat. No. 7,577,628—Startup and control of graph-based computation [0.277]

U.S. Pat. No. 8,352,395—Training an attentional cascade [0.277]

U.S. Pat. No. 7,577,629—Computer-implemented system and method for facilitating and evaluating user thinking about an arbitrary problem [0.277]

U.S. Pat. No. 8,065,251—Dynamic management of a process model repository for a process control system [0.277]

U.S. Pat. No. 7,962,440—Adaptive industrial systems via embedded historian data [0.277]

U.S. Pat. No. 8,090,670—System and method for remote usage modeling [0.277]

U.S. Pat. No. 8,099,375—Non-classical suspension of a logic gate [0.277]

U.S. Pat. No. 7,711,667—Method and system for measuring interest levels of digital messages [0.277]

U.S. Pat. No. 6,931,384—System and method providing utility-based decision making about clarification dialog given communicative uncertainty [0.277]

U.S. Pat. No. 7,925,604—Adaptive greedy method for ordering intersecting of a group of lists into a left-deep AND-tree [0.277]

U.S. Pat. No. 7,711,669—Configurable hierarchical content filtering system [0.277]

U.S. Pat. No. 6,859,798—Intelligence server system [0.277]

We now select the proximity matrix obtained with values: FOS=0.5 CRE=O. CIT=0.3 PCIT=1, and query the neighboring U.S. Pat. No. 7,962,440. See FIG. 13C.

To better understand the Figure, the following list is provided.

First Results of a query within a chosen context. Proximity Values are reported in brackets. Queried patents are formatted in bold font; the current query is marked by the symbol *

Results of a 2nd, 3rd, n-th query are listed in paragraphs below; the patents which were already obtained from previous query are omitted, despite proximity value may change their relative rank respect to the current searched node.

[symbol]

[symbol]

[symbol]

[symbol]

[symbol]

[symbol]

[symbol]

U.S. Pat. No. 8,150,724—System for eliciting accurate judgement of entertainment items [0.05]

U.S. Pat. No. 7,102,067—Using a system for prediction of musical preferences for the distribution of musical content over cellular networks [0.04]

U.S. Pat. No. 7,346,909—Network-like communication and stack synchronization for different virtual machines on the same physical device [0.04]

U.S. Pat. No. 6,442,438—Method for controlling a decisional process when pursuing an aim in a specific field of application, such as economical, technical, organizational or similar and system for implementing the method [0.038]

U.S. Pat. No. 6,669,832—Electronic transaction system [0.03]

U.S. Pat. No. 6,084,628—System and method of providing targeted advertising during video telephone calls [0.03]

U.S. Pat. No. 7,437,313—Methods, computer-readable media, and apparatus for offering users a plurality of scenarios under which to conduct at least one primary transaction [0.03]

U.S. Pat. No. 7,840,620—Hierarchical playlist generator [0.02]

U.S. Pat. No. 6,959,296—Systems and methods of choosing multi-component packages using an expert system [0.02]

U.S. Pat. No. 7,480,667—System and method for using anchor text as training data for classifier-based search systems [0.03]

U.S. Pat. No. 5,557,736—Computer system and job transfer method using electronic mail system [0.02]

U.S. Pat. No. 7,908,238—Prediction engines using probability tree and computing node probabilities for the probability tree [0.02]

U.S. Pat. No. 8,099,496—Systems and methods for clickstream analysis to modify an off-line business process involving matching a distribution list [0.018]

[symbol]

[symbol]

[symbol]

[symbol]

[symbol]

[symbol]

[symbol]

[symbol]

[symbol]

U.S. Pat. No. 6,084,595—Indexing method for image search engine [0.018]

U.S. Pat. No. 5,459,859—Apparatus and system for providing information required for meeting with desired person while traveling [0.018]

U.S. Pat. No. 8,065,252—Method and system of knowledge component based engineering design [0.277]

U.S. Pat. No. 8,010,473—Prime indexing and/or other related operations [0.277]

U.S. Pat. No. 7,711,666—Reduction of memory usage for prime number storage by using a table of differences between a closed form numerical function and prime numbers which bounds a prime numeral between two index values [0.277]

U.S. Pat. No. 8,010,472—System and method for evaluating information [0.277]

U.S. Pat. No. 7,577,628—Startup and control of graph-based computation [0.277]

U.S. Pat. No. 8,352,395—Training an attentional cascade [0.277]

U.S. Pat. No. 7,577,629—Computer-implemented system and method for facilitating and evaluating user thinking about an arbitrary problem [0.277]

U.S. Pat. No. 8,065,251—Dynamic management of a process model repository for a process control system [0.277]

[symbol]

[symbol]

[symbol]

[symbol]

[symbol]

[symbol]

[symbol]

U.S. Pat. No. 8,090,670—System and method for remote usage modeling [0.277]

U.S. Pat. No. 8,099,375—Non-classical suspension of a logic gate [0.277]

U.S. Pat. No. 7,711,667—Method and system for measuring interest levels of digital messages [0.277]

U.S. Pat. No. 6,931,384—System and method providing utility-based decision making about clarification dialog given communicative uncertainty [0.277]

U.S. Pat. No. 7,925,604—Adaptive greedy method for ordering intersecting of a group of lists into a left-deep AND-tree [0.277]

U.S. Pat. No. 7,711,669—Configurable hierarchical content filtering system [0.277]

U.S. Pat. No. 6,859,798—Intelligence server system [0.277]

U.S. Pat. No. 7,584,159—Strategies for providing novel recommendations [0.277]

U.S. Pat. No. 7,542,951—Strategies for providing diverse recommendations [0.277]

U.S. Pat. No. 7,613,671—Approach for re-using business rules [0.277]

U.S. Pat. No. 7,539,656—System and method for providing an intelligent multi-step dialog with a user [0.277]

U.S. Pat. No. 7,577,630—System and method to customize the facilitation of development of user thinking about an arbitrary problem [0.277]

U.S. Pat. No. 7,428,517—Data integration and knowledge management solution [0.277]

U.S. Pat. No. 7,610,253—System and method to customize the facilitation of development of user thinking about an arbitrary problem [0.277]

U.S. Pat. No. 7,630,945—Building support vector machines with reduced classifier complexity [0.277]

U.S. Pat. No. 7,580,908—System and method providing utility-based decision making about clarification dialog given communicative uncertainty [0.277]

U.S. Pat. No. 7,596,537—System and method of facilitating and evaluating user thinking about an arbitrary problem using an archetype process [0.277]

U.S. Pat. No. 7,251,640—Method and system for measuring interest levels of digital messages [0.277]

We obtained contextualized patents about providing novel recommendations, diverse recommendations and providing dialog with users, such as:

U.S. Pat. No. 7,584,159—“Strategies for providing novel recommendations”, Amazon Technologies, Inc., which describes strategies “for generating novel recommendations [to a user], comprising: providing at least one source of information [ . . . ]; generating a set of original recommendations based [ . . . ] on said at least one source of information; generating a set of novel recommendations from the set of original recommendations [ . . . ]; providing the set of novel recommendations to a user” (see: Claims, paragraph I);

U.S. Pat. No. 7,542,951—“Strategies for providing diverse recommendations”, Amazon Technologies, Inc.; which is indeed cross-referenced to related U.S. Pat. No. 7,584,159—“Ser. No. 11/263,563, entitled “Strategies for providing novel recommendations,” filed on the same date as the instant application” (see: U.S. Pat. No. 7,542,951—Paragraph “Cross-reference to related applications”);

U.S. Pat. No. 7,539,656—“System and method for providing an intelligent multi-step dialog with a user”, Consona CRM Inc., which is about “a better customer experience” associated to a knowledge map, specifically through “A method and system [ . . . ] for retrieving information through the use of a multi-stage interaction with a client to identify particular knowledge content associated with a knowledge map.” (see: Abstract).

U.S. Pat. No. 7,610,253—“System and method to customize the facilitation of development of user thinking about an arbitrary problem”, Zxibix, Inc.;

### Example 2

### Discovery Engine on Human Knowledge

An application of the Discovery Engine on Human Knowledge is based on collaborative databases representing factual knowledge, such as Wikipedia. In the case of Wikipedia, one type of entity is the Wikipedia Article and the type of property we considered is the link to other Wikipedia articles. The Wikipedia database we parsed is based on the Freebase WEX—the bundle we processed contains more than 4M articles. We now show some example of uses of the Discovery Engine on Human Knowledge and the relative topics' contextualization. We notice that in the navigation the neighbors obtained for a topic are ordered meaningfully to guide the user in understanding consequential relations and in “making sense” of knowledge areas.

### A. Contextualizing Topic: Mathematics

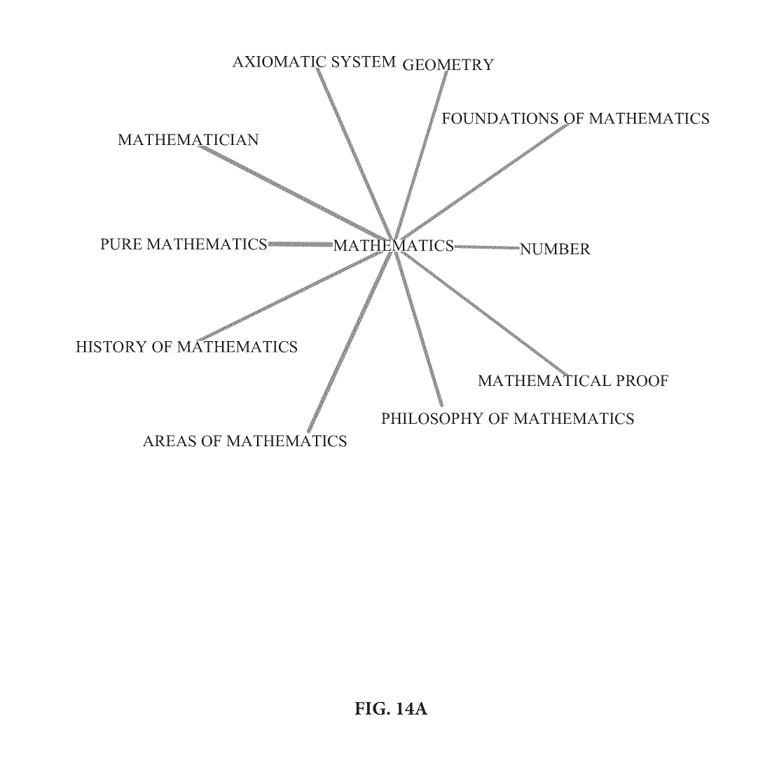

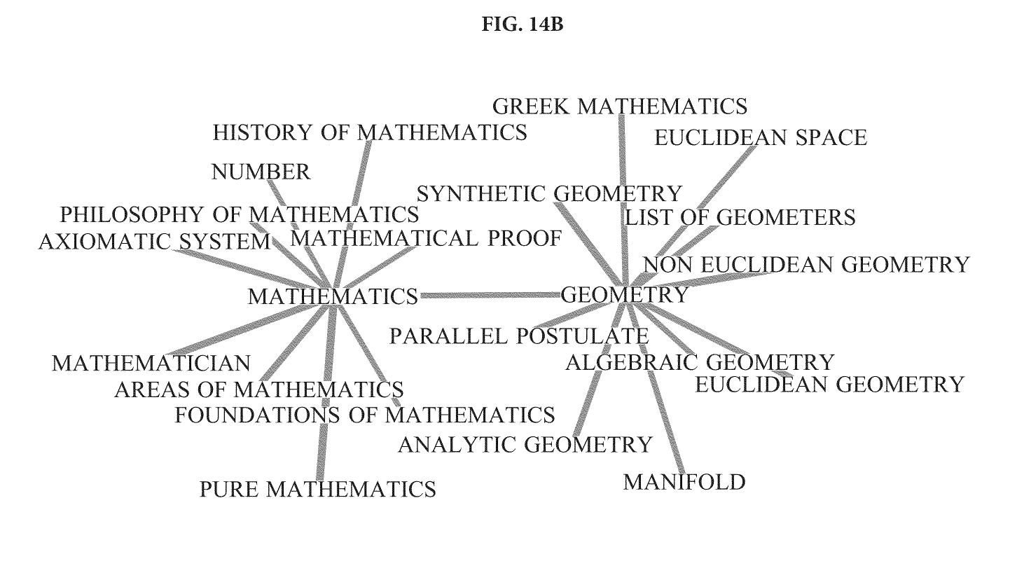

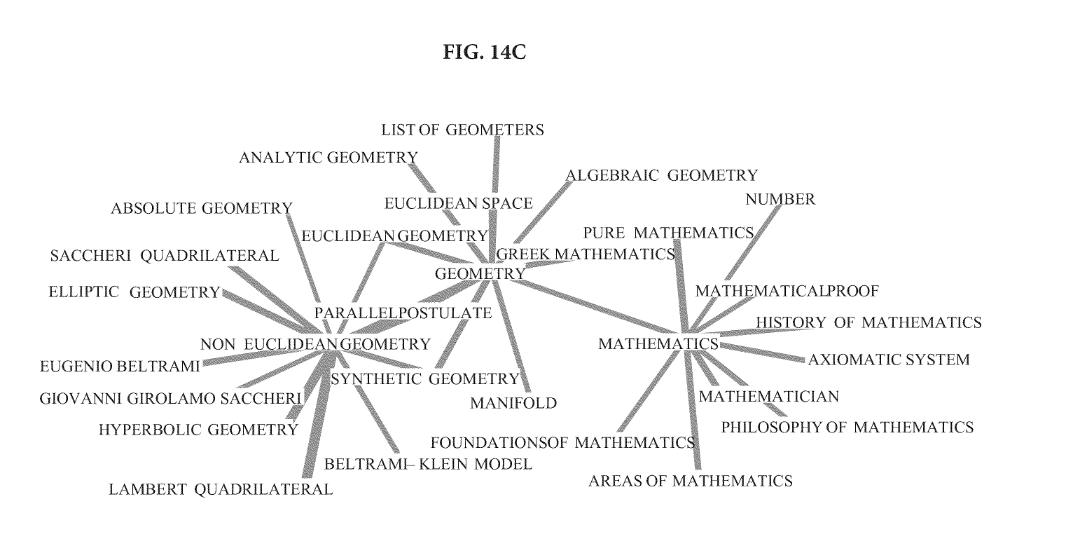

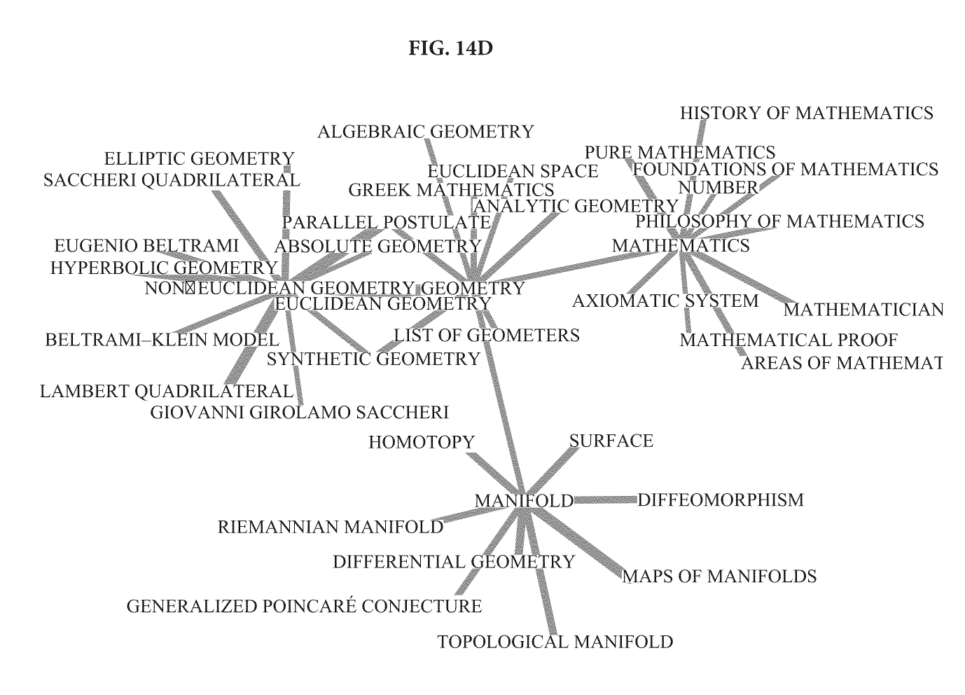

We start from the topic ‘Mathematics’ and we obtain FIG. 14A which is contextualized by fields of mathematics as ‘Algebra’, ‘Geometry’, ‘Foundations of mathematics’, etc.; by the ‘History of mathematics’ and ‘Philosophy of mathematics’; or by basic concepts like ‘Number’ and ‘Axiomatic system’.

Next we open the neighboring topic ‘Geometry’ as shown in FIG. 14B. The topic is contextualized by the sub-fields of geometry: ‘Euclidean geometry’, ‘non-Euclidean geometry’, ‘Analytical geometry’ and ‘Algebraic geometry’; in context there are also the main objects of study of the topic: ‘Manifold’ and a particular case of manifold, the ‘Euclidean space’. A prominent school of geometry is also present: ‘Greek mathematics’. We want to learn more about the topic non-Euclidean geometry and we obtain FIG. 14C.

We see that the topic ‘non-Euclidean geometry’ has topics in common with the topic geometry, for example, through the topics ‘Euclidean geometry’, since non-Euclidean geometry is a generalization of Euclidean geometry, and ‘Parallel postulate’, since it was by studying this postulate that mathematicians developed non-Euclidean geometries. Linked to the topic non-Euclidean geometry we find: ‘Hyperbolic geometry’ and ‘Elliptic geometry’, which are the two dimensional non-Euclidean geometries and geometers like ‘Giovanni Girolamo Sacchieri’ and ‘Eugenio Beltrami’ that where pioneers in this field.

We go back to the topic geometry and open the topic manifold to obtain FIG. 14D. Since this topic is a mathematical concept it is contextualized by related mathematical concepts like type of manifolds: ‘Riemannian manifold’ and ‘Topological manifolds’; a classical example of manifolds is ‘Surface’. Transformations that involve manifolds are ‘Maps of manifolds’, ‘Diffeomorphism’ and ‘Homotopy’, while ‘Differential geometry’ studies smooth manifolds.

### B. Contextualizing Topic: Leonardo Da Vinci

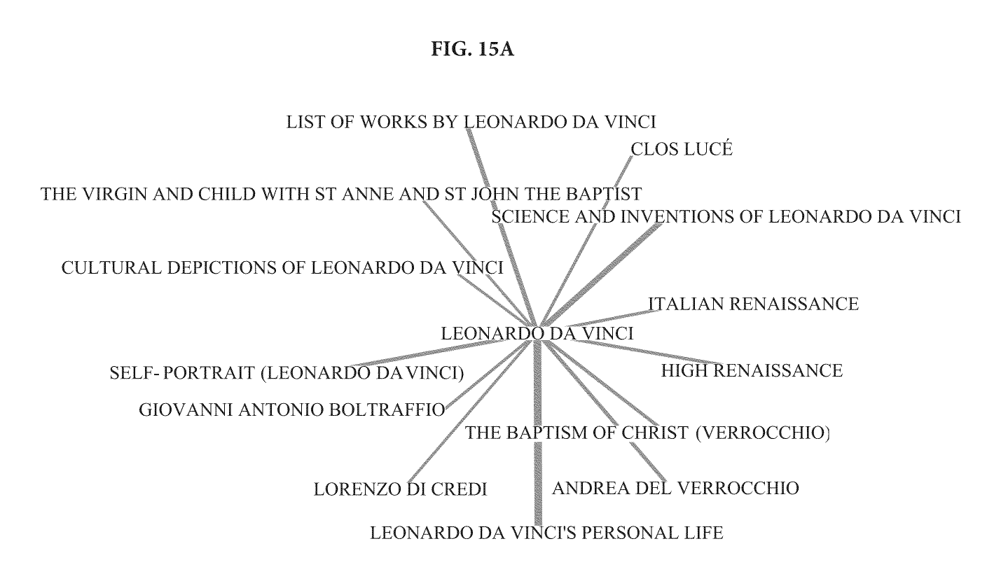

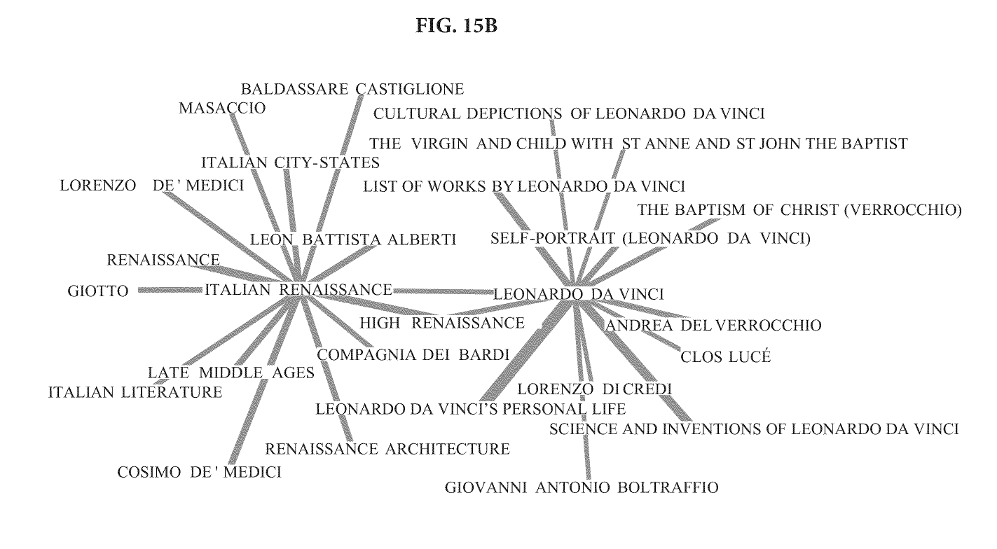

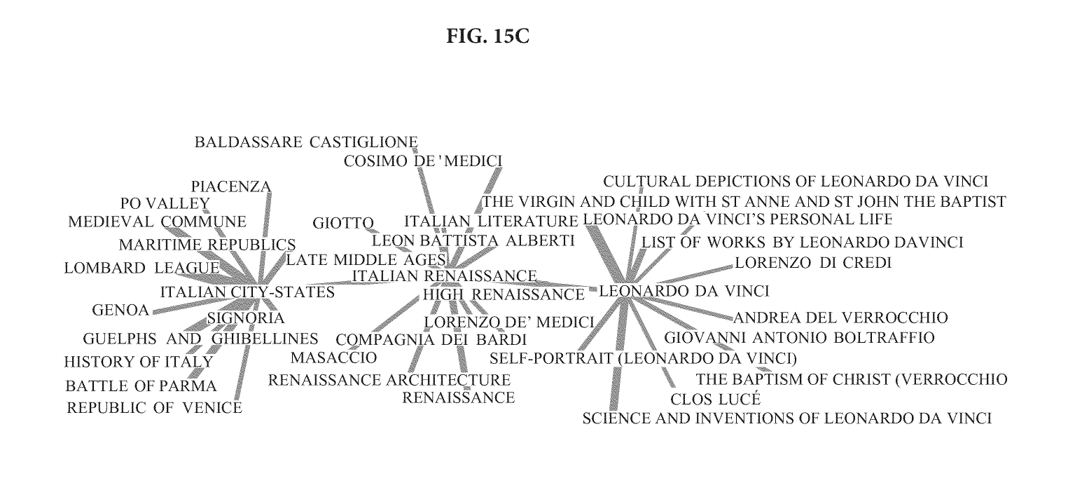

We start from the topic ‘Leonardo da Vinci’ and we obtain FIG. 15A. We find topics describing the influence of Leonardo da Vinci such as ‘Science and inventions of Leonardo da Vinci’, ‘Cultural depictions of Leonardo da Vinci’ and ‘List of works from Leonardo da Vinci’; we find Leonardo's paintings ‘Self-portrait (Leonardo da Vinci)’ and ‘The Virgin and the Child with St Anne and St John the Baptist’; we find collaborators ‘Lorenzo di Credi’, ‘Andrea del Verrocchio’ and ‘Giovanni Antonio Boltraffo’; we find the historical period Leonardo was living in ‘Italian Renaissance’ and ‘High Renaissance’; finally, we find the castle where Leonardo died in France: ‘Clos Lucé’.

We continue the exploration opening the topic Italian Renaissance and we find FIG. 15B. This topic is contextualized by the influent artists ‘Leon Battista Alberti’, ‘Giotto’ and ‘Masaccio’; by the influent political leaders and bankers ‘Cosimo de' Medici’, ‘Lorenzo de' Medici’ and ‘Compagnia dei Bardi’. Renaissance spurred both the ‘Renaissance architecture’ and ‘Italian literature’. Historically ‘Italian Renaissance’ comes after the ‘Late Middle Ages’ and is dominated by the ‘Italian City-States’ that now we explore.

In FIG. 15C, the “Italian City-States” are contextualized by their relations with ‘Medieval commune’, from which they evolved in the ‘Po valley’ to become a ‘Signoria’; they formed the ‘Lombard League’ at the time of the ‘Guelphs and Ghibellines’ and fought the ‘Italian wars’. This topic is prominent in ‘Italian history’; among the most powerful City-States were the ‘Maritime Republics’ such as ‘Genoa’ and the ‘Republic of Venice’.

### C. Contextualizing Topic: Lion

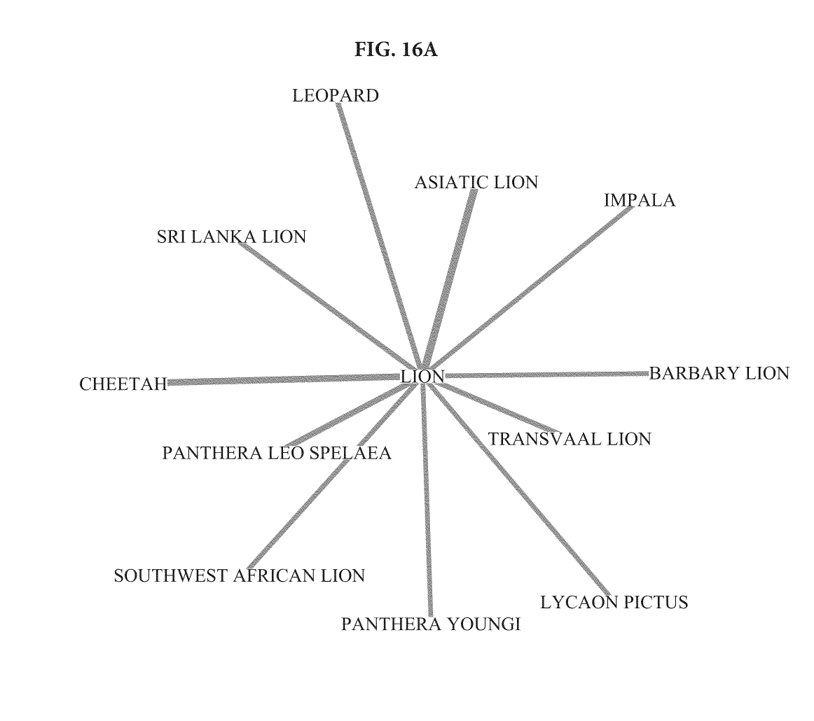

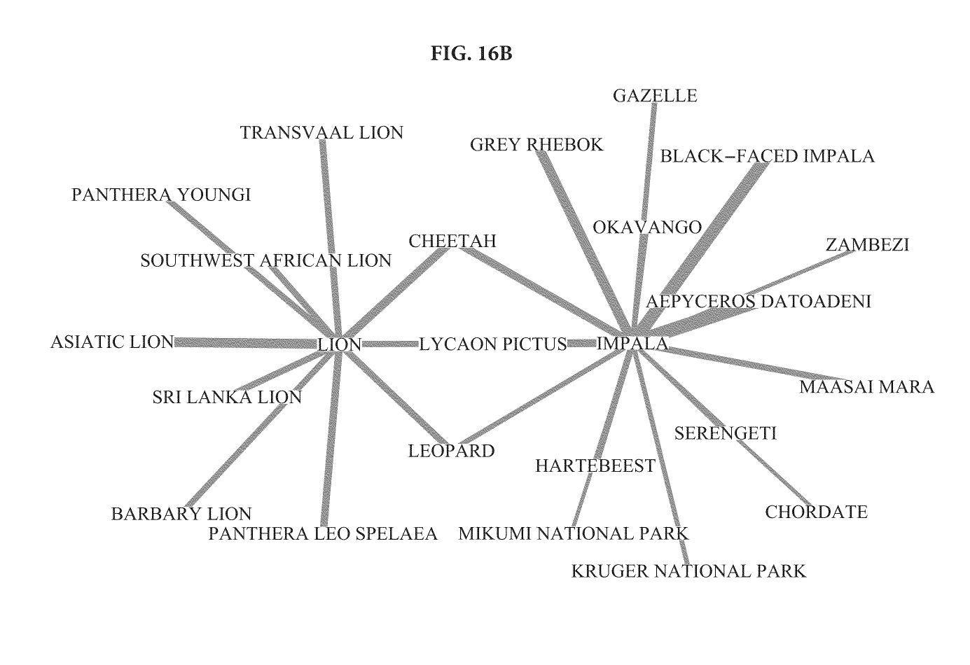

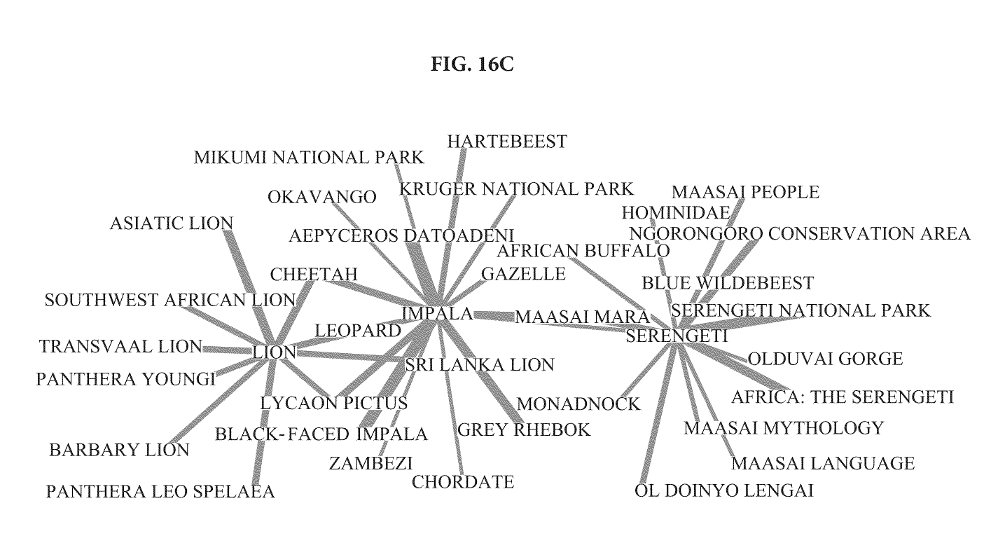

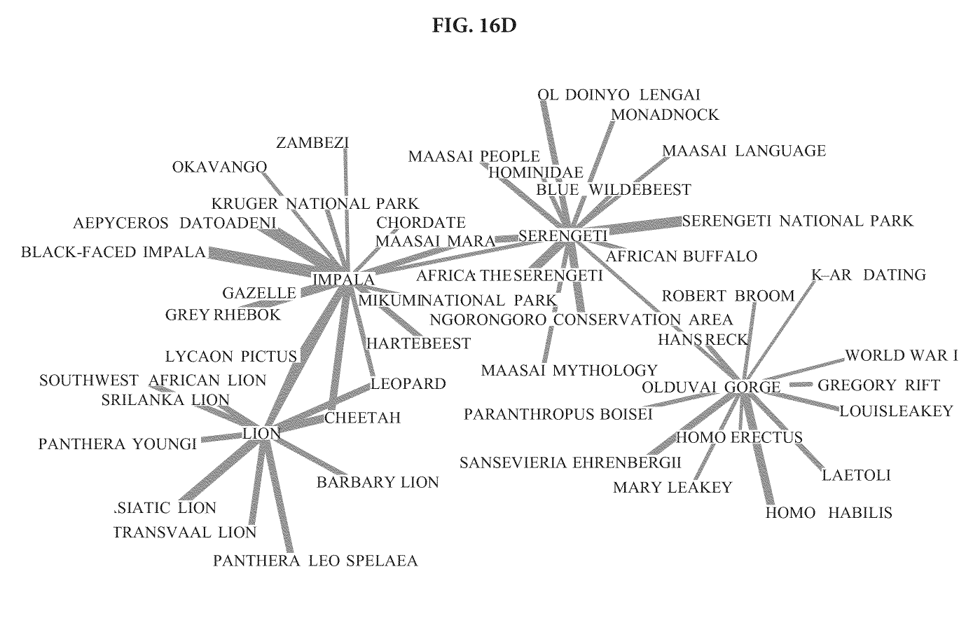

We start exploring from lion as shown in FIG. 16A. This topic is contextualized by other lions like ‘Asiatic lion’, ‘Southwest African lion’, ‘American lion’, etc.; by similar animals like the ‘Cheetah’ and the ‘Leopard’; by animals in the same habitat, and eventually in the same food chain, like the ‘Impala’.

Next we open the topic ‘Impala’ and we find FIG. 16B. The impala is related to both the cheetah and the leopard being hunted by them, while the lion was related to these by the fact of being a felidae. The impala is related to other herbivores as the ‘Black-faced impala’, the ‘Gazelle’ and the ‘Grey rhebok’. All these animals live in the ‘Maasai Mara’ and ‘Serengeti’, in particular in the ‘Kruger National Park’ and in the ‘Mikumi National Park’.

In FIG. 16C the topic ‘Serengeti’ is related to the ‘Maasai people’, living in it, to their ‘Maasai language’ and to their ‘Maasai mythology’. The Serengeti has protected areas as the ‘Serengeti National Park’ and as the ‘Ngorongoro Conservation Area’. The ‘Olduvai Gorge’ is where we hominidae all come from.

In FIG. 16D we opened the topic ‘Olduvai Gorge’. This topic is related to the hominidae ‘Paranthropus boisei’, ‘Homo erectus’ and ‘Homo abilis’, whose footprints in the ‘Laetoli’ site show they walked out from there. The discoveries of these hominidae were made by, among others, ‘Louis Leakey’ and ‘Mary Leakey’, ‘Hans Reck’ using also techniques like ‘k-ar dating’. The ‘Olduvai Gorge’ is covered by the plant ‘Sansevieria ehrenbergii’.

### Example 3

### A. Discovery Engine on Movies and Cinematographic Domain

We applied here the discovery engine to a movie database, accounting of about 54.000 movies. We constructed the collection of entities “movie” from multiple databases.

Since an entity is unique, it uniquely identifies a movie despite the language used in the source databases. In the following example, figures display movie titles in Italian language; movie titles in English equivalently refer to the same entities in the multipartite graph.

Three proximity matrices are chosen from the family of proximity matrices obtained by projecting the entity “movie” onto the properties “directors” and “writers”; onto “starring actors” who played in the movie; onto the properties “movie-plot” and “movie-genre”.

Each proximity matrix is a context characterizing proximity-related movies: we named the context of each proximity matrix respectively as “creativity”; “play”; and “story”.

A fourth proximity matrix (named “default”) is chosen from the family, to represent an average of the three, and represents a kind of generic context in the movie domain.

The user interface has been designed to associate to each proximity matrix a code: in this case, color-codes or other symbols help the user in selecting the context of the corresponding proximity matrix, and to find similar movies pertaining to a specific chosen context.

The user can select a specific context by means of buttons.

The user interface adopts a dual representation for accessing the multi-partite graph, by means of a connected graph and of a textual-grid layout.

The text-grid layout is designed to display the first neighbors of each entity in column; each column represents a context of a kind, and therefore is associated to a color-code corresponding to the point “central”, “creativity”, “play” and “story”; side-by-side columns are associated to the entities which belong to the shortest path connecting the first and last entities, queried within a tree (sub-graph) of a discovery session.

A discovery session starts by displaying neighbors of an entity within the generic context (“default” point). We chose to query the first seven neighbors for each node: a user can choose the number of neighbors for querying an entity.

### A. Contextualizing Movie: “Blade Runner: Final Cut”

“Blade Runner: final cut” is a science-fiction movie by Ridley Scott, re-mastered in 2007, based on the original movie of 1982 and based on a novel by Philip Dick. With the kind of contextualization “central”, the entity “Blade Runner”, which is the original 1982 movie, the most related movie which result as first neighbors are: “Blade Runner” (the original version); “The Blood of Heroes”; “Fatherland”; “Unforgiven”; and “Leviathan”. See: FIG. 17A.

We notice that entities having a relatively high proximity relatively to the other neighbors suggest a possibility of refining results by iterating the multi-partite graph method, by considering entities having proximity closed to 100% as identical. See: FIG. 17B.

We select the proximity matrix “creativity” and explore the node “Brave New World”. “Brave new World” is another science-fiction movie, based on homonymous Aldous Huxley's novel written in 1932. We obtain other movies directed by Ridley Scott and screen-players which worked with him on similar type of science-fiction movies, such as “Prometheus”, “Nessuna Verita” (“Body of Lies”), starring Leonardo DiCaprio, Russel Crowe and Mark Strong among the others), and “Robin Hood” (starring Russel Crowe and Mark Strong among the others). See: FIG. 17C.

We select again the proximity matrix “central” and then select “Alien”, which results contextualized by the Alien saga, and other science-fiction movies characterized by a futuristic dramatic atmosphere such as “Alien Vs. Predator”; “Lifeforce” (Italian adapted title in the figure: “Space Vampires”); “The Return of the Living Dead” (Italian adapted title in the figure: “II Ritorno dei Morti Viventi”); and “Total Recall” (Italian adapted title in the figure: “Atto di Forza”). See: FIG. 17D.

We may want to explore more on the proximity matrix “play”: we select “Total Recall” (“Atto di Forza”), a movie by Paul Verhoeven with Arnold Schwarzenegger and Sharon Stone among the others; we obtain a contextualization of related movies such as “Basic Instinct”, another movie by Paul Verhoeven starring Sharon Stone, Michael Douglas among the others; “Scissors” (Italian adapted title in the figure: “ “Scissors-Forbici” ”), a drama movie by Frank De Felitta starring Sharon Stone among the others; and “Terminator”, a movie by James Cameron starring Arnold Schwarzenegger among the others). See: FIG. 17E.

We may want to explore more the context “story” related to “Terminator”: we obtain “Terminator 2”, “Cybernator”, “Deadline” (Italian adapted title in the figure: “Redline”), “Dune Warriors” (Italian adapted title in the figure: “I guerrieri delle dune”), and “Retrograde”. They are all action movies whose story is characterized by extraterrestrial and technological futures, scenarios of vengeance. See: FIG. 17F.

We may also want to explore more the “creativity” context of “Terminator”: we obtain “Terminator 3”, “Titanic”, “Avatar”, “The Abyss” and “Aliens” which are movies directed by James Cameron. See: FIG. 17G.

We may want to explore more the “story” proximity matrix contextualizing “Avatar”. “Avatar”'s story is about a soldier sent to an alien planet which is exploited by military and business-men for its resources—the protagonist will drive a rebellion against them by joining with the aliens. The neighboring entities are “Robowar”, a science-fiction Italian movie where a military troop is sent to the forest in southeast Asia to destroy a robot war machine; “Starship Troopers”, a story where there is a military dictatorship leading planet Earth with extraterrestrial enemies; “Species 2”—a movie based on the future about a contamination between human and alien DNA after an expedition on Mars; “Stargate”, a movie about a military expedition to an alien planet through an interstellar gate—the protagonist will lead a rebellion to free the slaved alien population; “Hesus, Iusyunaryo”, a science-fiction movie made in 2002 based on an imminent future (2011) where a military junta rules on the Philippines, and the protagonist join clandestine rebel groups. See: FIG. 17H.

We know may want to synthesize the discovery made from the first movie, “Blade Runner: Final Cut” and “Avatar”. The shortest path in the tree we explored conveys the different context leading from the first to the latter movie.

The shortest path in a tree can be represented in the connected graph as well as in the textual-grid layout. See: FIG. 17I.

In this example, the shortest path in the tree is summarized above and can also be read in the first row of a matrix layout, which display an excerpt of the movie: we notice we gradually shifted the context about the science-fiction movie “Blade Runner—the final cut”, and reached “Avatar” through contextualizing movies: “Brave New World”, “Total Recall”, “Terminator”.

The shortest path in a tree is also mutually represented within the sub-graph corresponding to the textual-grid layout. See: FIG. 17J.

### Example 4

### A. Discovery Engine on Food Domain

We applied the discovery engine to a food database of about 25.000 Italian recipes in Italian language; the recipes' names are here translated and adapted in English language—the original Italian name is reported in brackets.

We obtained the family of proximity matrices from the projections of entities “recipe” in the direction of their properties “ingredient”, “main ingredient”, and “nutritional values”. It is also possible to arbitrarily extend the number of properties to consider, such as “flavors”, “traditional origin”, “methods for preparation”, or “cooking time”.

It is possible to improve the quality of the multi-partite graph by refining the database of raw ingredients into a smaller sets of classified ingredients: a possibility is to classify the recipes' ingredients of the source database against nutrient and food list databases of national agencies, such as USDA (US Department of Agriculture) and IEO (European Institute of Oncology); another possibility is to compute the family of proximity matrices for entities “ingredient” projected in the direction of properties “recipe”, so that to use proximity relationships as a measure to classify the ingredients linked by a proximity beyond a certain threshold. Another practice to improve the quality of the multi-partite graph may be to weight the importance of an ingredient in a recipe by its quantity.

A chosen proximity matrix specifically contextualizes the food knowledge encoded in the multipartite graph.

Since all recipes are connected, a user can traverse the whole multipartite graph, and gradually choose alternatives to the queried recipes.

### A. Contextualizing Recipe: “Tiramisu”

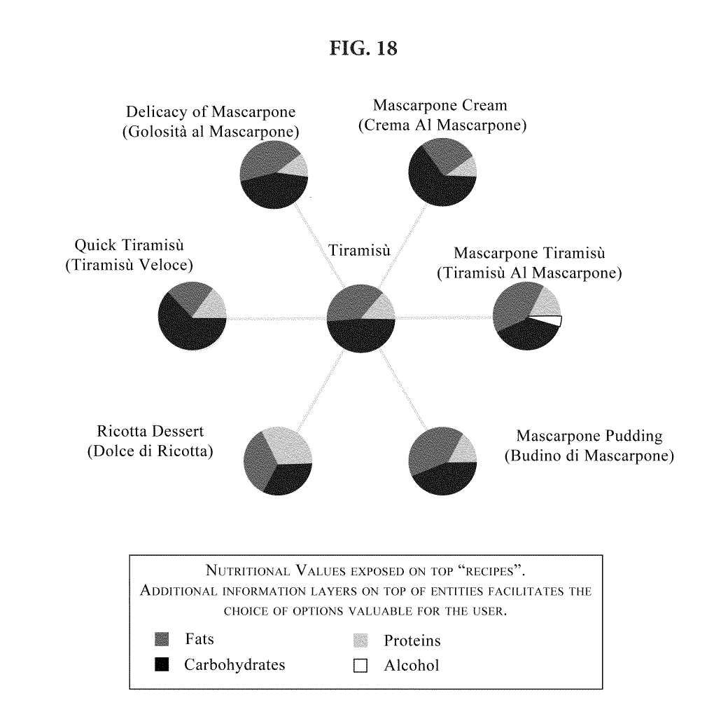

This example shows a possible application for contextualizing food and obtaining suggestions on how to vary a diet. On top of the results queried in the discovery engine, an information layer summarizes and displays the nutritional values of recipes so that a user can opt for alternative recipes proximity related by flavor, yet having different nutritional contribution. In this example, nutritional values are displayed with a pie-chart applied to nodes on a connected-graph interface, so that each node carry information on the carbohydrates, fats, proteins and alcohols pertaining a recipe. See FIG. 18.

In this recipe repository, “Tiramisu” is a dish based on “Mascarpone”, a type of fat-cream cheese, and “Savoiardi” biscuits, chocolate, sugar, eggs, and coffee with a spray of cacao.

The proximity relationships between “Tiramisù” and the first results of the query contextualize food knowledge focused on desserts based on cream cheeses. We obtain:

‘Quick Tiramisu’ (Tiramisu Veloce); ‘Delicacy with Mascarpone’ (Golosità al Mascarpone); ‘Mascarpone Cream’ (Crema al Mascarpone); ‘Mascarpone Tiramisù’ (Tiramisu al Mascarpone); ‘Mascarpone Pudding’ (Budino al Mascarpone); ‘Ricotta Dessert’ (Dolce di Ricotta). Such recipes have in common the use of cream cheese (such as ricotta or mascarpone) to prepare foamy, pudding-alike and creamy desserts, in combination of chocolate and coffee.

We may want to explore other types of cakes from the ‘Ricotta Dessert’: we obtain other options known in the Italian culinary domain, such as “Ricotta and Cacao Roll” (“Salame di Ricotta”—a variation where biscuits are smashed and combined with the cream-cheese and yolk to obtain a roll to be frozen); ‘Mascarpone Dessert in Cups’ (Tazzine buone di Mascarpone—a dessert based on mascarpone which prescribes to smash the biscuits and mix with yolks, cream-cheese and a tip of cognac, serve frozen in cups); and ‘Gianduia Chocolate Cake’ (Torta di Gianduia—a cake which basically use the ingredients of a tiramiù., differently combined).

### B. Traversing the Multi-Partite Graph

The choice of a proximity matrix allows choosing the context of a recipe respect to the food knowledge embedded in the multipartite graph.

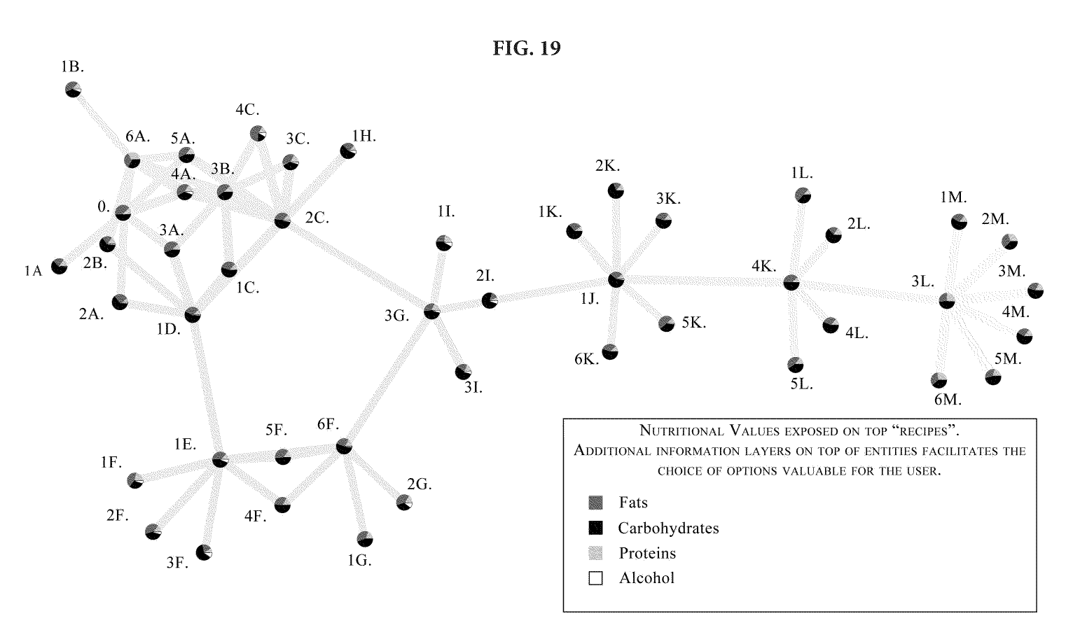

We can iterate queries across the sub-graph resulting neighbors, and traverse a culinary domain to gradually shift from cakes, to other forms of desserts using cheese and fruits, or to other type of courses using cheese as entry or appetizers, so that we gradually traverse the multi-partite graph towards savory type of courses. See FIG. 19.

Sample of results of queries in traversing the multi-partite graph. Queried recipes are formatted in bold font. First neighbors of queries are grouped in paragraphs.

[symbol]

[symbol]

1A. “Quick” Tiramisù(TiramisùVeloce)

### 2A. Mascarpone Cream (Crema al Mascarpone)

[symbol] [symbol] [symbol] [symbol] [symbol] 4A. Mascarpone Tiramisù(Tiramisùal Mascarpone)

### 5A. Mascarpone Pudding (Budino di Mascarpone)

### 6A. Ricotta Dessert (Dolce di Ricotta)

1B. Dessert Mascarpone in Cups (Tazzine buone di Mascarpone)

### 2B. Ricotta and Cacao Roll (Salame con Ricotta)

### 3B. “Gianduia” Chocolate Cake (Torta Gianduia)

### 1C. Ricotta Tart (Crostata di Ricotta)

2C. Chocolates with Mascarpone
3C. Dessert Supreme with Ricotta and Dark Chocolate (Dolce Supreme)
4C. Cups with Mascarpone and Almonds (Coppe al Mascarpone)

[symbol]

[symbol]

[symbol]

[symbol]

[symbol]

[symbol]

[symbol]

[symbol]

[symbol]

[symbol]

[symbol]

### 1F. Delicacy of Ricotta and Whipped Cream (Delizia di Ricotta)

2F. Sponge-Cake Tiramisù(Tiramisùcon il Pan di Spagna)
3F. Iced Cream with Jam and Mascarpone (Crema fredda al Mascarpone)

### 4F. Ricotta Mousse (Mousse di Ricotta)

5F. Ricotta Pudding with Caramel (Budino di Ricotta Al Caramello)

[symbol]

[symbol]

[symbol]

[symbol]

[symbol]

[symbol]

[symbol]

1G. Crèpes stuffed with Ricotta and Raisin (Crèpes Ripiene)

### 2G. Semifreddo Ricotta (Dolce di Ricotta in Coppa)

[symbol]

[symbol]

[symbol]

[symbol]

[symbol]

[symbol]

[symbol]

### 1H. Semifreddo Mascarpone (Semifreddo al Mascarpone)

### 1I. Mousse of Ricotta and Chocolate (Mousse di Ricotta e Cioccolato)

[symbol] [symbol] [symbol] [symbol] [symbol] [symbol] 3I. Cream of Ricotta with Candid Apricot (Crema di Ricotta)

[symbol]

[symbol]

[symbol]

[symbol]

[symbol]

[symbol]

[symbol]

[symbol]

1K. Mascarpone dumplings with Pears (Fagottini di Mascarpone)
2K. Ricotta dumplings with Cinnamon and Honey (“Dita di Apostoli” Dessert, Sicilian Recipe)
3K. Ricotta dumplings (Palline di Ricotta)

[symbol]

[symbol]

[symbol]

[symbol]

### 5K. Semifreddo Ricotta (Semifreddo di Ricotta)

6K. “Quick” Ricotta-Pie (Torta di Ricotta veloce)
1L. Ricotta Syrniki (fried pancakes) (Syrniki—frittelle di ricotta)

### 2L. Ricotta and Potato Dumplings (Gnocchetti di Patate e Ricotta)

[symbol] [symbol] [symbol] [symbol] [symbol] 4L. Fried Ricotta Dumplings (Palline di Ricotta fritte)

### 5L. Mascarpone Dessert (Coppe Di Mascarpone)

1M. Ricotta Canapé (Tartine di Ricotta)
2M. Cheese-Pudding (Pudding di formaggio)
3M. Crouton with Melted Cheese (Crostini con Fonduta)

### 4M. Lasagna of “Norma Anita” (Lasagne di Norma Anita)

### 5M. Parmesan-Cheese Dumplings

6M. Cheese-souffle (Soufflè di Formaggio)

The procedures for “Tiramisù” recipe prescribe to obtain a compost from the eggs and mascarpone-cheese, and arrange it with biscuits bathed into coffee; the compost is then frozen.

We notice that a cluster of recipes made with “Mascarpone” and with a freezing procedure appears: there are dishes adopting “Ricotta” as variation to “Mascarpone”, or adopting a variation in the type of chocolate (e.g. Gianduia); substantially they pertain to a “Tiramisu” alike preparation.

We notice another cluster of creamy desserts obtained by a different use of “Mascarpone” and “Ricotta” and freezing techniques, such as “Gelato di Mascarpone” (“Ice-cream with mascarpone”), “Crema fredda al Mascarpone” (“Frozen cream of mascarpone”), “Mousse di Ricotta” (“foamy cake made of ricotta”), and “Crema di Ricotta con Mirtilli” (“Cream of ricotta with blackberries”).

We notice another cluster represented by fruit-mousses, obtained by a different treatment of the cream cheese, such as: “Spuma di Ricotta al Mascarpone” (“Foam of Ricotta with Mascarpone”), “Mousse di Ricotta e cioccolato” (“Mousse of Ricotta and Chocolate”), and “Coppe Gustose” (a compost of ricotta and milk served on cups and topped by candied fruits”). Mousses are dishes that are made by using procedures of freezing and mixing to incorporate air bubbles.

We notice another cluster of dishes, whose methods include mixing with thickeners (e.g. potatoes flour) and a part of boiling or frying, such as: “Bavarese” (a cake variation introducing the method of boiling the milk component with a coagulator, then joining the cream-cheese”), “Gnocchetti di patate e ricotta” (“gnocchi of potatoes and ricotta”—small balls of ricotta coagulated with potato flour, then boiled), “Palline di ricotta fritte” (small balls of ground up bread and ricotta, then fried), and “Coppe al Mascarpone” (a frozen mix of boiled milk with potatoes flour and cream).

We notice another cluster of dishes whose methods include methods as melting and filling, such as “Sformato di Fontina” (a type of appetizer with melting-cheese fontina on top of bread), “Crostini con Fonduta” (a regional dish from north-west Italy with melting-cheese fontina on top of bread), “Bignole Al Parmigiano” (a regional dish with boiled milk, flour, and parmesan melt in oven), “Soufflé di Formaggio (3)” (a souffle based on Emmenthal cheese which includes methods of cooking with steam and melting the cheese in the oven).

In this example, we notice that the context of a matrix in the family of proximity matrices obtained from ingredients and nutritional properties also captures and organizes other type of information embedded in the multi-partite graph. We observe that variations in the adoption of creamy cheeses respect to melting cheeses also carries information on variations of the methods for their preparations, such as from freezing (Tiramisu like), to freezing and foaming (Cream alike), to freezing and boiling/frying, to filling and boiling/frying. We also observe a transition from “Desserts” to “Canape” and “main courses” type of dishes (e.g. from “Tiramisu” to “Lasagna”).

We also observed that regional recipes tend to be grouped together, reflecting the traditional and historical know-how for combining ingredients.

“Sformato di Fonduta”, “Crostini of Fonduta”, “Canederli pressati Con Fontina Valdostana” are regional dishes from north-west Italy (from Piemonte and Valle D'Aosta regions, north-west Italy); they are neighbored with other regional dishes based on melting-cheese methods and spun paste (“pasta filata”) type of cheese, such as: “Crespelle con Taleggio e Tartufo” (Crepes with Taleggio cheese and truffle), a regional dish from northern Italy, region of Lombardia, north of Italy; “Grougere al Provolone”, a dish from flatland “Pianura Padana”, north of Italy; “Bignole al Parmigiano”, a dish from Calabria region, southern-centre of Italy, “Pallotte Cacio e Uova”, a dish based on Cacio cheese, original from Lazio region, central Italy; “Uova Affogate Nel Nido Al Gorgonzola”, a dished based on Gorgonzola, a cheese traditional of northern Italy in region Lombardia, north of Italy.

By extension, it is possible to merge and combine different datasets of recipes, also multi-language, and obtain a multi-partite graph that reflects, at world level, the cultural traditional traits, know-how and flavors in combining ingredients to obtain food recipes.

C. Traversing the Multi-Partite Graph: Applications for Optimizing and Diversifying the Preparation of Products with a Minimum Set of Components

This example shows the use of the discovery engine to find a set of new either unknown recipes within a few queries.

The set of recipes are characterized by a minimum number of ingredients.

This allows finding application in processes for optimizing the use of ingredients/components in the preparation of products. [food processing/industrial products]

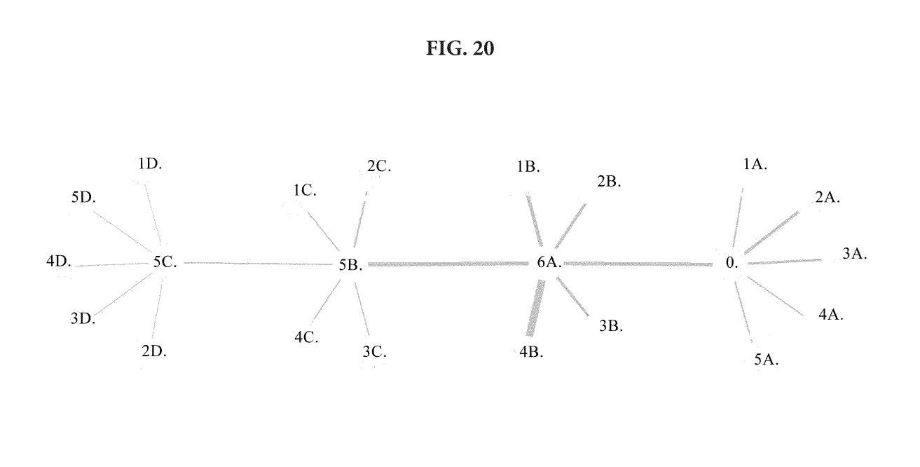

In the food domain, this allows to vary the diet sufficiently by gradual variations in the initial set of ingredients. See FIG. 20.

Sample of results of queries in traversing the multi-partite graph. Queried recipes are formatted in bold font, their results are reported in the paragraph below.

[symbol]

[symbol]

[symbol]

[symbol]

[symbol]

1A. Soup with Rice and Leeks (Minestra di Riso e Porri)

### 2A. Savory Rice Pie (Tortino di Riso)

3A. Risotto with Barolo wine (Risotto Al Barolo)
4A. Risotto with Chestnuts and Rosemary (Risotto con Castagne e Rosmarino)
5A. Risotto with Spumante wine and Scamorza cheese (Risotto con Spumante e Scamorza)

[symbol]

[symbol]

[symbol]

[symbol]

[symbol]

1B. Risotto with Lentils (Risotto con le lenticchie)
2B. Spiced Semolina soup (Semolino Aromatico)
3B. Savory Rice Pie with Spinach and Parmesan (Torta salata di Riso)
4B. Bread crump soup with Eggs (Pantrito)

[symbol]

[symbol]

[symbol]

[symbol]

[symbol]

1C. Soup with Celery (Minestra al Sedano Rapa)
2C. Risotto with Pumpkins and Artichokes (Risotto con Zucca e Carciofi)
3C. Risotto with Spinaches (Risotto agli Spinaci)
4C. Risotto with Cream and Leeks (Risotto con Panna e Porri)

[symbol]

[symbol]

[symbol]

[symbol]

[symbol]

1D. Soup with Legumes (Crema di Legumi)
2D. Soup with Lettuce (Zuppa di Lattuga)
3D. Tomato Soup with Bread Crumbs (Zuppa d'Oro)
4D. Soup with Celery (Crema di Sedano)

### 5D. Pumpkin-pie (Sformato di Zucca)

Within 4 queries, we varied from Risotto-type of recipes to Soup-type of recipes, based on a common set of ingredients. The steps are: “Risotto with Prosecco” (Risotto with White Sparkling Wine), “Rice with Egg”, “Crema Maria”, “Crema di Carciofi” (Soup with Artichokes).

By querying six neighbors for each entity, we obtained 22 recipes with a list of 31 basic ingredients: Rice; Cereal Meals [Rice soup (semolina alike); Semolina]; Eggs; Alliaceous vegetables [Onion; Leek]; Potatoes; Leguminous Vegetables [Lentils]; Celeriac, radishes and similar edible roots [Celery]; Vegetables [Artichoke; Spinach; Zucchini; Pumpkin]; Mushrooms and truffles [Truffles]; Dried Fruit [Chestnuts]; Soups and Broths and preparations therefore [Marrow; Broth/Chicken Broth]; Bread and other bakers wares [bread crumbs]; Olive oil; Salt; Spices [Rosemary; Muscat; Cinnamon; Pepper]; Wine [Sparkling White Wine; Red Wine (Barolo)]; Spirits and Liquors [Cognac].

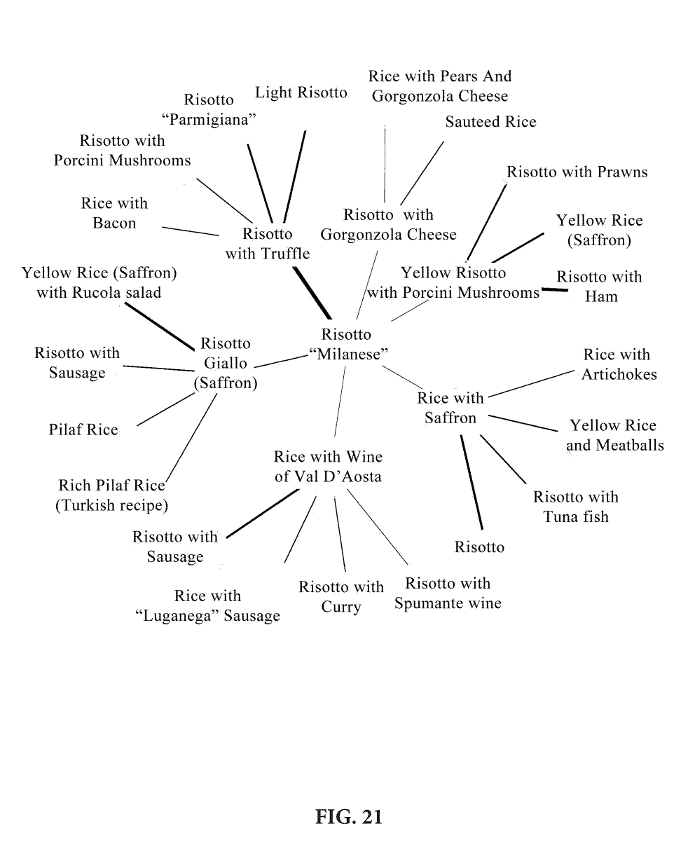

This example shows the use of a discovery engine to provide results focused on clusters of similar entities. We queried the first six neighbors of the recipe “Risotto Alla Milanese” (risotto with saffron) and queried the first four neighbors for each of the six results: the portion of multi-partite graph is displayed with a connected graph. See FIG. 21.

We obtained 24 variations of risottos with a basis of 34 ingredients: Rice; Meat of Swine [Bacon; Ham; Sausage]; Fish [Tuna]; Crustaceans [Prawns]; Butter and other fats from milk/dairy spreads [Butter; Cream]; Cheese and Curds [Parmesan Cheese; Gorgonzola Cheese]; Alliaceous vegetables [Onion; Garlic]; Celeriac, radishes and similar edible roots [Celery]; Lettuce and Chicory [Salad (arugola)]; Vegetables [Artichokes; Pumpkins]; Fresh Fruit [Pears]; Mushrooms and truffles [Truffle; Porcini Mushrooms]; Dried Fruit [Walnuts]; Soups and Broths and preparations therefore [Marrow; Broth]; Olive Oil; Salt; Spices [Basil; Parsley; Rosemary; Pepper; Curry; Saffron]; Wine [White Wine; White Wine (Sparkling); Red Wine (Marsala)]; Spirits and Liqueurs [Cognac].

We now extract a sub-graph from a multi-partite graph by querying multiple nodes rather than only one.

The minimum size of a group of connected recipes, characterized by the minimum set of ingredients, is found by querying two nodes with a shortest path algorithm; in this case, the Dijkstra algorithm.

As example, we want to search for the minimum group of recipes connecting “Risotto Alla Milanese” (risotto with saffron) AND “Risotto Con Salsiccia” (risotto with pork sausage).

We obtained: Risotto with Saffron (“Risotto Alla Milanese”); Yellow Rice with Meatball (“Riso Giallo e Polpettine”); Rice with Almonds (Riso alle Mandorle); Rice with Sausage (“Risotto Alla Salsiccia”); Risotto with Pork Sausage (“Risotto Con Salsiccia”).

D. We Query the Multi-Partite Graph Against “Torta all'Ananas” (Ananas Pie) and “Plumcake”.

We obtained: Ananas Pie (“Torta All'Ananas”); Danish Puff Pastry (“Pasta Sfoglia Danese”); Brioches; Pastry for Brioches (“Pasta Per Brioches”); Almond Pastries (“Pastine Alle Mandorle”); Biscuits with Raisin (“Biscotti All'uvetta”); Plumcake.

E. Indexing Web Documents within a Multi-Partite Graph

Another embodiment of the discovery engine is to query a multi-partite graph constructed from documents indexed in the World Wide Web, in order to aggregate and organize content from multiple sources, such as web sites and other electronic archives.

In the sample below we indexed multiple web sources to obtain a database of about 200.000 recipes in English language.

We constructed a multi-partite graph and contextualize recipes with the proximity matrix obtained from the projection of entities “recipe” onto the properties “ingredient”.

As example, “Wafer-Banana Cake” is a recipe indexed from Seriouseats.com.

[Source: http://www.seriouseats.com/recipes/2011/08/let-them-eat-nilla-wafer-banana-cake-recipe.html]

The first neighbors describe other cakes combining a biscuit based dough with fruit flavor, such as:

“Raspberry Buttermilk Cake”, indexed from Epicurious.com [Source: http://www.epicurious.com/recipes/food/views/Raspberry-Buttermilk-Cake-353616];

“Buttermilk Biscuits”, indexed from MarthaStweart.com

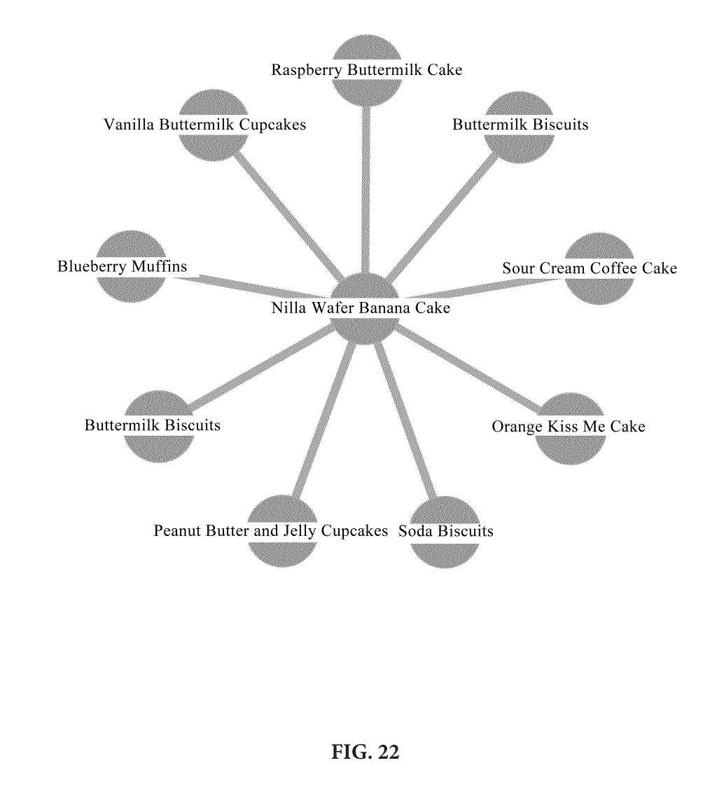

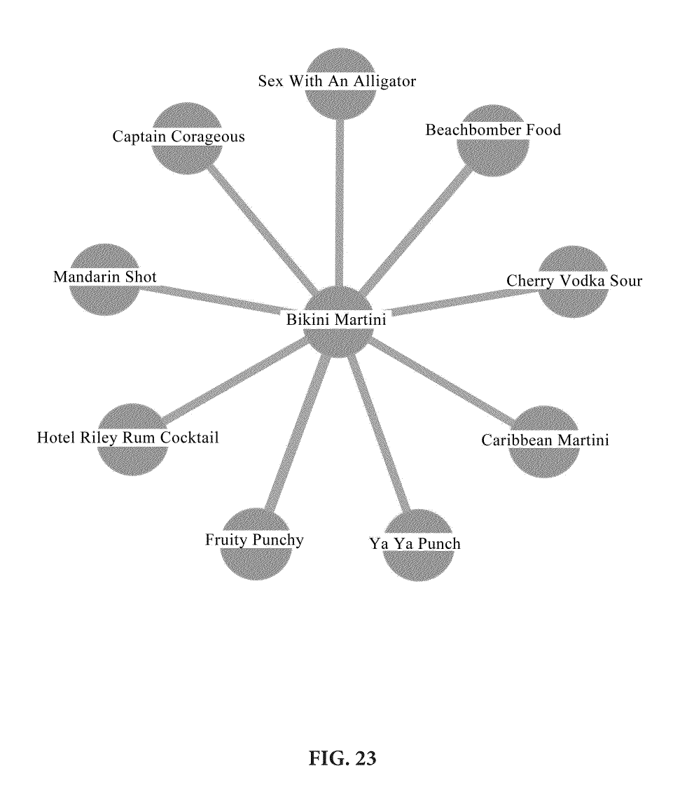

(http://www.marthastewart.com/315759/buttermilk-biscuits); “Sour Cream Coffee Cake”, indexed from MarthaStweart.com (http://www.marthastewart.com/343429/sour-cream-coffee-cake); “Orange Kiss Me Cake”, indexed from Seriouseats.com (http://www.seriouseats.com/recipes/2011/09/let-them-eat-orange-kiss-me-cake.html); “Peanut Butter and Jelly Cupcakes”, indexed from Seriouseats.com (http://www.seriouseats.com/recipes/2011/09/let-them-eat-peanut-butter-jelly-cupcakes-recipe.html); “Vanilla Buttermilk Cupcakes”, indexed from MyRecipes.com [http://www.myrecipes.com/recipe/vanilla-buttermilk-cupcakes-10000001049346/]; “Blueberry Muffins”, indexed from Food.com (http://www.food.com/recipe/blueberry-muffins-96520). See FIG. 22.

In this example we queried the first neighbors of “Bikini Cocktail”, a drink flavored by Pineapple Juice with a base of Martini and Vodka, indexed from Allrecipes.com (http://allrecipes.com/recipe/bikini-martini); the food context obtained from the proximity matrix is characterized by other fruit flavored cocktails, such as: “Caribbean Martini”, sourced from Food.com (http://www.food.com/recipe/caribbean-martini-185216); “Mandarin Shot”, sourced from Food.com (http://www.food.com/recipe/mandarin-shot-308390); and “Beachcomber”, sourced from Food.com (http://www.food.com/recipe/beachcomber-423018). See FIG. 50.

### Example 5

### Observations on Proximity Results from the Multi-Partite Graph Respect to Results from Recommender Systems

This example shows that the multi-partite graph allows finding proximity results for any entity in the multi-partite graph: in comparison with the recommender systems for information retrieval mentioned in the “Background of Invention”, the discovery engine's results do not depend on the popularity of entities among users.

We compare the results, obtained from the discovery engines mentioned in the examples, with knowledge graph of Google, Inc.

### A. “the Bourne Identity”—an Action Movie Directed by Doug Liman, Starring Matt Damon.

The first ten results of the related searched based on the Google's knowledge graph are:

“The Bourne Supremacy”, “The Bourne Ultimatum”, “The Bourne Legacy”, “The Long Kiss Goodnight”, “Hanna”, “Salt”, “Abduction”, “Vantage Point”, “Body of Lies”, “Green Zone”.

The results of the discovery engine applied to the multi-partite graph of about 54.000 entities of type “movie” are shown below, together with the proximity values rounded to the nearest tenth.

Within the context “Default” of the proximity matrix chosen in the example above, first ten results are:

“The Bourne Supremacy” [37.3%], “The Bourne Ultimatum” [33.3%], “The Bourne Legacy” [32.5%], “Killer Elite” [23.5%], “Shoot'em Up” [23.4%], “Vertical Limit” [20.8%], “We Mortals Here” [20.8%], “Fair Game” [20.7%], “II Ragazzo dalle mani d'acciaio/Karate Rock” [20.1%], “Bait/L'esca” [19.8%].

The first ten results based on the “Creativity” proximity matrix chosen in the example above are:

“The Bourne Legacy” [31.7%], “Michael Clayton” [29.9%], “The Bourne Supremacy” [28.7%], “The Bourne Ultimatum” [23.9%], “Mr. & Mrs. Smith” [23.5%], “Duplicity” [21.3%], “We Mortals Here” [20.8%], “Fair Game” [20.4%], “Untitled Plame and Wilson Biopic” [19.2%], “Bait/L'esca” [18.2%].

Within the context “Play” of the proximity matrix chosen in the example above, first ten results are:

“The Bourne Supremacy” [39.0%], “The Bourne Ultimatum” [29.4%], “The Bourne Legacy” [19.8%], “Killer Elite” [19.3%], “Shoot'em Up” [19.0%], “Gerry” [17.2%], “Syriana” [16.2%], “The International” [15.6%], “Saving Private Ryan” [15.3%], “His Life” [15.2%].

Within the context “Story” of the proximity matrix chosen in the example above, first ten results are:

“S.W.A.T.: Fire-Fight” [29.4%], “Bangkok Dangerous” [27.8%], “Naked Weapon” [27.0%], “Shadowless Sword/II potere della spada” [26.9%], “Swordfish” [26.2%], “The Sanctuary” [26.2%], “Mortal Kombat: Annihilation” [26.2%], “The Foreigner” [26.1%], “Jianyu” [26.0%], “The Siege” [25.6%].

B. “Supramolecular chemistry”—“Supramolecular chemistry refers to the domain of chemistry beyond that of molecules and focuses on the chemical systems made up of a discrete number of assembled molecular subunits or components.” [source: Wikipedia]

Despite at least one the sources used by Google is Wikipedia for providing related results, there isn't any result in the knowledge graph for the entity “Supramolecular chemistry”.

The results of the discovery engine applied to the multi-partite graph of entities of type “topics” extracted from the Wikipedia database are shown below, together with the proximity values rounded to the nearest one.

Within the context of the proximity matrix chosen in the example above, first ten results are:

“Molecular self-assembly” [20%], “Folding (chemistry)” [17%], “Catenane”, “Molecular Machine” [13%], “Supramolecular Assembly” [13%], “Fraser Stoddart” [13%], “Molecular knot” [11%], “Host-Guest Chemistry” [10%], “Molecular Imprinting” [10%], “Foldamer” [10%].

What is claimed is:

1. A computer-implemented method to organize and combine multiple databases into a Multi-Partite Graph Database (MPGD), said databases containing information on type of entities and their properties, comprising:
a. obtaining a plurality of type of entities and their relative properties, wherein at least two of said entities share at least one property;
b. creating a multi-partite graph;
c. making a projection for each type of entity onto each of their type of properties to obtain a proximity matrix, or a weighted graph, for each pair type of entity-type of property;
d. obtaining a family of proximity matrices for each type of entity;
e. querying the computed results in a format so that for each type of entity, portions of proximity matrices, or weighted graphs, of said family, are interactively accessed, represented or displayed.

2. The method according to claim 1, wherein after step b) and before step c), the step b′ of promoting said properties to entities and type of properties to type of entities is provided.

3. The method according to claim 1, wherein said multi-partite graph database contains as many families of proximity matrices as the number of entity-types and any of said family contains infinite proximity matrices.

4. The method according to claim 1, wherein said multi-partite graph database contains as many families of weighted graphs as the number of entity-types and any of said family contains infinite weighted graphs.

5. The method according to claim 1, wherein said type of entities are documents and said properties are links between said documents.

6. The method according to claim 1, wherein said multi-partite graph of step b) is a collection of as many hyper-graphs (where an entity is an element and a property a set) as the entity types are.

7. The method according to claim 1, wherein semantic relations among entities are transferred to relations among nodes of said multi-partite graph.

8. The method according to claim 1, wherein an entity type is projected onto each of the entity types it is connected with in said multi-partite graph.

9. The method according to claim 8, wherein said projection generates proximity matrices over a type of entity which are linearly combined to create a continuous family of proximity matrices.

10. The method according to claim 1, wherein the family of proximity matrices is queried by specifying any of type of entity, a context and a list of entities.

11. The method according to claim 10, wherein said query returns a sub-graph, or equivalently a sub-matrix, containing the specified entities.

12. The method according to claim 10, wherein a visual interface is implemented.

13. A discovery engine using the method of claim 10.

14. The discovery engine according to claim 13, wherein a query of a single entity is made.

15. The discovery engine according to claim 14, wherein any successive query is made against an entity belonging to the sub-graph union of the sub-graphs returned by the previous queries.

16. The discovery engine according to claim 13, wherein a query of two entities is made.

17. The discovery engine according to claim 16, wherein a shortest-path algorithm is applied to determine the returned sub-graph.

18. The discovery engine according to claim 13, wherein a query of three or more entities is made.

19. The discovery engine according to claim 18, wherein clustering or community detection algorithms are applied to determine the returned sub-graph.

20. The discovery engine according to claim 13, wherein queries against collections of families of proximity matrices are combined.

21. A method for performing the discovery engine according to claim 13, wherein a visual interface is implemented, comprising:
a. displaying the sub-graph graphically or by equivalent textual-grid layouts;
b. displaying the shortest path which connects the first queried and the currently selected entity belonging to the sub-graph;
c. overviewing and traversing knowledge domains by accessing the sub-graph;
d. summarizing meaningful relationships between entities by highlighting the paths connecting at least two selected entities;
e. aggregating multiple information layers associated to an entity;
f. accessing a minimum number of properties to characterize a set of entities.

22. A non-transitory computer program storage device readable by computer, tangibly embodying a program of instructions executable by said computer to perform the method of claim 1.

23. A non-transitory computer program storage device readable by computer, tangibly embodying a program of instructions executable by said computer to perform the discovery engine of claim 13.
